(19) United States
(12) Patent Application Publication
(10) Pub. No.: US 2002/0042751 A1
(43) Pub. Date: Apr. 11, 2002

(54) Systems and methods for business to business financial analysis

(76) Inventor: Anthony Sarno, Madison, WI (US)

Correspondence Address: MEDLEN & CARROLL, LLP, Suite 2200, 220 Montgomery Street, San Francisco, CA, 94104, US

(21) Appl. No.: 09/898,179

(22) Filed: Jul. 3, 2001

Related U.S. Application Data
(60) Provisional application No. 60/216,392, filed on Jul. 6, 2000.
(60) Provisional application No. 60/216,437, filed on Jul. 6, 2000.

(51) Int. Cl. G06F 17/60

(52) U.S. Cl. 705/26

(57) ABSTRACT

The present invention relates to systems and methods for analyzing and presenting user information for cost justification. For example, the present invention provides systems, methods, and software tools for generating financial summaries and business cases allowing, for example, adjustments for continuous improvements and modified rollout schedules. The present invention further provides systems and methods for generating and integrating knowledge bases and expense rules with the above systems and methods.

This Application claims priority to Provisional Applications 60/216,392 and 60/216,437, both filed Jul. 6, 2000.

### FIELD OF THE INVENTION

The present invention relates to systems and methods for analyzing and presenting user information for cost justification. For example, the present invention provides systems, methods, and software tools for generating financial summaries and business cases allowing, for example, adjustments for continuous improvements and modified rollout schedules. The present invention further provides systems and methods for generating and integrating knowledge bases and expense rules with the above systems and methods.

### BACKGROUND OF THE INVENTION

There is a growing trend towards using capital budgeting techniques and the presentation of business cases to identify, recommend and communicate information technology (IT) and other investments. Business cases include cash flow statements that provide insight into the financial impact of an investment decision. The cash flow statements use Generally Accepted Accounting Principles (GAAP) and contain yearly summarized totals for capital and non-capital expenses and benefits. They also take into account the time value of capital. Current methods for generating and presenting such financial analyses suffer from problems of being both too complicated and too simple. For example, many financial analysis methods provide extensive financial details in the form of spreadsheets, tables, and the like, covering hundreds of financial components of a business decision to be implemented. While these detailed reports and analyses may be beneficial under certain circumstances, they are often too detailed, convoluted, and complex for business decision-makers (e.g., executives) to use in evaluating the business decision. Also, in some aspects, the financial analyses are too simple, and inflexible. For example, many financial analysis methods are not readily amenable or efficient at recalculating financial models when one or more of the business assumptions underlying the analyzed business decision is altered. What is needed are systems and methods for providing relevant information about the effects of business decisions to those involved in approving the decisions, while providing flexibility and efficiency in adjusting to changes in the information underlying the financial analysis of the business decision.

The art is also in need of systems and methods for making the preparation and presentation of financial analyses more efficient. For example, at present, expensive and complex marketing and demonstrations are needed to link providers of improved business management systems with the businesses who need their products and services and to convince the businesses to purchase and implement the products and services. This is particularly true in the area of information technology where every major corporation in the world has at least one thing in common—their companies are computerized. However, the entire process of buying and selling information technology hardware, software, and services is grossly inefficient. As a result, in today's more than $555 billion worldwide information technology market, approximately $85 billion is wasted due to the inability of information technology sellers and buyers to quantify the value of the solutions and systems that are to be implemented.

Sellers of information technology suffer from a number of problems and inefficiencies. The inability of information technology suppliers to differentiate themselves based on value, and their subsequent failure to be rewarded with future sales for providing that value, is causing the cost of sales to escalate. In particular, the software market is characterized by sales and marketing costs ranging from a low of 32% (Microsoft) to a high of 70% (Cognos) of revenue. As a result, from 1992 to 1997, the cost of sales for software vendors rose $10 billion, while net income rose less than $3 billion. In part, these expenses represent an accumulation of unaddressed inefficiencies that needlessly lengthen the sales process: quality lead generation is expensive and time-consuming; solutions are sold based on features and price, not value; access to purchasing power is elusive; and resources are wasted on promotional materials, proposals and demonstration, rather than on quantifying business problems and solutions. However, it is the inability to quantify the value of information technology solutions continually that prevents sellers from reaping the greatest economic benefits—those achieved when a client move from a basic to a preferred level relationship. When this occurs, customer loyalty rises, repurchase levels grow, buying time frames accelerate, and buyers are willing to pay a modest premium for products and services.

Buyers of information technology also suffer from a number of problems and inefficiencies. For every dollar sellers spend on the sales process, buyers spend approximately five, often on the wrong product. This occurs for a number of reasons including: buyers lack the time to learn complex products and determine the business impact; buyers spend too much time buying; buyers lack a single measure by which to compare products; and buyers lack sufficient support data to manage the deployment of projects. These inefficiencies often result in information technology purchases being made based on a simple price comparison rather than a value justification system. As information technology becomes more widespread and increasingly complex, its cost of purchase has become an increasing burden. The average Fortune 500 firm currently authorizes over 300 employees to purchase information technology solutions, and they buy more than 1000 products annually. Inefficient buying practices dramatically raise the cost of their purchases. Though this is true for all information technology purchases, the problem is exacerbated for the multitude of relatively small purchases. Whereas the typical purchase of a million dollar solution may entail an additional 42% in buying costs, this figure increases to 180% for purchases under $50,000. This increasing cost of sales is a predominant cause of the spectacular growth in the Sales Force Automation (SFA) and Customer Relationship Management market (CRM). These initiatives promise to reduce customer acquisition costs, reduce discounting, and increase customer retention and cross selling. However, according to a detailed survey conducted by the Sentry Group, the only way for this to happen is for information technology providers to continually justify the value of their solution over time. In this area, these products and services fall short. Systems and methods that reduce these costs are needed.

### SUMMARY OF THE INVENTION

The present invention relates to systems and methods for analyzing and presenting user information for cost justification. For example, the present invention provides systems, methods, and software tools for generating financial summaries and business cases allowing, for example, adjustments for continuous improvements and modified rollout schedules. The present invention also provides methods for facilitating the buying process for sellers and purchasers employing cost justification systems and methods. The present invention further provides systems and methods for generating and integrating knowledge bases and expense rules with the above systems and methods.

In certain embodiments, the present invention provides a method of cost justification analysis for a user comprising; a) providing; i) a user interface capable of receiving user information, ii) a cost justification application operably linked to the user interface, and iii) a computer system comprising the cost justification application, b) receiving the user information by way of the user interface, and c) processing the user information with the cost justification application to generate results. In some embodiments, the user information is buyer information. In other embodiments, the user information is knowledge base information. In further embodiments, the user information is rollout schedule information. In still other embodiments, the user information is expense rule information. In other embodiments, the user information is selected from buyer information, rollout schedule information, knowledge base information, expense rule information, and combinations thereof.

In certain embodiments, the present invention provides a method of cost justification analysis for a user comprising; a) providing; i) a user interface capable of receiving user information, ii) a cost justification application operably linked to the user interface, and iii) a computer system comprising the cost justification application, b) receiving the user information by way of the user interface, c) processing the user information with the cost justification application to generate results, d) modifying the user information to generate modified user information, and e) processing the user information with the cost justification application to generate modified results. In some embodiments, the user information modified is buyer information. In other embodiments, the user information modified is knowledge base information. In further embodiments, the user information modified is rollout schedule information. In still other embodiments, the user information modified is expense rule information. In other embodiments, the user information modified is selected from buyer information, rollout schedule information, knowledge base information, expense rule information, and combinations thereof. In certain embodiments, the method further comprises step f) comparing the results and modified results. In some embodiments, the results and the modified results comprise financial summaries. In other embodiments, the results and modified results comprise business cases. In some embodiments, the modifying step comprises changing a single number. In other embodiments, the modifying step comprises changing multiple numbers. In further embodiments, the modifying step does not require that the cost justification application be re-configured (e.g., the formula employed does not need to be changed).

In certain embodiments, the present invention provides a method of cost justification analysis for a user comprising; a) providing; i) a user interface capable of receiving user information, ii) a cost justification application operably linked to the user interface, and iii) a computer system comprising the cost justification application, b) receiving the user information by way of the user interface, c) processing the user information with the cost justification application to generate results, d) modifying the user information to generate modified user information, and e) processing the user information with the cost justification application to generate modified results. In some embodiments, the method further comprises step f) comparing the results and the modified results. In certain embodiments, the comparing step allows the most suitable rollout schedule to be determined. In other embodiments, the comparing step allows the impact of different rollout schedules to be determined. In certain embodiments, the comparing step allows the impact of different expense rule to be determined. In particular embodiments, the comparing step allows the suitability of different vendor products to be evaluated (e.g., two or more vendor products may be compared for suitability for a particular user).

In some embodiments, the present invention provides a cost justification system comprising: a) a user interface capable of receiving user information, b) a cost justification application operably linked to the user interface, wherein the cost justification application is capable of processing the user information to generate a result, and c) a computer system having stored therein the cost justification application. In preferred embodiments, the present invention provides a cost justification system comprising: a) a user interface capable of receiving user information, wherein the user information comprises buyer information, b) a cost justification application operably linked to the user interface, wherein the cost justification application comprises knowledge base information, and wherein the cost justification application is capable of processing the user information to generate a result comprising a financial summary, and c) a computer system having stored therein the cost justification application, wherein the computer system comprises computer memory and a computer processor.

In some embodiments, the cost justification application is a software application. In other embodiments, the cost justification application is capable of processing user information to generate results (e.g., the cost justification application comprises a set of instructions that allow information to be processed when the cost justification application is operably linked to a computer processor). In some embodiments, the cost justification application is stored on computer readable medium (e.g., DVDs, CDs, hard disk drives, magnetic tape and servers for streaming media over networks). In other embodiments, the cost justification application is stored on computer memory or a computer memory device. In certain embodiments, the cost justification application comprises user information. In some embodiments, the cost justification application comprises buyer information. In other embodiments, the cost justification application comprises knowledge base information. In still further embodiments, the cost justification application comprises rollout schedule information. In further embodiments, the cost justification application comprises expense rule information. In other embodiments, the cost justification application comprises user information selected from buyer information, rollout schedule information, knowledge base information, expense rule information, or combinations thereof

In some embodiments, the computer system comprises computer memory or a computer memory device and a computer processor. In some embodiments, the computer memory (or computer memory device) and computer processor are part of the same computer. In other embodiments, the computer memory device or computer memory are located on one computer and the computer processor is located on a different computer. In some embodiments, the computer memory is connected to the computer processor through the Internet or World Wide Web. In some embodiments, the computer memory is on a computer readable medium (e.g., floppy disk, hard disk, compact disk, DVD, etc). In other embodiments, the computer memory (or computer memory device) and computer processor are connected via a local network or intranet. In some embodiments, the cost justification application is stored on the computer memory or computer memory device. In some embodiments, the computer system further comprises computer readable medium with the cost justification application stored thereon. In further embodiments, the computer system comprises the computer memory, computer processor, and the cost justification application is located on the computer memory, and the computer processor is able to read the cost justification application from the computer memory (e.g., ROM or other computer memory) and perform a set of steps according to cost justification application. In certain embodiments, the computer system comprises a computer memory device, a computer processor, an interactive device (e.g., keyboard, mouse, voice recognition system), and a display system (e.g., monitor, speaker system, etc.).

In certain preferred embodiments, the present invention provides a method of cost justification analysis for a user comprising; a) providing; i) a user interface capable of receiving user information, wherein the user information comprises buyer information, ii) a cost justification application operably linked to the user interface, wherein the cost justification application comprises knowledge base information, and iii) a computer system having stored therein the cost justification application, wherein the computer system comprises computer memory and a computer processor, b) receiving the user information by way of the user interface, and c) processing the user information with the cost justification application to generate results.

In some embodiments of the system and methods of the present invention, the user interface is a written document capable of being viewed by a user. In further embodiments, the user interface is telephone capable of receiving responses from a user (e.g., pre-recorded telephone message of questions or questions presented by an operator). In preferred embodiments, the user interface is a graphical user interface (e.g., a user interface screen presented on a computer monitor).

In some embodiments of the methods of the present invention, the user information is received by way of the user interface. In some embodiment, the receipt of the user information is by way of receiving oral communication with a user. In other embodiments, the receipt of the user information is by way of receiving a written document from a user (e.g., received through the mail system). In preferred embodiments, the receipt of the user information is by way of receiving an electronic communication (e.g., over telephone lines, cable lines, or a broadcast electronic communication). In some embodiments, the receipt of the user information is by receiving a facsimile transmission, an e-mail, or information entered into a web site.

In some embodiments of the methods of the present invention, user information is processed with the cost justification application to generate results. In some embodiments, the cost justification application is operably linked to the computer processor such that the cost justification application is able to process the user information. In some embodiments, the cost justification application is physically located in the same computer as the computer processor. In other embodiments, the cost justification application is in a different computer than the computer processor and the cost justification application and computer processor are operably linked (e.g., there is an electronic connection between the computer processor and the cost justification application). In some embodiments, the electronic connection is selected from phone lines, cable lines, broadcast transmission, or combinations thereof.

In certain embodiments, the user information further comprises survey data information. In other embodiments, the cost justification application further comprises a survey generator (e.g., for tracking the results of the implementation of a vendor product). In particular embodiments, the survey generator is capable of generating survey data. In some embodiments, the survey generator comprises a series of questions regarding the implementation of a vendor solution. In certain embodiments, said knowledge base information further comprises survey data information.

In certain preferred embodiments, the present invention provides a method of cost justification analysis for a user comprising; a) providing; i) a user interface capable of receiving user information, wherein the user information comprises buyer information, ii) a cost justification application operably linked to the user interface, wherein the cost justification application comprises knowledge base information, and iii) a computer system having stored therein the cost justification application, wherein the computer system comprises computer memory and a computer processor, b) receiving the user information by way of the user interface, c) processing the user information with the cost justification application to generate results, and d) displaying the results to a user. In some embodiments, the results are displayed on a computer screen. In other embodiments, the results are displayed on paper. In certain embodiments, the results are displayed audibly (e.g., over the telephone or a speaker system). In particularly preferred embodiments, the results are displayed on a web site.

In some embodiments, the systems and methods of the present invention comprise knowledge base information. In certain embodiments, the knowledge base information comprises expected improvement information. In other embodiments, the expected improvement information comprises expected cost reductions. In some embodiments, the expected improvement comprises expected revenue increases. In some embodiments, knowledge base information comprises user criteria (e.g., the number and identity of factors that should be measured by the methods of the present invention to provide a useful financial analysis). In some embodiments, the user criteria comprises worker roles and activities empirically determined to be useful for providing a useful financial analysis. In still other embodiments, the expected improvement information comprises expected cost reductions, expected revenue increases, user criteria, or any combination thereof.

In certain embodiments, the knowledge base information comprises historical information generated over time in an industry based on past results of implementing a vendor's solution or similar solutions. In some embodiments, the knowledge base information is already present in the cost justification application. In other embodiments, the information is received in the user interface. In some embodiments, a portion of the knowledge base information is present in the cost justification application and a portion is received in the user interface. In still other embodiments, the knowledge base information is supplemented with survey data information. In yet other embodiments, the knowledge base information is particular to a certain industry (e.g., industrial, computer related, pharmaceutical, etc). In other embodiments, the knowledge base information is particular to a particular vendor product type (e.g., data warehousing automation). In preferred embodiments, the knowledge base information is particular to a certain vendor product (e.g., based on information supplied by the vendor, information gathered in the industry, or survey generated information). In particular embodiments, the knowledge base information is present in the cost justification application and may be changed (e.g., to reflect a more conservative estimate of expected cost reductions or expected revenue increases, or to reflect survey data information).

In some embodiments, the systems and methods of the present invention comprise rollout schedule information. In some embodiments, the rollout schedule information is information describing the timing of when a proposed product is to be implemented in an organization. In certain embodiments, rollout schedule information is employed to account for a deployment of vendor's product (i.e. an investment) across a business that happens incrementally (e.g., the employees of the company may not all have access to the solution as the same time). In some embodiments, rollout schedule information is received by way of the user interface of the present invention. In other embodiments, the rollout schedule information is already present in the cost justification application of the present invention. In still other embodiments, a portion of the rollout schedule information is received by way of the user interface of the present invention, and a portion of the rollout schedule information is already present in the software application of the present invention. In some embodiments, the rollout schedule information is particularized such that it relates to the availability of the solution (vendor product) to a certain type of worker. In further embodiments, rollout schedule information may further detail the availability of a solution to a certain worker role, and further detail what percent of the workers are represented by the role that have access to the vendor product in a given time period.

In some embodiments, the systems and methods of the present invention comprise buyer information. In certain embodiments, buyer information comprises project information. In different embodiments, buyer information comprises personnel information. In certain embodiments, buyer information comprises asset information. In still other embodiments, buyer information comprises financial assumptions. In further embodiments, buyer information comprises project information, personnel information, asset information, financial assumptions, or combinations thereof. In preferred embodiments, buyer information comprises project information, personnel information, asset information, and financial assumptions. In some embodiments, all of the buyer information is received by way of the user interface. In other embodiments, the cost justification application already comprises the buyer information. In preferred embodiments, a portion of the buyer information is received by way of the user interface (e.g., project information, personnel information, and assets information), and a portion of the buyer information is already present in the cost justification application (e.g., financial assumptions).

In certain embodiments buyer information comprises project information. In some embodiments, project information comprises the name of the project, the start date of the project, the length of the project, who the author of the final report is, who the report is being prepared for, what type of industry the user is in, the type of product or service being contemplated (e.g., information technology product for automating data warehouse monitoring), or any combination thereof. In some embodiments, project information is employed by the cost justification application to select the appropriate knowledge base information to apply to the processing of the user information. In other embodiments, the project information is employed by the cost justification application to select the appropriate roles and/or activities to present and process.

In certain embodiments, buyer information comprises personnel information. In some embodiments, personnel information comprises information regarding the total number of users who would utilize the vendor product, workers affected by the vendor product (may be the number of workers by category), data regarding the average salary for each type of worker (or hourly rate of each type of worker along with number of hours worked per year), data regarding the roles of each type of worker (e.g., field technician, contract administrator, call center worker, database administrator, or system administrator), the percent of time a certain type of worker typically spends on a certain type of role, the projected percent growth in the workload for each type of worker, information regarding the type of activities usually associated with each type of worker (e.g., field technician—locating parts and return visits), and combinations thereof.

In some embodiments, buyer information comprises asset information. In certain embodiments, asset information comprises information regarding assets owned by the business or person that are likely to be affected by the contemplated purchase, the amount of the asset owned, the expected growth rate of such assets in the future, and combinations thereof. In some embodiments, buyer information comprises financial assumptions. In certain embodiments, financial assumptions comprise the discount rate, adjustments for risk (e.g., increase costs by and reduce savings by), and combinations thereof.

In some embodiments, the systems and methods of the present invention comprises expense rule information. In certain embodiments, expense rule information comprises information regarding additional expenses that may be incurred as a result of purchasing a vendor product as well as the cost of the vendor product itself. Examples include, but are not limited to, training for personnel or additional hardware (e.g., servers) in order to employ the purchased vendor product effectively. In certain embodiments, expense rule information is processed as a function of the rollout schedule (e.g., the number of servers that need accounted for is a function of the number of employees which is determined by the rollout schedule). In some embodiments, expense rule information is a formula that represents how many servers need to be added based on the number of employees in a certain role. In particular embodiments, expense rule information is received by way of the user interface of the present invention. In other embodiments, the expense rule information is present in the cost justification application. In preferred embodiments, a portion of the expense rule information is received by way of the user interface of the present invention, and a portion of the expense rule information is present in the cost justification application of the present invention.

In some embodiments, the present invention provides a method of cost justification analysis for a user comprising; providing; i) a user interface capable of receiving buyer information and rollout schedule information, ii) a cost justification application operably linked to the user interface, wherein the cost justification application comprises knowledge base information, and iii) a computer system having stored therein the cost justification application, wherein the computer system comprises computer memory and a computer processor, b) receiving the buyer information and the rollout schedule information by way of the user interface, c) processing the buyer information with the cost justification application to generate business as usual results, and d) processing the buyer information, as a function of both the rollout schedule information and the knowledge base information, with the cost justification application to generate vendor results. In further embodiments, the method further comprises step e) processing the business as usual results, and the vendor product results, with the cost justification application to generate results comprising a financial summary. In some embodiments, steps c) and d) occur simultaneously. In different embodiments, step d) occurs before step c).

Some embodiments of the systems and methods of the present invention comprise the generation and/or display of results. In certain embodiments, the results comprise business as usual results. In other embodiments, the results comprise vendor results. In still other embodiments, the results comprise economic benefits results. In certain embodiments, the results comprise savings results. In further embodiments, the results comprise additional expense results. In some embodiments, the results comprise an executive summary. In some embodiments, the results comprise financial summary values (e.g., Net Cash Flow, Discounted Cash Flow, Internal Rate of Return, and Payback Period). In other embodiments, the results comprise a cash flow statement (cash flow results). In some embodiments, the results comprise a financial summary (e.g., financial summary values or cash flow statements).

In some embodiments, the results comprise a financial summary. In other embodiments, the financial summary comprises a business case. In some embodiments, the business case comprises a business impacts component. In additional embodiments, a business case comprises a business impacts component and an assumptions and methods component. In further embodiments, the business case comprises a business impacts component, an assumptions and methods component, and a sensitivity, risks, and contingencies component. In a different embodiment, the business case comprises a business impacts component, an assumptions and methods component, and an introduction and overview component. In a preferred embodiment, the business case comprises a business impacts component, an assumptions and methods component, an introduction and overview component, and a sensitivity, risks and contingencies component. In additional embodiments, the business case comprises a business impacts component, an assumptions and methods component, an introduction and overview component, a sensitivity, risks and contingencies component, and a conclusions and recommendations component.

In some embodiments of the present invention, the business case comprises an introduction and overview component. In certain embodiments, the introduction and overview component comprises a title and subtitle (e.g., to identify the nature of the proposed vendor product and type of analysis), an address header (e.g., “To” and “From” headers), the date on which the report was completed, a subject section (e.g., to describe the proposed action and the objectives of this action), a stated purpose of the business case, a disclaimer, an executive summary, an approach section, and combinations thereof.

In some embodiments of the present invention, the business case comprises an assumptions and methods component. In certain embodiments, the assumptions and methods component comprises an assumptions section (e.g., for prediction, simplification, and clarification), a rollout schedule (e.g., to present the rollout schedule information used to generate the business case), a scope and boundaries section (e.g., to set out the dimensions of the business case and provides the rules for deciding what type of data is included in the business case, and what type of data is left out), a cost/benefit data section, data sources and methods, and combinations thereof.

In some embodiments of the present invention, the business case comprises a business impacts component. In certain embodiments, the business impact component comprises financial summary values, cash flow statements, a financial model (e.g., pie charts, graphs, charts, and spreadsheets), additional expenses (e.g., caused by purchasing the vendor product), additional economic benefits, a cash flow statement, an analysis of results section, and combinations thereof.

In some embodiments of the present invention, the business case comprises a sensitivity and risks component. In certain embodiments, the sensitivity and risks component comprises a sensitivity analysis section, a risk analysis section, and combinations thereof. In some embodiments of the present invention, the business case comprises a conclusions and recommendations section. In certain embodiments, the conclusions and recommendations section comprises a conclusions section, a recommendations section, and combinations thereof.

In some embodiments, the present invention provides a cost justification system comprising; a) a user interface capable of receiving user information, wherein the user information comprises buyer information, b) a cost justification application operably linked to the user interface, wherein the cost justification application comprises knowledge base information, and wherein the cost justification application is capable of processing the user information to generate a result comprising a financial summary, c) a computer system having stored therein the cost justification application, wherein the computer system comprises computer memory and a computer processor, and d) an intermediary service provider operably linked to the computer system, wherein the intermediary service provider is capable of displaying the user interface and the result to a user.

In certain embodiments, the intermediary service provider comprises a hosted electronic environment. In some embodiments, the hosted electronic environment is located on the Internet. In other embodiments, the hosted electronic environment is located on the world wide web. In still other embodiments, the hosted electronic environment is located on an intranet. In preferred embodiments, the hosted electronic environment comprises a web site.

In certain embodiments, the present invention provides a method of cost justification for a user comprising; a) providing; i) a user interface capable of receiving user information, wherein the user information comprises buyer information, ii) a cost justification application operably linked to the user interface, wherein the cost justification application comprises knowledge base information, iii) a computer system having stored therein the cost justification application, wherein the computer system comprises computer memory and a computer processor, and iv) a hosted electronic environment operably linked to the computer system, b) displaying the user interface on the hosted electronic environment, c) receiving the user information by way of the user interface, and d) processing the user information with the cost justification application to generate results comprising a financial summary. In certain embodiments, the method further comprises step e) of displaying the results on the hosted electronic environment. In particular embodiments, the method further comprises a step before step e) of receiving compensation for displaying said results. In further embodiments, the method further comprises a step before step b) of receiving compensation for displaying the user interface (e.g., to a user). In some embodiments, the compensation is selected from money, an agreement to provide survey data, publicity, providing a hyperlink to the hosted electronic environment, and combinations thereof. In some embodiments, the user information further comprises survey data information. In yet other embodiments, the method further comprises a step before step b) of supplementing the knowledge base information with the survey data information.

In other embodiments, the present invention provides a method for cost justification analysis for a user comprising; a) providing; i) a user interface capable of receiving buyer information and rollout schedule information, ii) a cost justification application operably linked to the user interface, wherein the cost justification application comprises knowledge base information, iii) a computer system having stored therein the cost justification application, wherein the computer system comprises computer memory and a computer processor, and iv) a hosted electronic environment operably linked to the computer system, b) displaying the user interface on the hosted electronic environment, c) receiving the buyer information and the rollout schedule information by way of the user interface, d) processing the buyer information with the cost justification application to generate business as usual results, and e) processing the buyer information, as a function of both the rollout schedule information and the knowledge base information, with the cost justification application to generate vendor product results. In some embodiments, the method further comprises step f) processing the business as usual results and the vendor results with the cost justification application to generate results comprising a financial summary. In further embodiments, the financial summary comprises a business case. In particular embodiments, steps d) and e) occur simultaneously. In other embodiments, step e) occurs before step d). In some embodiments, the method further comprises a step before step b) of receiving compensation for displaying the user interface.

### DESCRIPTION OF THE FIGURES

FIGS. 1A-P show exemplary business cases prepared using certain embodiments of the present invention.

FIG. 2 shows a user interface screen provided in one embodiment of the cost justification software of the present invention.

FIG. 3 shows a user interface screen provided in one embodiment of the cost justification software of the present invention.

FIG. 4 shows a user interface screen provided in one embodiment of the cost justification software of the present invention.

FIG. 5 shows a user interface screen provided in one embodiment of the cost justification software of the present invention.

FIG. 6 shows a user interface screen provided in one embodiment of the cost justification software of the present invention.

FIG. 7 shows a user interface screen provided in one embodiment of the cost justification software of the present invention.

FIG. 8 shows a user interface screen provided in one embodiment of the cost justification software of the present invention.

FIG. 9 shows a user interface screen provided in one embodiment of the cost justification software of the present invention.

FIG. 10 shows a user interface screen provided in one embodiment of the cost justification software of the present invention.

FIG. 11 shows a user interface screen provided in one embodiment of the cost justification software of the present invention.

FIG. 12 shows a user interface screen provided in one embodiment of the cost justification software of the present invention.

FIG. 13 shows a spreadsheet-based calculation system in one embodiment of the present invention.

FIG. 14 shows a spreadsheet-based calculation system in one embodiment of the present invention.

FIG. 15 shows a spreadsheet-based calculation system in one embodiment of the present invention.

FIG. 16 shows a spreadsheet-based calculation system in one embodiment of the present invention.

FIG. 17 shows a spreadsheet-based calculation system in one embodiment of the present invention.

FIG. 18 shows a spreadsheet-based calculation system in one embodiment of the present invention.

FIG. 19 shows a spreadsheet-based calculation system in one embodiment of the present invention.

FIG. 20 shows a spreadsheet-based calculation system in one embodiment of the present invention.

FIG. 21 shows a spreadsheet-based calculation system in one embodiment of the present invention.

FIG. 22 shows a spreadsheet-based calculation system in one embodiment of the present invention.

FIG. 23 shows a spreadsheet-based calculation system in one embodiment of the present invention.

FIG. 24 shows a spreadsheet-based calculation system in one embodiment of the present invention.

FIG. 25 shows a spreadsheet-based calculation system in one embodiment of the present invention.

FIG. 26 shows a spreadsheet-based calculation system in one embodiment of the present invention.

FIG. 27 shows a spreadsheet-based calculation system in one embodiment of the present invention.

FIG. 28 shows a spreadsheet-based calculation system in one embodiment of the present invention.

FIG. 29 shows a spreadsheet-based calculation system in one embodiment of the present invention.

FIG. 30 shows a user interface screen provided in one embodiment of the cost justification software of the present invention.

FIG. 31 shows a user interface screen provided in one embodiment of the cost justification software of the present invention.

FIG. 32 shows a user interface screen provided in one embodiment of the cost justification software of the present invention.

FIG. 33 shows a user interface screen provided in one embodiment of the cost justification software of the present invention.

### GENERAL DESCRIPTION OF THE INVENTION

The present invention relates to systems and methods for analyzing and presenting user information for cost justification. For example, the present invention provides systems, methods, and software tools for generating financial summaries and business cases allowing, for example, adjustments for continuous improvements and modified rollout schedules. The present invention also provides methods for facilitating the buying process for sellers and purchasers employing cost justification systems and methods. The present invention further provides systems and methods for generating and integrating knowledge bases and expense rules with the above systems and methods.

In some embodiments, the present invention provides software applications for receiving user information related to the implementation of a business decision (e.g., a decision to purchase and implement new software), manipulating the data, and providing a summary that allows decision-makers within a company to evaluate the merits of implementing the business decision. The cost justification software of the present invention finds use in the analysis of any type of business decision implementation including, but not limited to, the implementation of information technology management applications and services. Examples of information technology management applications and services include, but are not limited to, those used in data warehouse management, application service provider systems, and business to business management systems.

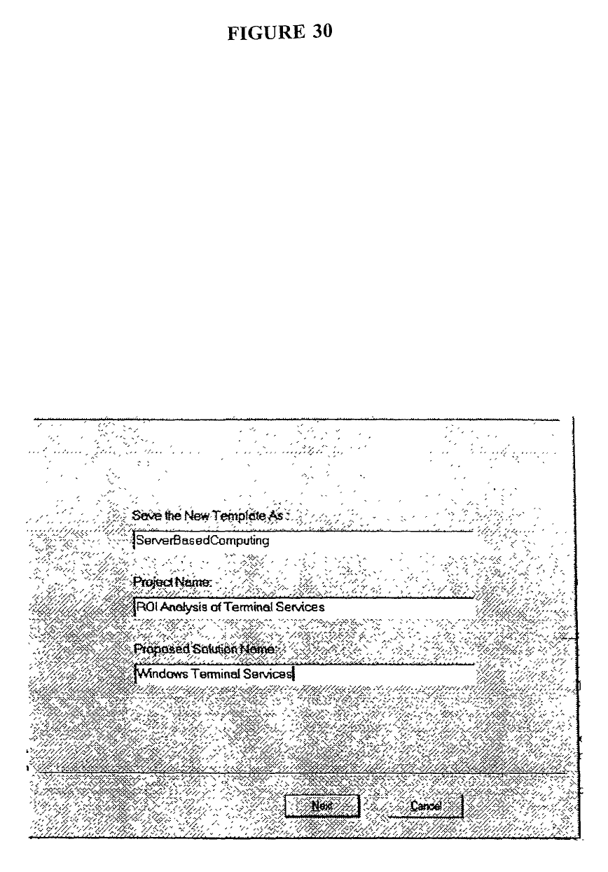

In some embodiments, the software and methods of the present invention guides the user to input a select set of user criteria that are particularly relevant to analyzing the merits of implementing the business decision (i.e. the relevant roles and activities). The choice of the user criteria is based on a knowledge base either provided by the software or generated through the use of the software application. In preferred embodiments, the user criteria are limited to one to several roles (i.e., elements that affect cost, revenue, or assets of the company—e.g., system administrators in charge of a certain task within the company) and one to several activities associated with each role (i.e., events associated with a role that directly impact cost, revenue, or assets—e.g., amount of time each system administrator spends carrying out a certain task associated with the job). In some embodiments, the cost justification software automatically provides the roles and activities to be monitored (e.g., based on the type of product or service the user has entered to be analyzed and a knowledge base associated with this type of product or service). In other embodiments, the user decides which roles and activities to monitor (e.g., by entering the roles and activities to be monitored and the savings and/or expenses associated with each—see FIGS. 30-33). Although a great number of roles or activities may be affected by the implementation of a business decision, in preferred embodiments of the present invention, only a relevant sub-set of the total are inputted into the software. The selection of user criteria, which may be based on a knowledge base, simplifies the calculations and resulting report, while maintaining relevancy and maximizing persuasive impact and readability by a decision-maker in charge of adapting the business decision. However, the present invention is not limited by the number of roles and activities analyzed. For example, in some embodiments, all known roles and activities may be analyzed.

Once the user criteria (e.g., roles and activities) are selected, a user inputs user information pertaining to the roles and activities into the software (e.g., using a graphical user interface (GUI)). The software then performs the relevant calculations and generates a result. In preferred embodiments, the result is a business case. The business case generated provides information relevant to the decision-maker who must decide whether or not to implement the business decision (i.e., purchase the vendor product), while excluding extraneous information or minimizing and summarizing less relevant information.

Importantly, the cost justification software in the systems and methods of the present invention allow a user to specify rollout information regarding the business decision (e.g., specify the financial period in which the business decision is to be implemented for each role). The cost justification software also allows the rollout information to be changed by simply changing, for example, a single entry in the user interface. The software then automatically recalculates the relevant information and provides a new result based on the new rollout schedule information. In addition to rollout schedule information, any of the criteria can be easily changed (e.g., the identity of the roles and activities as well as the financial assumptions and financial data), allowing recalculation and the generation of a new result. Thus, the cost justification software provides tremendous ease-of-use and flexibility.

In certain embodiments of the present invention, the cost justification software further simplifies the process by providing pre-selected knowledge base information. For example, in some embodiments of the present invention, the cost justification software selects from one or more knowledge base databases, information relevant to a particular user (e.g., a user who is a member of a certain category of business type). Such information may comprise survey data (e.g., data obtained from surveys of the user's company or similar companies or may comprise empirical data obtained from the implementation of similar business decisions by other companies) or user criteria. Such knowledge base information includes, but is not limited to, the appropriate roles and activities for a particular company (e.g., the most relevant roles and activities for a company implementing an application service provider) and the particular expected cost reductions, revenue increases, or asset changes to be expected following the implementation of a particular business decision. In such embodiments, the amount of information that needs to be entered by the user is minimized and the quality of the output report is improved (e.g., because the calculations are based on empirical data rather than projections or predictions, and are focused on the one or few roles and activities that truly summarize the benefits and costs of implementation).

In certain embodiments of the systems and methods of the present invention, the cost justification software allows a user to enter expense rule information to account for additional expenses that may be incurred as a result of a purchase. In some embodiments, the software has expense rule information already present (e.g., from a knowledge base), based on the actual product being analyzed (e.g., an expense rule that adds the cost of the product to the first year of the calculations). In other embodiments, a user enters expense rule information particular to their business in order to customize the cost justification analysis. Importantly, the cost justification software of the present invention is able to process expense rules as a function of rollout schedule information. For example, a buyer of computer servers, who would incur an additional expense of one server for every 20 database administrators rolled out, could enter an expense rule dependent on database administer rollout and allow the software to include costs associated with the additional server at the appropriate time (i.e., based on the rollout schedule of the database administrators provided by the user).

Furthermore, since the software allows the rollout schedule information to be changed by simply changing a single entry in the user interface, in some embodiments of the present invention, the software automatically recalculates additional expenses dependent on the rollout schedule information, based on the expense rules that have been entered (or are present initially in the software through use of a knowledge base). This greatly simplifies the analysis, as the expense rules do not have to be recalculated or re-entered by the user once provided. In addition to rollout schedule information, any of the criteria can be easily changed (e.g., the identity of the roles and activities as well as the financial assumptions and financial data), allowing recalculation and the generation of a new result that automatically incorporates the expense rules entered by the user (i.e., adding additional expenses in the appropriate amounts at the appropriate time). Thus, the cost justification software provides tremendous ease-of-use and flexibility, while allowing a user to customize their cost justification analysis.

The cost justification software may be provided to the user in any suitable format. For example, the software may be provided on a computer readable medium (e.g., floppy disk, CD, or DVD) or on a computer. The cost justification software may also be made available to a user (or user's computer) or data input module through a public or private network. For example, the cost justification software may be made available over the Internet or similar public networks. The cost justification software may also be provided as a service where the user provides the data input information and the service inputs the information, generates the result, and provides the result to the user.

The present invention is not limited by the nature of the user. The user may be any individual or corporation. In some embodiments, the user is a company or individual attempting to sell business management applications and services (e.g., to another company or individual). For example, the software and methods of the present invention allow such entities to prove to their prospective customers that the implementation of their product is beneficial to the purchaser. Business cases generated using the methods and systems of the present invention are particularly suited to such applications as they quickly and efficiently provide information needed by the company's decision-maker in deciding whether or not to purchase the product. The systems and methods of the present invention also provide means to quickly generate new reports based on different criteria (e.g., criteria other than those original considered) that the decision-maker wishes to see.

The following description provides one illustrative example of the use of the systems and methods of the present invention. This example is meant to merely illustrate certain preferred embodiments and is not meant to limit the scope of the present invention. In this example, Company A sells chemical inventory software to chemical companies to help manage their inventories. The software better tracks the location of chemicals in the company's various storage facilities, tracks delivery vehicles, and automates certain tasks normally conducted by telephone operators. Using the systems of the prior art, the company consistently fails to make a sale of the software to Company B, a large chemical company, because Company A cannot provide a concise, relevant, detailed, and flexible business case that simply and clearly illustrates the benefit of its products and services to Company B. However, using the systems and methods of the present invention, Company A quickly produces a business case and closes the sale with the chief financial officer of Company B. Specifically, the cost justification software of the present invention directs Company A to select two or three roles (e.g., delivery personnel, etc.) and two or three activities for each role (e.g., for delivery personnel: average distance driven from warehouse to customer, number of return customer visits because of incorrect delivery, etc.). The roles and activities are selected by guiding the user to select roles and activities that capture a significant percent of the total net benefit of Company A's product (e.g., 70%) or they are selected automatically from a knowledge base created through data collection of other companies employing similar management systems (e.g., other chemical companies employing management systems from Company A or similar management systems). Once the roles and activities are selected, the user then inputs user information corresponding to the roles and activities and a business case is generated and provided to Company B. As desired (e.g., upon the request of Company B), changes can be made quickly, and new results generated. For example, Company A can demonstrate the differences caused by rolling out Company A's products and services in a particular accounting period for each role/activity as opposed to other time periods. Unlike the systems and methods of the prior art, Company A's use of the systems and methods of the present invention provide an integration of capital budgeting and continuous improvement techniques by tracking activity costs and their related outputs and measuring them over time. Unlike the systems and methods of the prior art, the present invention requires very few inputs and requires little to no action to re-calculate a business case when a change is required. Also, unlike the systems and methods of the prior art, the present invention allows incorporation of a knowledge base information into the methods for generating informative and concise results (e.g., business cases).

The present invention further provides novel systems and methods for implementing and promoting the above cost justification software, systems, and methods. For example, the present invention provides an intermediary service for use by service vendors (e.g., vendors of software packages and services for improving and managing the operation of client customers) and/or their clients (e.g., businesses implementing the vendors' software packages and services). In one such embodiment, the intermediary service provides the vendor access to the software of the present invention so that the vendor can prove to their prospective clients that the vendor's products are worth purchasing. In some embodiments of the present invention, the intermediary service provides an electronic portal (e.g., an Internet Web site) that is accessible by vendors and their clients (i.e., buyers). In certain preferred embodiments, the electronic portals is designated for certain subject matter-specific classes of vendors and buyers (e.g., companies concerned about data warehouses, application service providers, business to business procurement, business to business electronic services, etc.). Thus, the subject-matter-specific portals provide means for vendors and clients to identify each other and to determine if they wish to enter into business with one another. The cost justification software of the present invention is available at such portals so that the vendor and buyer can intelligently choose to work with one another.

In certain embodiments of the present invention, the portals may be used by vendors to exhibit their goods and services and may be used by buyers to place bids for such goods and services. For example, the intermediary service may host an electronic environment (e.g., a Web site), where vendors post a model of their systems using the cost justification software of the present invention (e.g., post a version of the cost justification software of the present invention incorporating financial details specific for the package sold by the vendor). In some embodiments of the present invention, these posted models include input fields where a buyer enters their specific financial information to determine the benefits of purchasing the vendor's system. The buyer may sample a number of vendors to identify the best product. Thus, the present invention provides systems and methods for delivering the greatest value to buyers and maximizing competition and efficiency of vendors. In certain embodiments, of the present invention, the buyers post bids at the hosted electronic environment, and vendors compete to acquire the buyers business by demonstrating the savings generated by their systems (e.g., using the cost justification software of the present invention).

The portals also offer the opportunity to gather information for developing the knowledge bases of the present invention and to disseminate such knowledge bases through enhanced software packages incorporating the information. For example, the ability to have access to the portals or the knowledge bases can be made contingent on providing information useful for generating knowledge bases (e.g., providing survey answers). Alternately, the cost of gaining access may be reduced (or some other incentive provided) for those willing to contribute information to the knowledge base information. In other embodiments of the present invention, the actions of vendors and buyers are tracked (e.g., by employing cookies) to generate information for the knowledge base (e.g., sample business cases generated or data entered during the activities at the portal are tracked and recorded to identify and catalogue buyer and vendor identities, interests, and user information, financial data).

Definitions

To facilitate an understanding of the present invention, a number of terms and phrases are defined below:

As used herein, the term “vendor product” or “vendor's product” or “vendor's solution” refers to goods (e.g., software application) or services (e.g., configuring an organization's computer systems or training employees) or a combination of both, that may be purchased by a buyer. One example incudes information technology software applications and support systems designed to streamline and optimize the computer systems of an organization (e.g., improve data warehousing capabilities).

As used herein, the term “expected improvement information” refers to the effect a vendor's product is likely to have on the financial status of an organization or individual purchasing and implementing the vendors product. Examples of expected improvement include, but are not limited to, expected cost reductions and expected revenue increases. Expected improvement information may be based on empirical data and may comprise projections and/or estimates.

As used herein the term “expected cost reductions” refers the amount or percent of resources that are expected to be conserved by purchasing/implementing a vendor's solution. One example is the reduced need to purchase new disk space for an organization due the increase efficiency of utilization. This may be expressed as percent reduction in the need for disk space.

As used herein, the term “expected revenue increases” refers the amount or percent of increased revenue that is expected to accrue to the organization by purchasing/implementing a vendor's solution. One example is the increased revenue generated by a certain type of employee (e.g., call center worker) due the increased ability to get more work done per unit of time using the vendor's product.

As used herein, the term “intermediary service provider” refers to an agent providing a forum for vendors and buyers to interact with each other (e.g., identify each other, conduct commerce, etc). For example, an intermediary service provider may provide a forum for vendors to demonstrate a cost justification analysis of their product (e.g., by providing the cost justification application of the present invention configured for the vendor's product), or provide a forum for buyers to receive cost justification analysis for one or more vendor products (e.g., to facilitate the selection of a vendor or vendor product). The intermediary service also allows, for example, vendors to receive information regarding the identity and needs of buyers (e.g., provide access to opt-in email lists or other contact information), and for the collection of survey data. In some embodiments, the intermediary service provider is a hosted electronic environment located on the Internet or World Wide Web.

As used herein, the term “Hyperlink” refers to a navigational link from one document to another, or from one portion (or component) of a document to another. Typically, a hyperlink is displayed as a highlighted word or phrase that can be selected by clicking on it using a mouse to jump to the associated document or documented portion.

As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

As used herein, the terms “World Wide Web” or “Web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the term “Web Site” refers to a computer system that serves informational content over a network using the standard protocols of the World Wide Web. Typically, a Web site corresponds to a particular Internet domain name, such as “proveit.net/” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

As used herein, the term “HTML” refers to HyperText Markup Language which is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

As used herein, the term “HTTP” refers to HyperText Transport Protocol which is the standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

As used herein, the term “URL” refers to Uniform Resource Locator which is a unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

As used herein, the term “Cookies” refers to a technology that enables a Web server to retrieve information from a user's computer that reveals prior browsing activities of the user. The informational item stored on the user's computer (typically on the hard drive) is commonly referred to as a “cookie.” Many standard Web browsers support the use of cookies.

As used herein, the terms “computer memory” and “computer memory device” refer to any storage media readable by a computer processor. Examples of computer memory include, but are not limited to, RAM, ROM, computer chips, digital video disc (DVDs), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks.

As used herein, the terms “computer processor” and “central processing unit” or “CPU” are used interchangeably and refers to a device that is able to read a program from a computer memory (e.g., ROM or other computer memory) and perform a set of steps according to the program.

As used herein, the term “hosted electronic environment” refers to an electronic communication network accessible by computer for transferring information. One example includes, but is not limited to, a web site located on the world wide web.

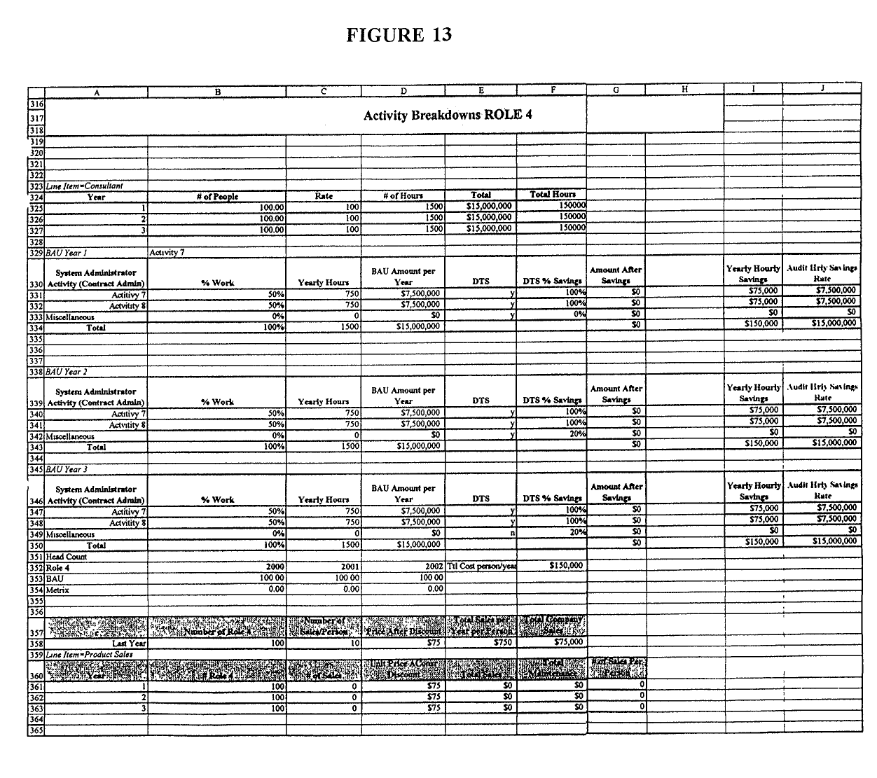

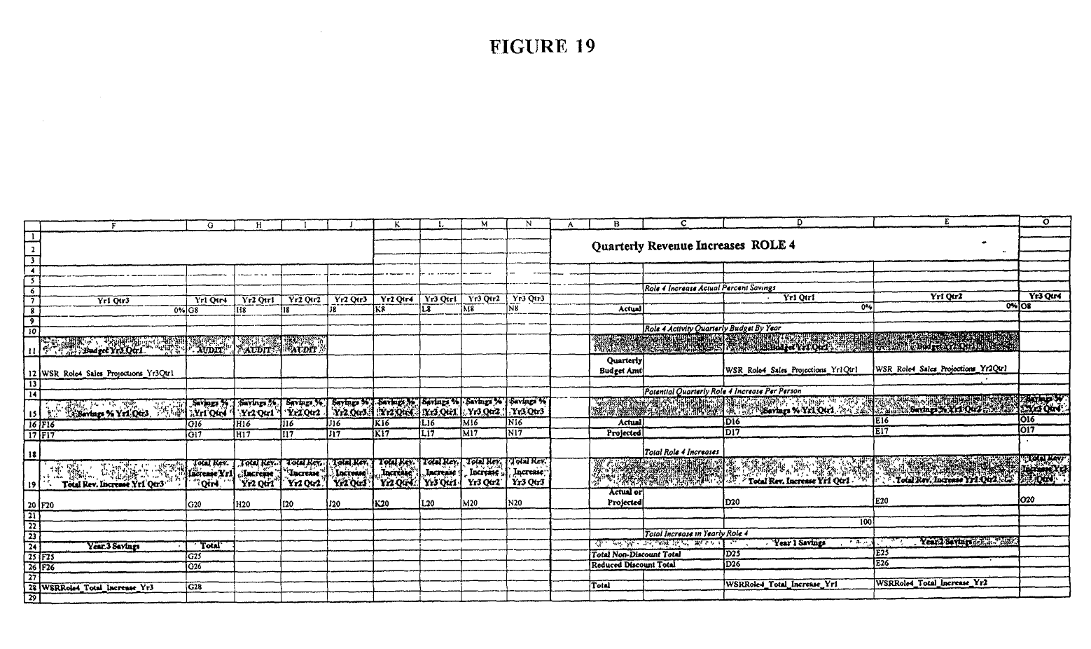

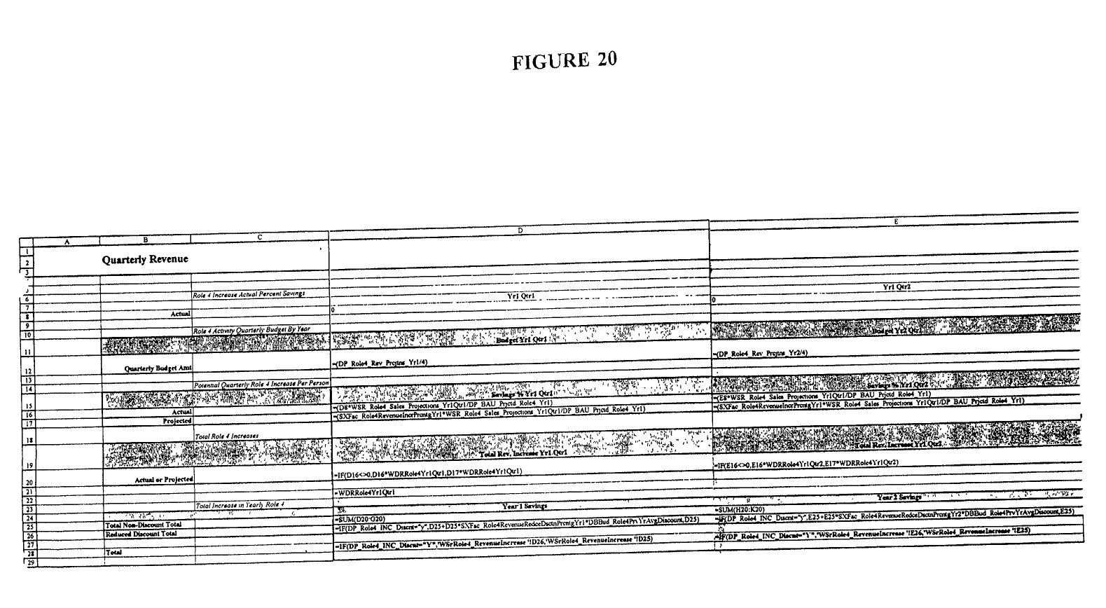

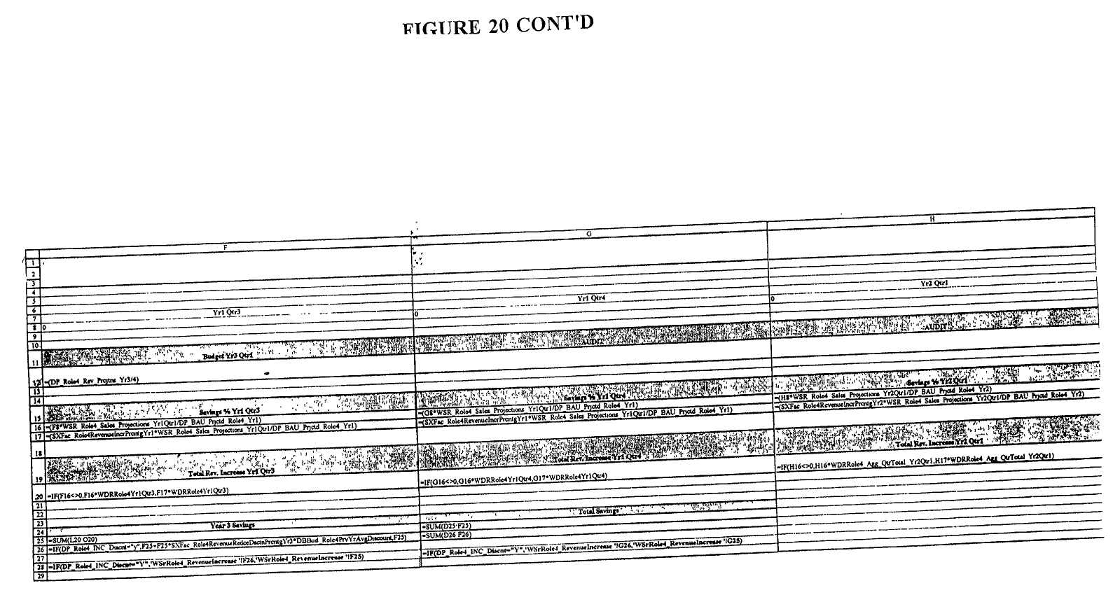

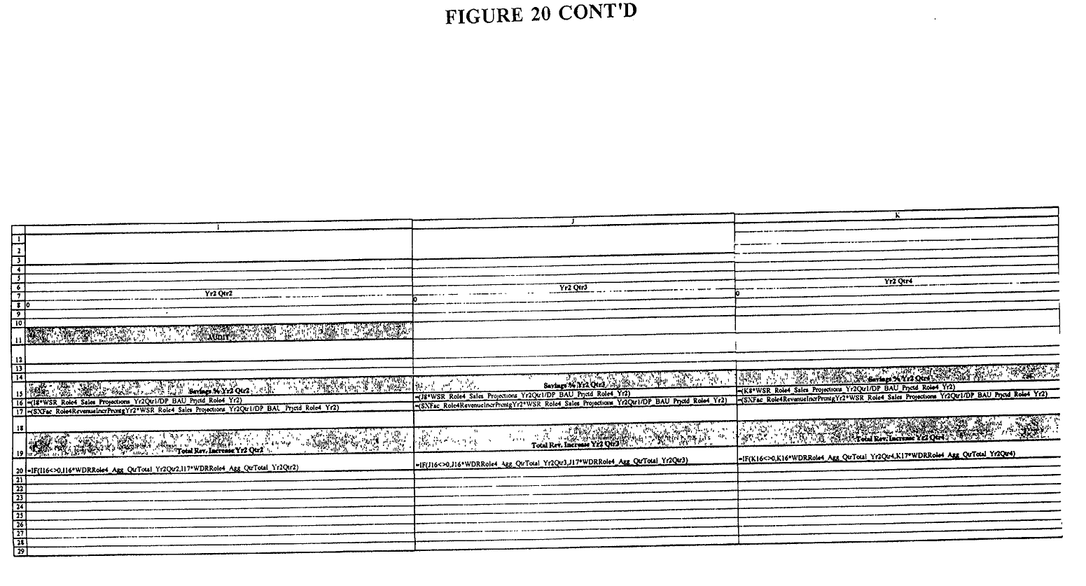

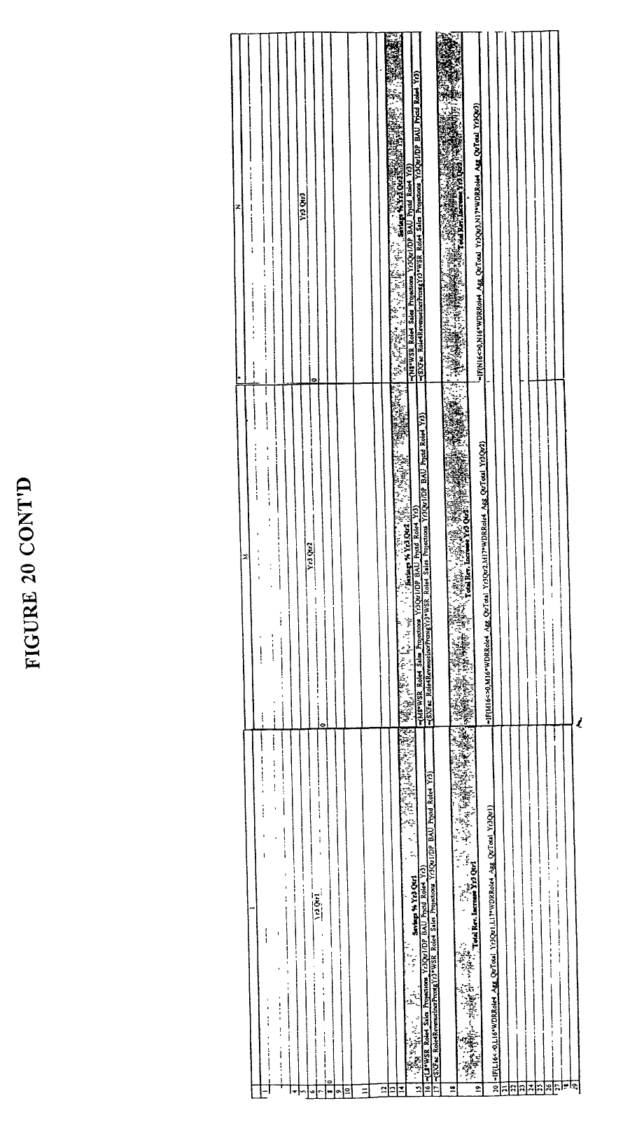

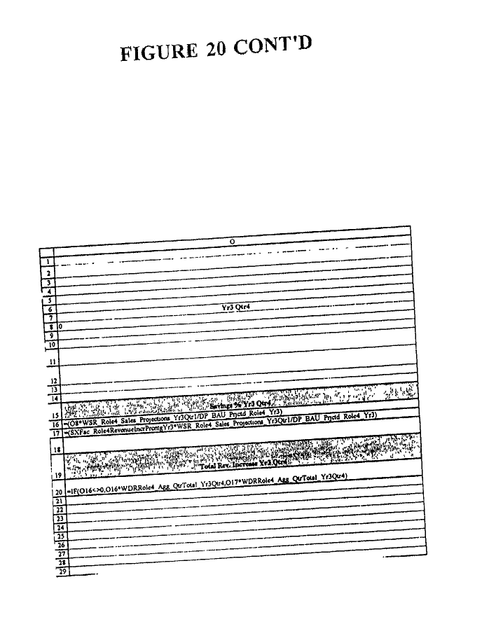

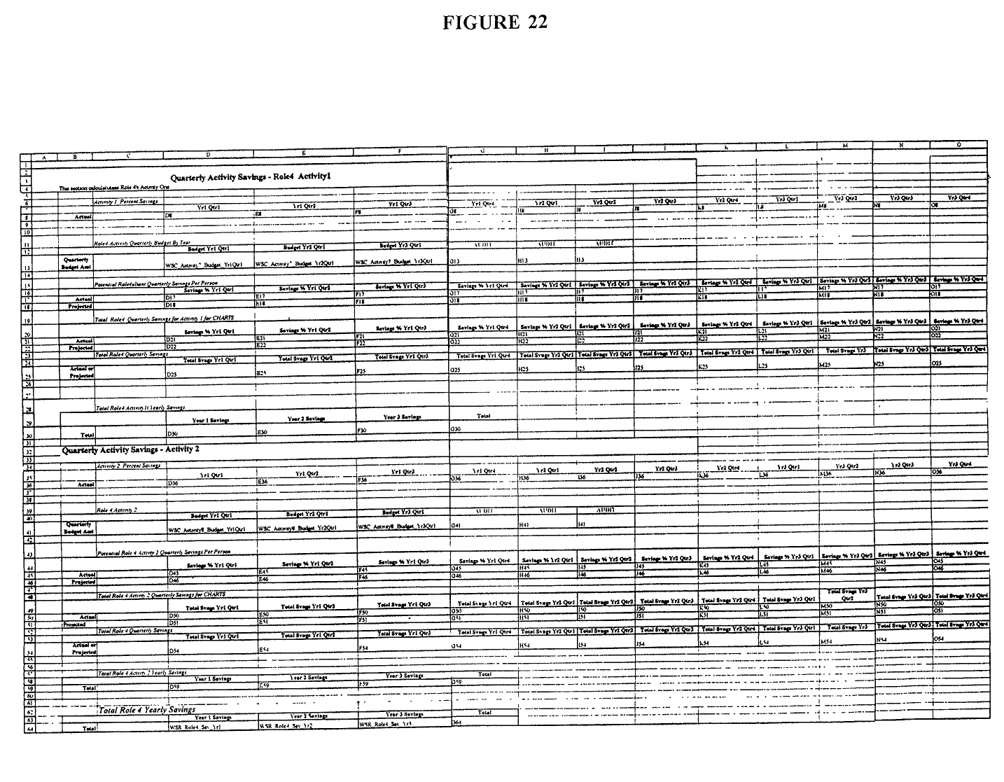

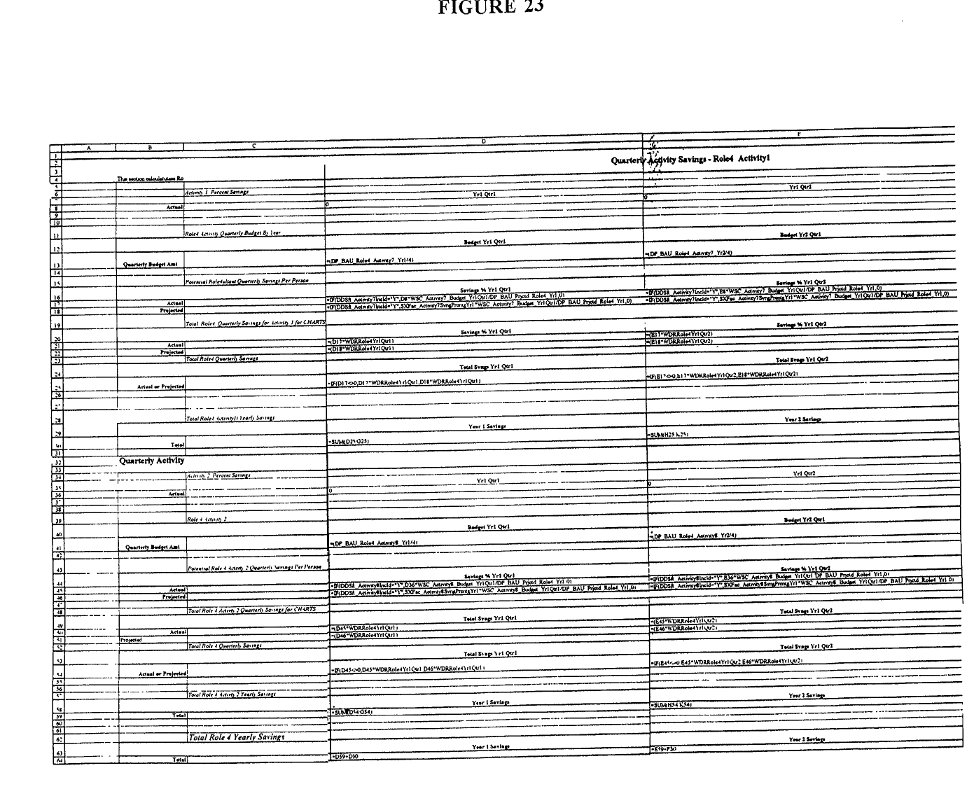

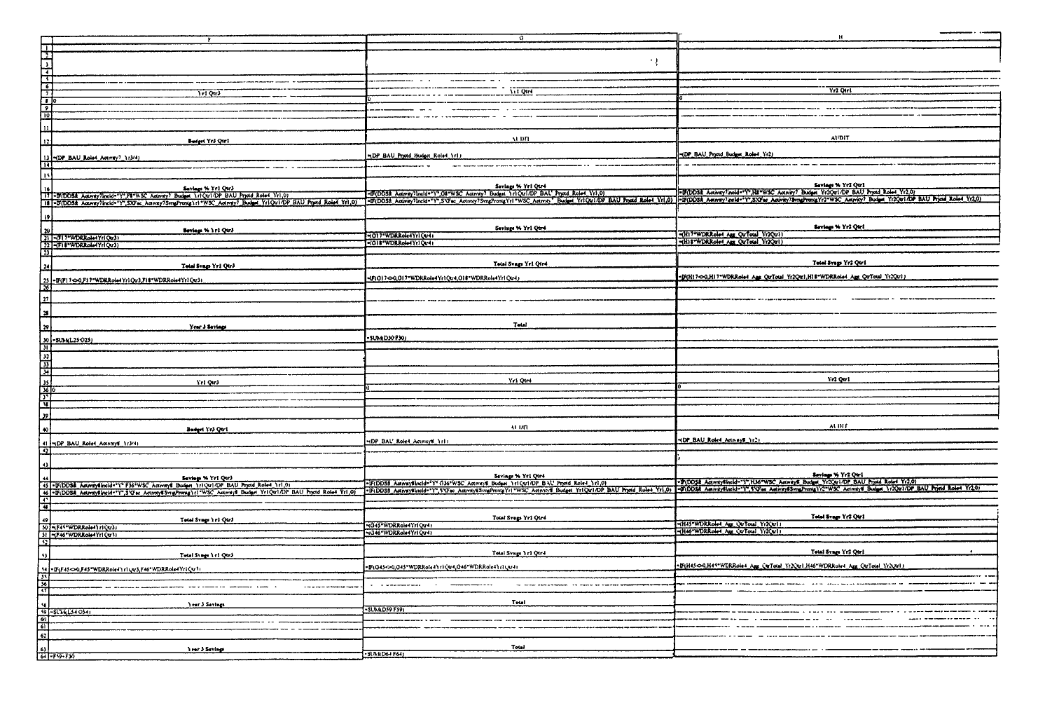

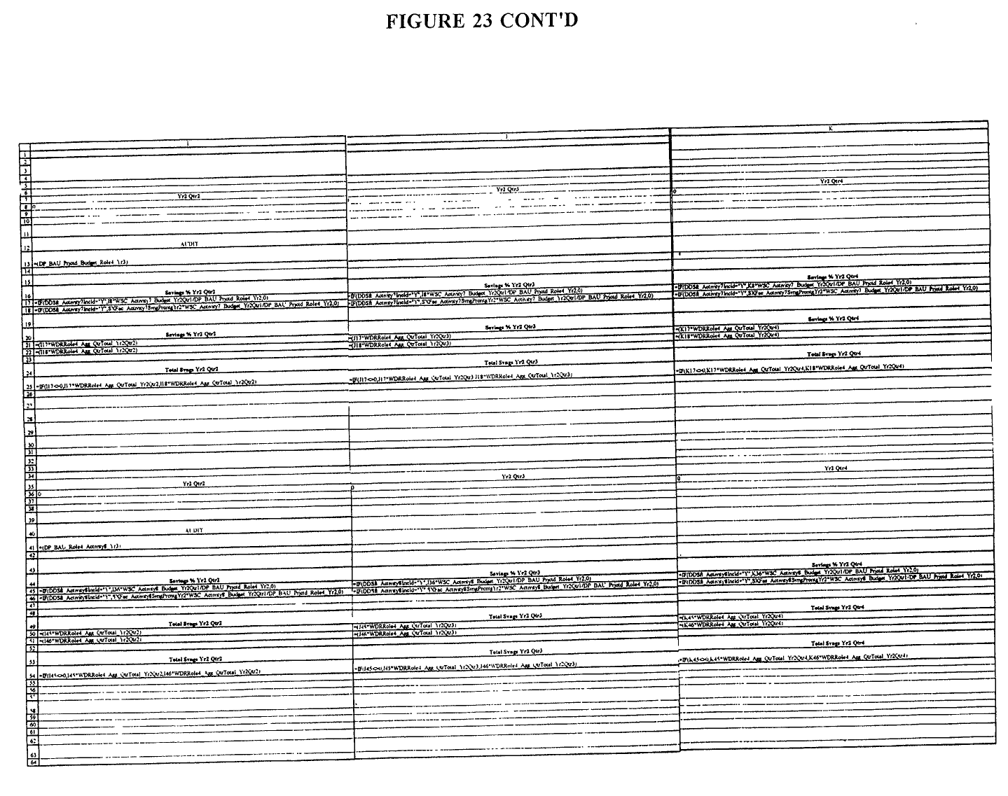

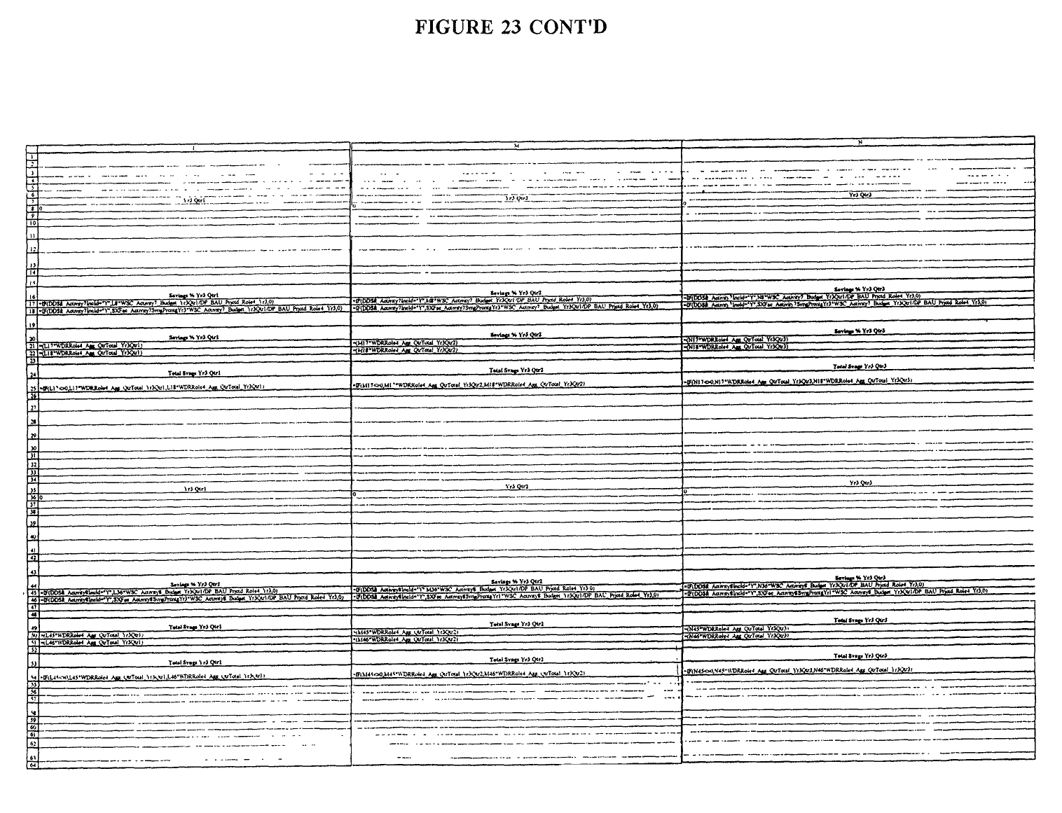

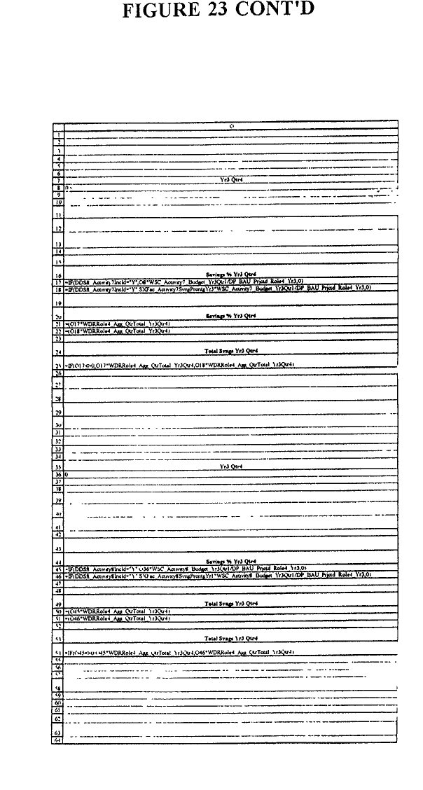

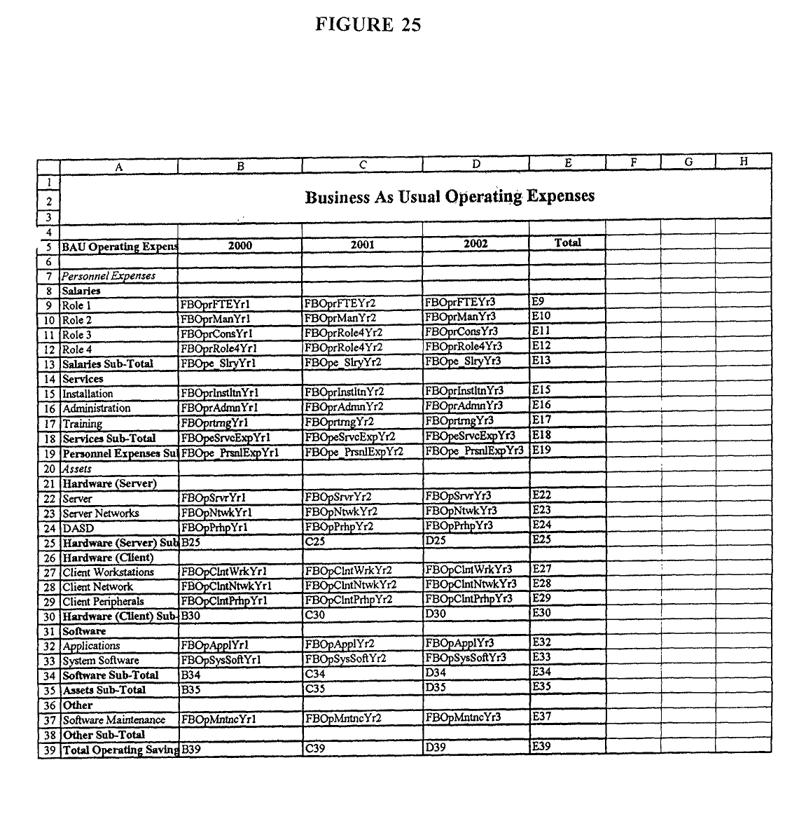

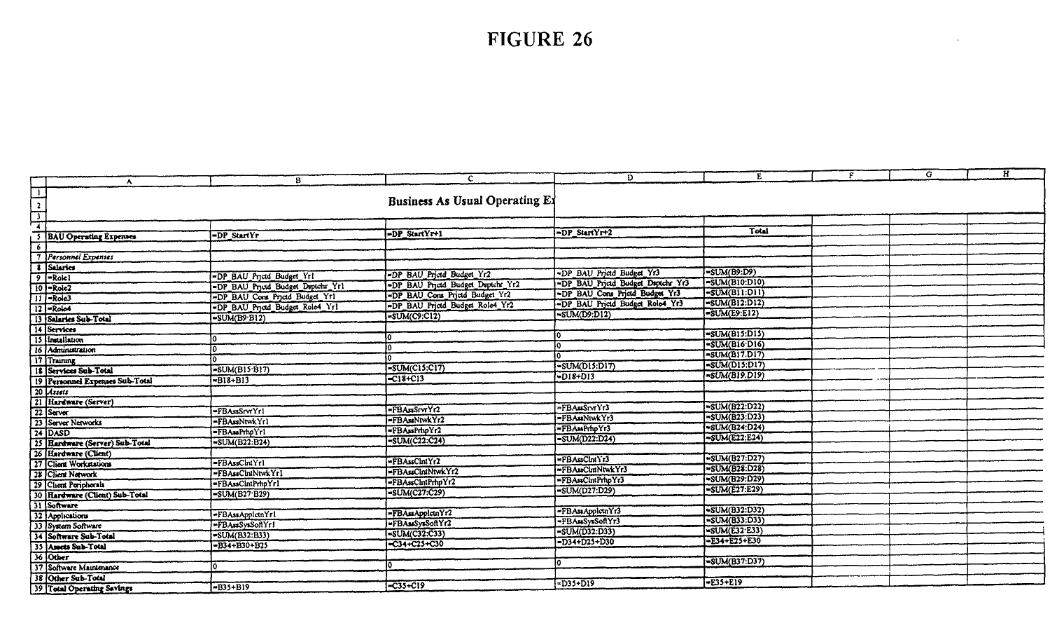

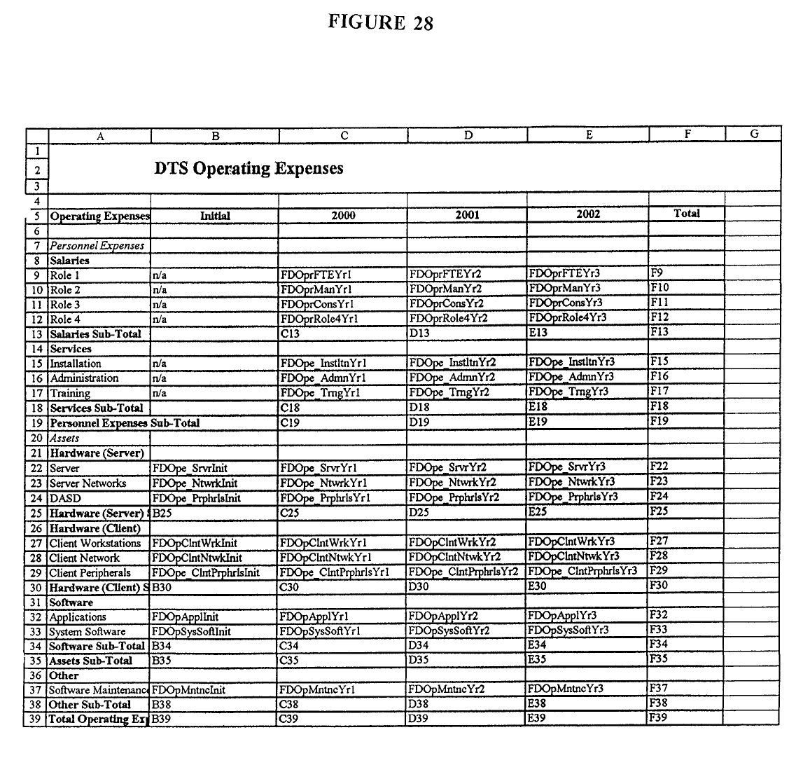

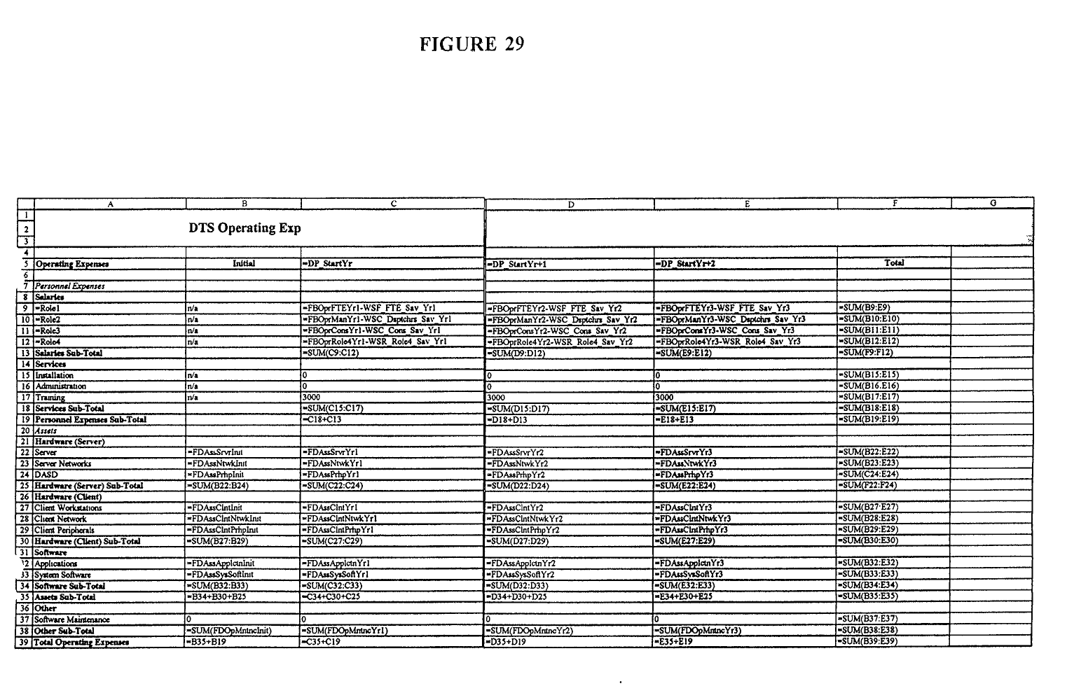

As used herein, the term “processing” as used in connection with the cost justification application refers manipulating numbers according to a formula established by the cost justification application (See, e.g., FIGS. 13-29). As used herein “processing as a function of” refers to manipulating numbers according to a formula established by the cost justification application such that the value of one set of number (e.g. buyer information) is changed by another set of numbers (e.g. rollout schedule information) (See, e.g., FIG. 13-29).

As used herein, the term “financial summary” and “financial summaries” refers to both cash flow statements and financial summary values (e.g., IRR, DCF, payback period).

### DETAILED DESCRIPTION OF THE INVENTION

As described above, the present invention provides systems and methods for conducting and facilitating cost justification analyses. The following discussion provides a description of certain preferred embodiments of the present invention and is not intended to limit the scope thereof. The discussion is provided in the following sections: I) Cost justification (methods of analysis for cost justification, financial summaries, and business cases); II) Cost justification systems and methods of the present invention; III) Exemplary Embodiments; and IV) Implementation and facilitation.

I. Cost Justification

This section provides an overview of cost justification methods and provides a number of cost justification techniques that find use in particular embodiments of the present invention. The decision to purchase complex or expensive equipment or services (e.g., vendor systems) is often accompanied by some type of financial analysis in order to justify the purchase (i.e., cost justification). Ordinarily, a financial analysis incorporating financial summaries (e.g., a business case) is prepared to attempt to quantify the results of a purchase. A business case usually contains financial summaries (cash flow statements and financial summary values) that provide insight into the financial impact of an investment decision over time. Cash flow statements use generally accepted accounting principles (GAAP) and normally contain yearly summarized totals for capital and non-capital expenses and benefits. Business cases ordinarily also contain the methods and rationale used to generate the results because arbitrary assumptions and judgements are incorporated into the business case that affect the numbers generated. A business case is ordinarily used to convey to management of a corporation the reduced costs, increased revenues, and accelerated revenues associated with a purchase. More specifically, financial summary values such as net cash flow, discounted cash flow, payback period and internal rate of return are normally presented.

A. Methods of Analysis for Cost Justification

Different types of analyses may be used to prepare a financial summary or complete business case including, but not limited to, Cost of Ownership, Return on Investment, and Cost/Benefit analysis. Each type of analysis takes a different approach to analyzing the impact of an investment on a business. None of these techniques have a single universally accepted definition, however, the general principles usually associated with each are detailed below.

1. Cost of Ownership

Cost justification employing cost of ownership (COO) analysis, also known as Total Cost of Ownership (TCO), is usually associated with the complete cost of using, installing, acquiring, changing, maintaining, and getting rid of something across a given period of time. Cost of ownership is often employed in analyzing medical equipment, computer systems, or other expensive items. The structure of a Cost of Ownership analysis results in the calculated cost of ownership always being more than the purchase price. A COO analysis requires that the boundaries of what is being measured be determined, and the information communicated to a recipient of this analysis along with reasons for selecting particular factors to measure. For example, in an Information Technology (IT) purchase analysis, analysts usually focus narrowly on purchase price, maintenance, and direct operational costs, while IT purchase analysis from managers, sales people, or consultants usually tend to have a broader scope (looking at the comprehensive cost of ownership).

A COO estimate may be the ‘cost’ component of a cost/benefit analysis, while benefits from a COO estimate can only be determined by comparing two or more different COO estimates. One type of comparison (to determine what ‘benefit’ an investment has) is comparing a “business as usual” scenario (i.e., a projection of the status of the company if it were to continue operating without using the investment) and an “investment” scenario (i.e., a projection where the investment is implemented). This may reveal cost savings or avoided costs in one situation as compared to the other. A COO estimate, however, does not determine financial benefits from sources such as increased business volume, increased revenue, or improved competitiveness. This means that a COO analysis usually cannot support a Return on Investment analysis, or financial measures such as IRR or payback period.

2. Return on Investment

Cost justification employing Return on Investment (ROI) methodology means different things depending on what context the term is used in. The strict financial meaning of ROI is a company's total capital divided into the company's income. ROI is also used to mean Return on Assets, which is simply the company's income for a given period divided by the value of the assets used to produce the income. However, in the broader business world, ROI simply means the incremental gain derived from an action divided by the cost of such action. For example, a purchase that costs $2000 and returns $3000 over a given period of time has a ROI of 50% for that period of time. This quantitative value for ROI may be used as a financial summary value (see below) for presenting the results of a cost justification analysis. However, there are many factors that may complicate a ROI calculation (or its interpretation), which is the reason that most business cases do not attempt to present ROI as a quantitative result, but instead provide financial measures such as Net Cash Flow, DCF, IRR, and payback period. One factor that may complicate a ROI analysis is determining a certain investment cost, which may fail to reflect opportunity costs. Another problem with ROI analysis is the fact that costs of an investment tend to be front end loaded, while benefits may come much later (meaning that the time value of money must be taken into consideration). Therefore, ROI is usually only valuable when the cost of the investment is certain, the return will be realized over a relatively short period of time, and the cost and return are clearly tied to each other.

3. Cost/Benefit Analysis

Cost justification employing a Cost/Benefit (C/B) analysis is a commonly used technique even though it has no exact definition beyond the concept that both negative and positive impacts of a decision are summarized and weighed against each other. A typical cost/benefit analysis requires that the time period being measured be clearly stated along with what factors are being included in the analysis. A typical cost/benefit analysis attempts to quantify every benefit and every cost of a decision, including benefits normally considered intangible (e.g., improved customer satisfaction). A cost/benefit analysis normally includes incremental costs and benefits (i.e. only financial changes resulting from a proposed decision), and is most effectively presented in a cash flow summary spreadsheet.

B. Financial Summaries

The results of most cost justification type analysis are often presented as financial summaries. Financial summaries may be financial metrics such as Net Cash Flow, Discounted Cash Flow (DCF), Internal Rate of Return (IRR), and Payback Period, all of which are generally single figures, presented as a certain number or a value point on a graph or chart. Financial summaries may also be Cash Flow Statements, which present line items of cash inflows and outflows along with one or more of the financial metrics listed above. Financial summaries are generally incorporated into business cases, as they present the financial information in summary format which may be easily understood and compared to other alternatives.

Net Cash Flow is a financial summary value that presents the difference between cash inflow and cash outflows. Net Cash Flow does not include items common to typical income statements such as depreciation expense. Most business cases include a Net Cash Flow figure because it reveals the actual flow of money. Net Cash Flow is also an important financial summary value to determine because it is the basis for other financial summary values such as DCF, IRR, and Payback Period.

Discounted Cash Flow (DCF), also known as Net Present Value, is the Net Cash Flow financial summary value that has been adjusted to reflect the time value of money. This figure allows a comparison between two alternatives, with the higher DCF being the better investment. DCF is based on the concept that money today should be valued more than the same amount of money received in the future because today's money could be invested and earn a certain rate of return between now and the future time. Therefore, the farther a given return on an investment is into the future, the less value it has. DCF is typically presented in business cases that concern investments that involve long periods of time, or where the greatest inflows come later than the greatest outflows.

Internal Rate of Return (IRR) is a financial summary value that has also been adjusted to reflect the time value of money. IRR takes an investment view of the cash flow stream, examining the rate of growth of an investment. The IRR for an investment is the discount rate at which the total present value of future cash flows equals the cost of the investment. It is the interest rate that produces a zero Net Present Value of the respective investment. It tells how high interest rates would have to climb to wipe out the value of the investment. The IRR also shows the rate at which the investment returns dollars to the company.

Payback Period is a financial summary value that indicates what length of time is required for recovering the price of the investment. The shorter Payback period between two investments is generally the better investment. Payback Period normally does not take into consideration the time value of money, nor does it reflect any money that might be coming in after the payback has been reached.

Another type of financial summary used in cost justification (e.g., in business cases) are Cash Flow Statements. In its simplest form, a Cash Flow Statement is a spreadsheet that presents cash inflows and cash outflows (e.g., by year and totals), and also presents a Net Cash Flow figure (e.g., by year and total). Cash Flow Statements present only line items that represent true inflows and outflows of cash, meaning that items such as depreciation expense are not included. Examples of cash inflow that may appear in a Cash Flow Statement include economic benefits, personnel savings, and assets savings. Examples of cash outflows that may appear in a Cash Flow Statement include additional personnel, additional assets, maintenance, and service expenses. Cash Flow Statements, may also be called Cash Flow Summaries when they bring together results from other Cash Flow/Financial Statements, and present financial summary values such as DCF, IRR, or Payback period. Cash Flow Summaries are usually included in business cases because a single document conveys the financial impact of an investment decision.

C. Business Cases

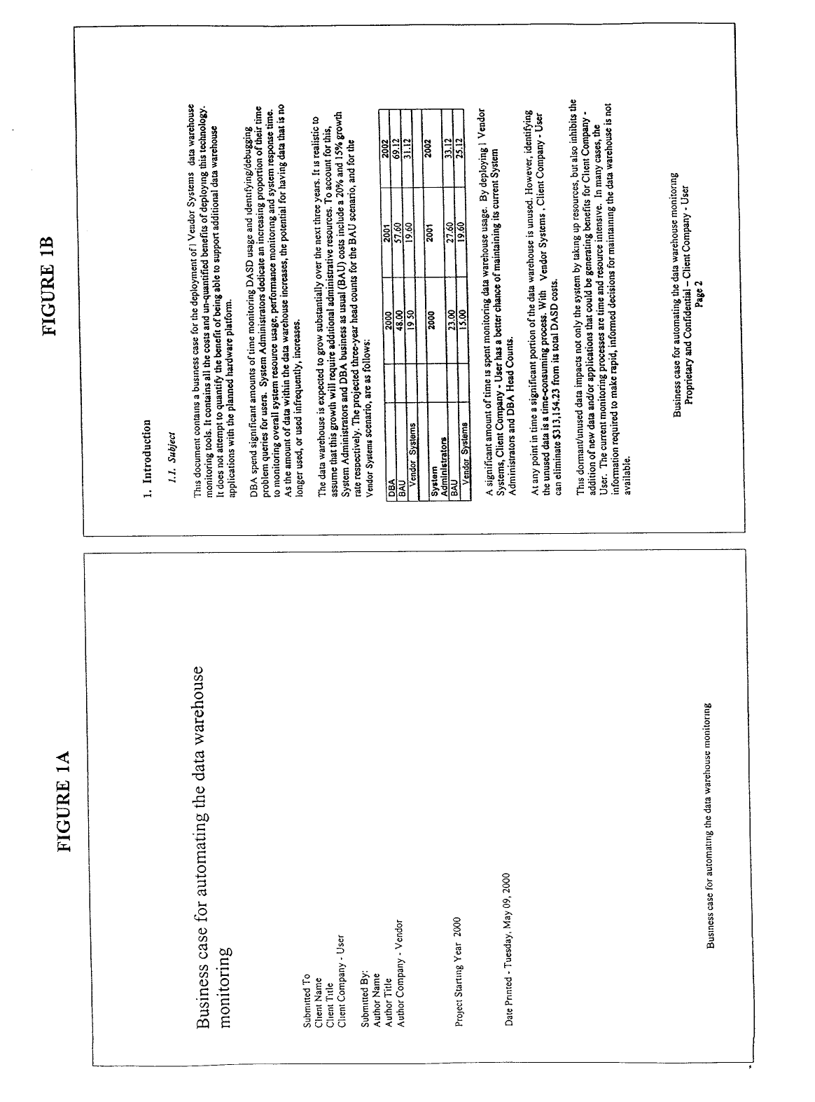

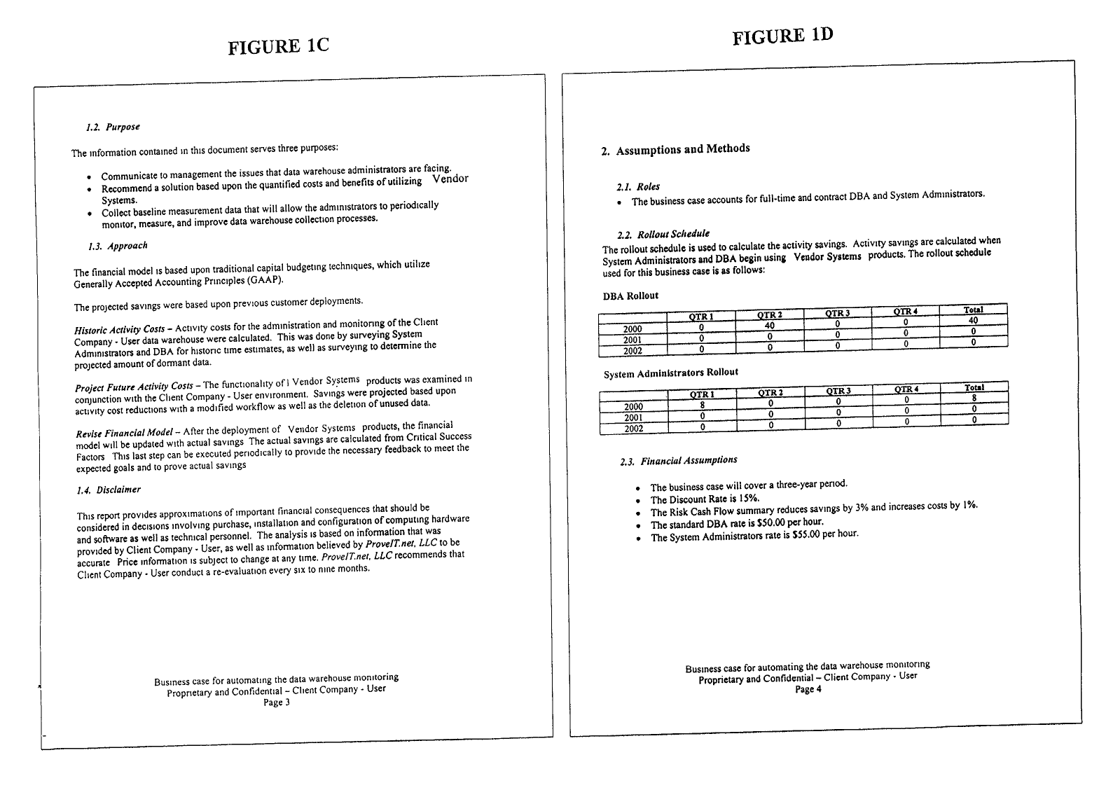

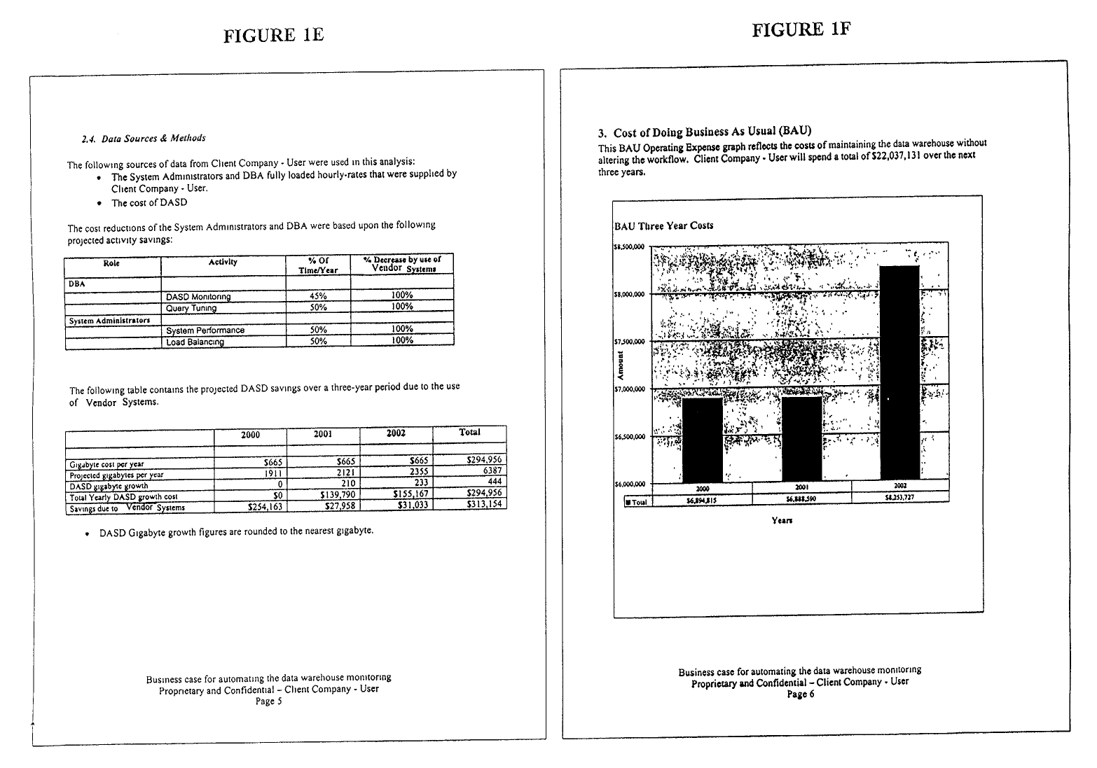

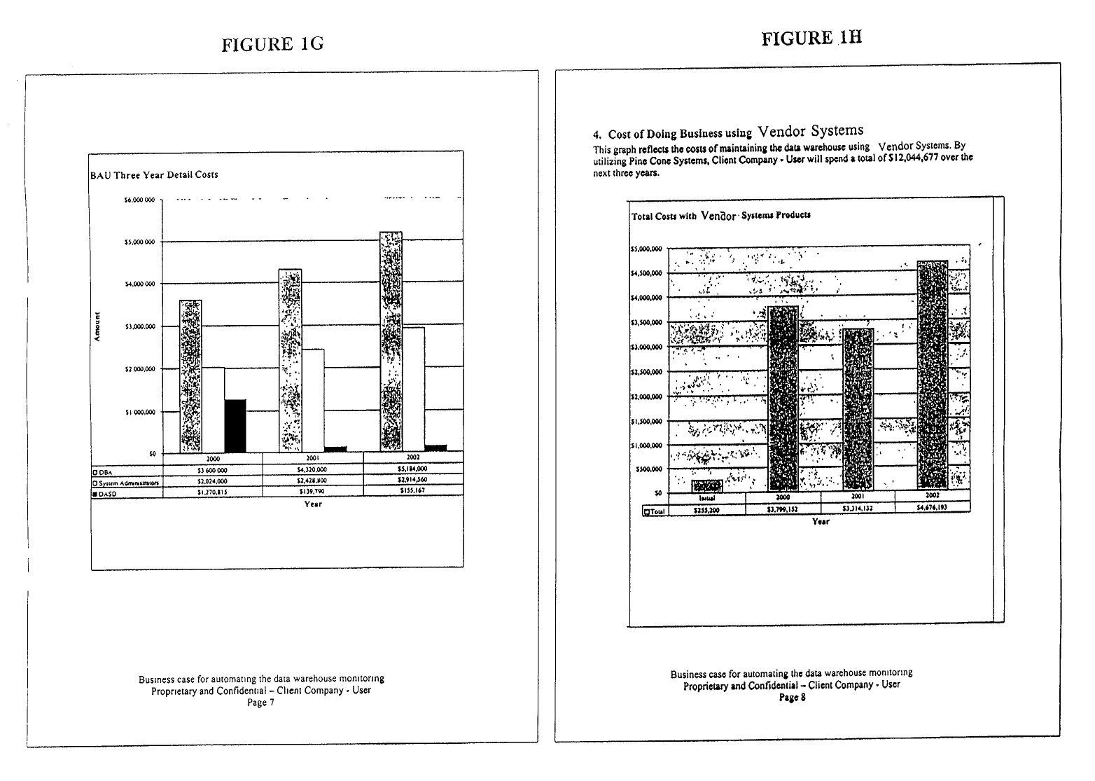

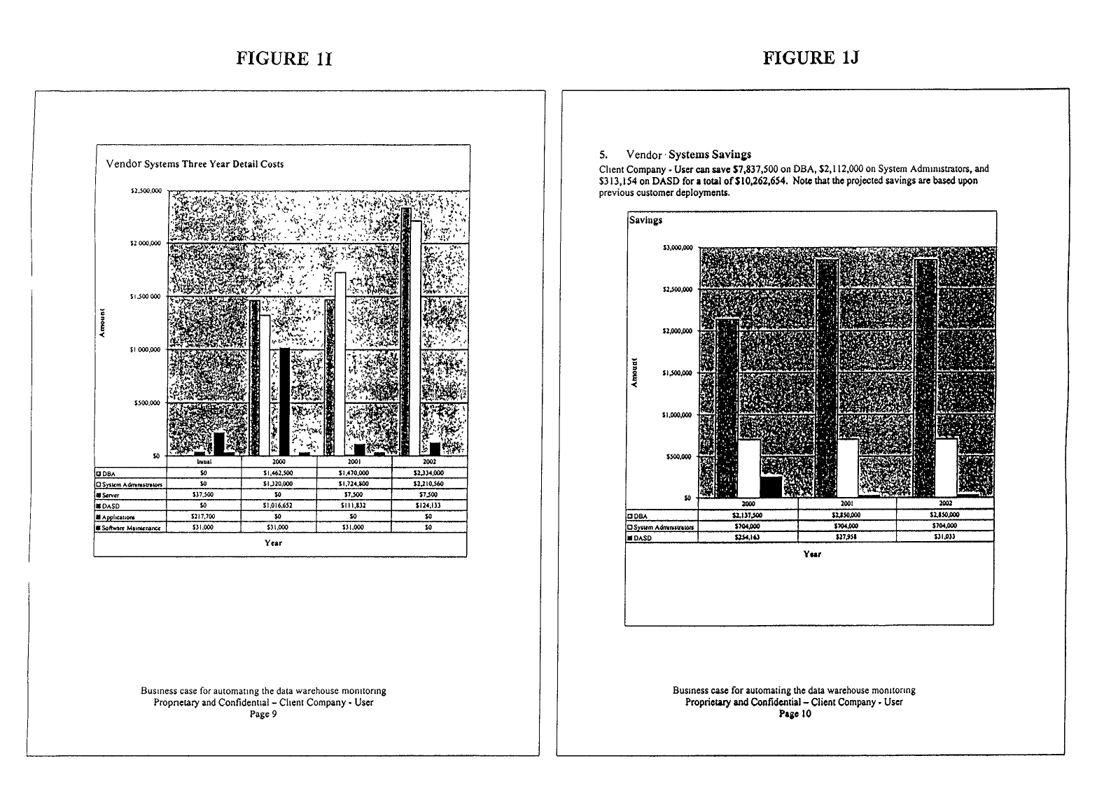

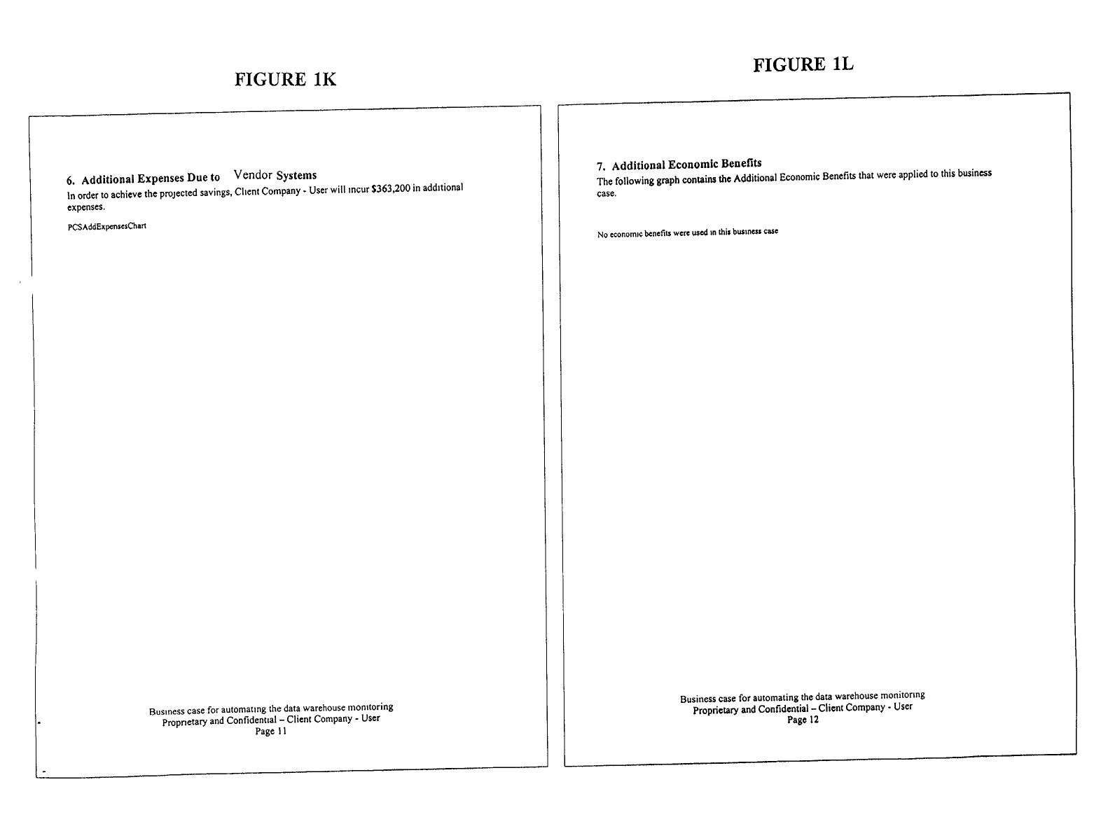

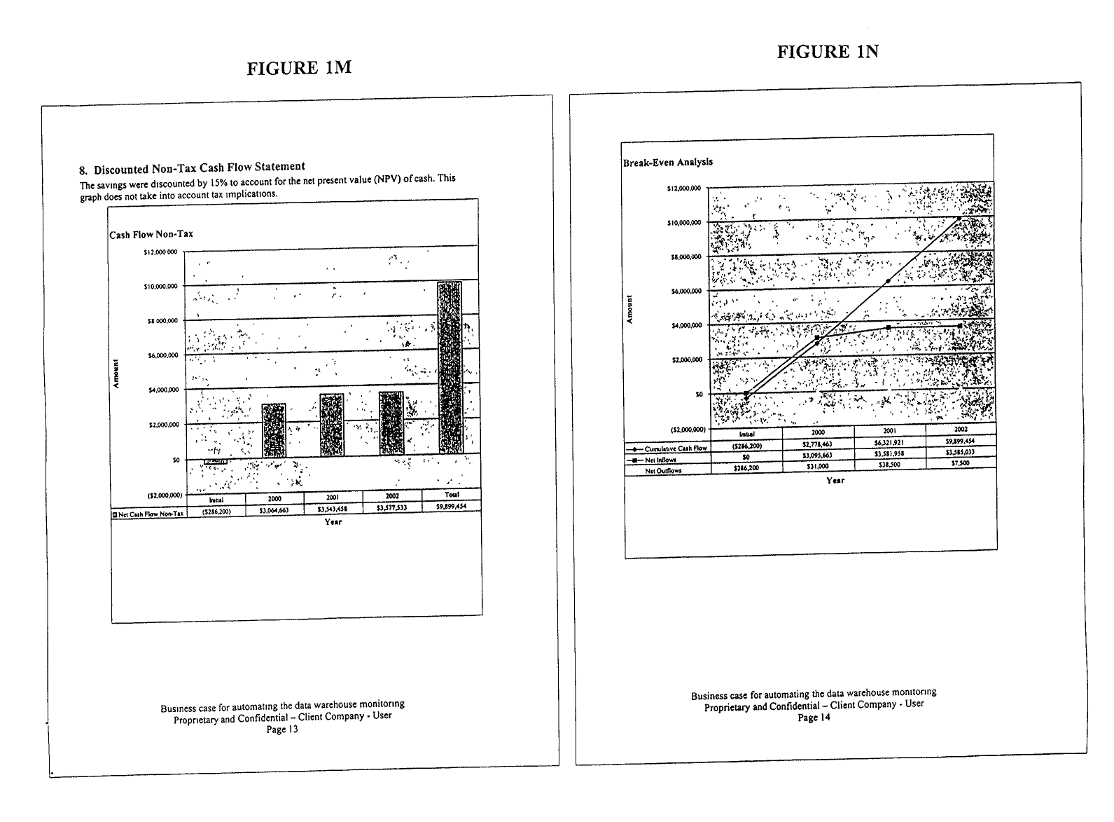

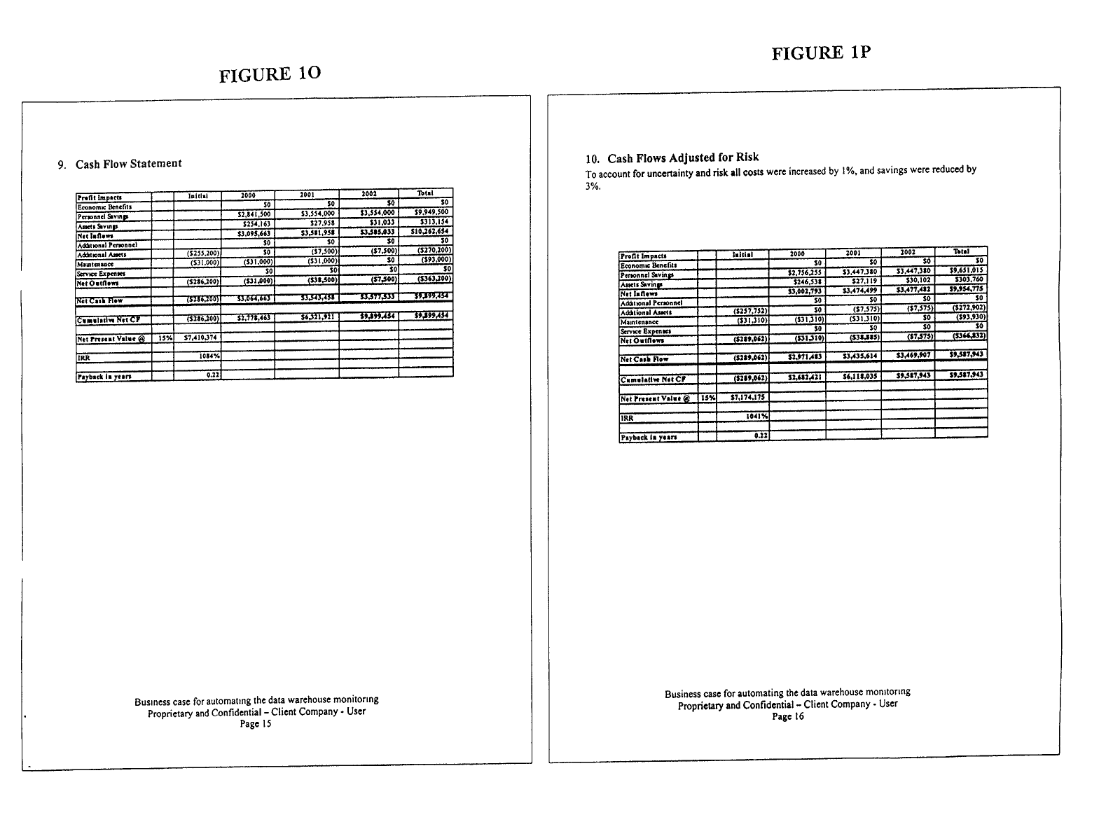

There are many different components that can be included in a business case such that it is complete, credible, and compelling. The challenge is selecting the proper components and presenting the final report in a form that decision makers are persuaded by. However, there is no such thing as a “correct” form a business case must take. Nonetheless, most business cases generally have several basic components or features. Detailed below are the various components that make up most business cases along with a description of an exemplary business case generated by one embodiment of the software of the present invention. This exemplary business case is presented in FIGS. 1A-P.

A complete and persuasive business case is generally, but not always, composed of the following components: (1) Introduction and Overview, (2) Assumptions and Methods, (3) Business Impacts, (4) Sensitivity, Risks, and Contingencies, and (5) Conclusions and Recommendations. Most business cases include each of these five areas (usually in the order presented above), but the content included in each component may differ significantly depending on what type of analysis is performed, what type of investment is being justified, or what industry the end-user (investment purchaser) is in. Business cases are often presented with only components 1-4 (i.e. not including Conclusions and Recommendations) allowing the reader to draw their own conclusion based on the data presented in the report. The exemplary business case presented in FIGS. 1A-P follows this approach by not including a Conclusions and Recommendations component. However, the exemplary business case presented in FIGS. 1A-P does include each of the other four sections usually associated with business cases.

The first component in most business cases is the Introduction and Overview component. The Introduction and Overview is the section that is normally read first by the audience. A title and subtitle are usually presented in this section that identify the nature of the proposed action and type of analysis. An example of a title, presented in FIG. 1A, is “Business case for automating the data warehouse monitoring”, indicating that this business case involves a cost justification analysis for data warehousing type applications. A sub-title may be included if more detail is needed. Next, the first component of most business cases generally includes address headers (e.g., “To” and “From” headers) such that it is clear who authored the report and who it is intended for (See e.g., FIG. 1A). Including these headers is important as the business case may be viewed differently depending on who the target audience is and if the person preparing the report has an interest in presenting favorable results justifying an investment. It is also important to know who the author of the report is because there are usually many subjective/arbitrary values incorporated into a business case, making the source of these determinations important to the credibility of the business case (and the financial summaries presented therein). The first component of a business case also normally indicates the date on which the report was completed (and submitted). FIG. 1A presents the project starting year and the date the report was printed (e.g., May 9, 2000). The date is important because many of the factors in a typical business case change (e.g., price quotes, salaries, and staffing), and may affect the results presented in the business case.

The first component of a business case generally includes a subject section. This section is used to describe the proposed action and the objectives of this action. The subject section presented in FIG. 1B describes the proposed action as implementing a system (data warehousing/monitoring applications) in order to maintain current head counts of database administrators and systems administrators and identify unused data. Another section generally included as part of the first component of a business case is a stated purpose of the case itself. Generally, the purpose is a statement that the report is to support decision making on the proposed investment (e.g., the purpose is to communicate to management the cost savings that would be realized with a proposed investment). This approach is followed in the exemplary business case as shown in FIG. 1C, which indicates that the document is intended to serve three purposes: (1) communicate to management the issues that data warehouse administrators are facing; (2) recommend a solution based upon the use of a vendor product (vendor system); and (3) collect baseline measurements to allow administrators to improve the data warehouse collection process.

The first component of a business case also typically includes a disclaimer when the report is to be submitted outside of the company preparing the report. The disclaimer helps set reasonable expectations for the audience receiving the report and provides some defensive legal protection for the author of the report. Disclaimer language typically includes warnings about the accuracy of financial predictions, how the information used for the report was gathered, recommendations for periodic re-evaluations, and the fact that the author of the report may be unaware of certain information. FIG. 1C provides one example of a disclaimer section. Another section that may be included in the first component of a business case is some type of executive summary. This section generally includes a short narrative on the subject, scope, and methods of analysis, along with any conclusions that the rest of the business case is meant to support. One additional section that is included in the first component of the exemplary business case is an Approach section (See FIG. 1C). This section details how projected savings were arrived at, as well as how historic and future activity costs were calculated. Importantly, this section also indicates that the financial model used to produce the business case will be periodically updated with actual savings numbers as they become available. In some business cases, this type of information is presented in a ‘Data Sources and Methods’ section (see below).

The second component in most business cases is the Assumptions and Methods component. This component of a business case is used to describe what type of methods were used to analyze the financial data and what type of assumptions were made. This component largely determines the credibility that is afforded the business case. One section normally included in the second component of a business case is the Assumptions section. Assumptions are typically included in the business case for three reasons: prediction, simplification, and clarification. Business cases that predict future financial results rely on factors that change over time that may not remain constant over the term of the business case (which is typically years). As such, the business case must clearly articulate these variable assumptions. FIG. 1D presents one such assumption called the discount rate (15%). Business cases also typically employ simplifying assumptions, such as the cost per year of a certain type of worker (even though in reality, most workers in the same category are making different salaries). This allows all the workers in the same category to be treated the same, simplifying financial analysis (See FIG. 1D which depicts the hourly rates for DBAs and system administrators). Assumptions may also be used to clarify how certain activities are conducted (e.g., the equipment will be leased instead of purchased).

The exemplary business case presented in FIGS. 1A-P also includes a section in the second component called Rollout Schedule, which is not a typical section of a business case. The rollout schedule is used to calculate activity savings for System Administrators and DBAs once they begin using the proposed investment system, since a business may not want or be able to implement the entire system to all employees at once. As the software of the present invention allows a user to enter particularized rollout schedule information for different types of workers (and different numbers of workers within the same class of worker) the exemplary business case presents the rollout schedule to inform the reader of this information. This information is depicted in FIG. 1D, which presents the rollout schedule information for each type of worker on a quarterly basis. As presented in FIG. 1D, 40 DBAs were rolled out in the second quarter of 2000, and 8 system administrators were rolled out in the first quarter of 2000. As the software of the present invention allows any type of particularized rollout schedule to be entered, a user may change these numbers, for example, by rolling out a portion of the DBAs in 2001 (Qrtr 3) and another portion of the DBAs in 2002 (Qrtr 1). The software of the present invention then automatically recalculates (without further data entry and/or changing data or parameters in the formula) the results of this type of rollout schedule and an altered business case may be printed out without any re-calculation or other work by the user.

A scope and boundaries section is also normally included in the second component of a business case. The scope and boundaries section is what sets out the dimensions of the business case and provides the rules for deciding what type of data is included in the business case, and what type of data is left out. One dimension that is typically present is time (i.e. how long of a period the business case covers, see FIG. 1D). Another dimension that may be included describes the part of the company that is being analyzed (e.g., certain group of employees affected by the implementation of a business decision). FIG. 1E indicates that the exemplary business case analysis focused on system administrators and DBAs fully loaded hourly rate and the cost of DASD (i.e., datawarehouse administers and equipment).

A cost/benefit data section is normally included in the second component of a business case. Cost and benefit data usually apply to specific line items. For example, a cost listed may be the average salary for a certain type of worker. A benefit may be the percent of time saved for a certain type of worker if the proposed investment is made as depicted for System Administrators and DBAs in FIG. 1E. The costs/benefits section of the exemplary business case provides further detail by also listing the amount of time spent on each activity for each type of employee and the projected percent savings resulting from the investment. The exemplary business case, in FIG. 1E, also presents the savings associated with DASD if the investment is made. Presentation of costs and benefits allows a reader of the business case to understand what factors are being measured and how they are impacted by the proposed investment. The source of these numbers is typically the vendor of the investment being analyzed (based on previous cases) or some other Knowledge Base (see below) that helps identify what activities to track and what type of benefits are normally realized. The second component of a business case also normally includes data sources and methods. This section describes how cost and benefit values were measured and the source of this information (e.g., the source of the knowledge base). In the exemplary business case presented in the Figures, this type of information is presented in an ‘Approach’ section (See FIG. 1C).

The third component of most business cases is the Business Impacts component. This component is the heart of the business case and is designed to present the financial consequences of a proposed investment and related financial information. A financial model is normally used to present the results of the investment analysis. Typical models include pie charts, graphs, charts, and spreadsheets, each of which may present the relationship between key variables or may indicate the entire cash flow resulting from the proposed decision. One financial model, presented in FIG. 1F, is a bar graph representing the costs for the next three years associated with maintaining the data warehouse under Business as Usual (BAU) conditions (i.e., without making the proposed investment). The costs presented in FIG. 1F are presented in detail in FIG. 1G, which presents BAU costs for the next three years broken out by individual cost (i.e., DBAs, System Administrators, and DASD). Another financial model presented in the exemplary business case (FIG. 1H) is a bar graph representing the costs for the next three years resulting from the implementation of the data warehousing solution. The costs presented in FIG. 1H are presented in detail in FIG. 1I, which presents detailed costs by category under a vendor systems scenario (i.e., DBAs, System Administrators, Servers, DASD, Applications, and Software maintenance). Another financial model, presented in FIG. 1J, are the savings by year (and total) realized by implementing the vendor system.

Also presented in the exemplary business case are additional expenses caused by the implementation of the vendor solution. FIG. 1K presents the total additional costs resulting from the implementation of the solution based on expense rules regarding such additional costs. The total costs incurred are presented in the business impacts (results) component of the business case, instead of a simple cost presented earlier, because the cost justification software of the present invention allows the expense rules to be dependent on the rollout schedule. As such, the additional costs generated by the program changes based on the rollout schedule information entered by a user. Also presented in the business case, in FIG. 1L, is a section for additional economic benefits that may be entered by a user, and may be assigned to a particular year. The exemplary business case does not include any additional economic benefits as noted in FIG. 1L. However, examples of additional economic benefits that may be included in a business case include, but are not limited to, reduced need for CPU upgrades, improved customer satisfaction, web enabling customer self-service, good will generated for the business, and the like.

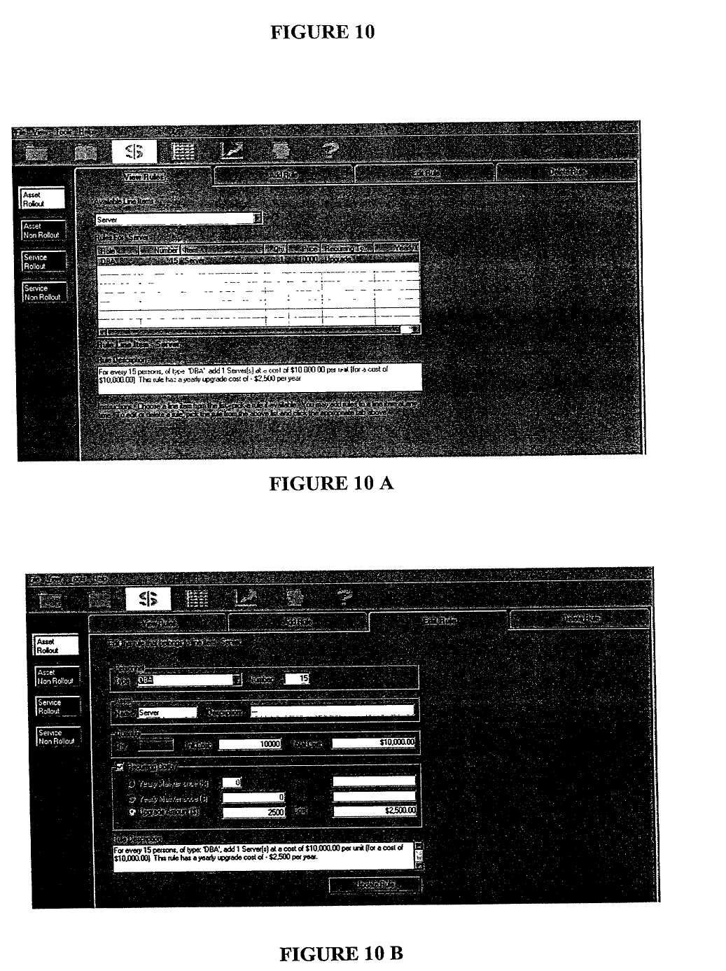

Regardless of how many types of data presentation are made, there is typically a cash flow statement (as described above) in the third component of a business case that serves as the true center of the business case. A Cash Flow Statement is a spreadsheet that presents cash inflows and cash outflows (e.g., by year and totals), and also presents a Net Cash Flow figure (e.g., by year and total). An example of a cash flow statement is presented as part of the exemplary business case in FIG. 10. The Cash Flow Statement may also be called Cash Flow Summary when it brings together results from other financial models/statements, and presents financial summary values such as DCF, IRR, or Payback period (e.g., the cash flow statement presented in FIG. 10, which lists net cash flow, net present value at a discount rate of 15%, IRR and payback in years). The presentation of these financial summary values (DCF, IRR, or Payback period) is also considered an analysis of results section, that may also be presented independently in chart or graph format. One independent presentation of DCF is presented in FIG. 1M as a bar chart, where savings were discounted 15% to account for the net present value of cash. Another independent presentation is depicted in FIG. 1N (Break Even Analysis) that graphically represents the point at which the investment benefits would payback the cost of the investment.

The fourth component of most business cases is the Sensitivity and Risks component. This component is designed to account for the uncertainty that is inherent in business cases due to the subjective assumptions and methods selected by the author. A sensitivity analysis section is normally included to present how the results may differ if the assumptions used to generate the results are changed. This allows a reader who may not agree with the original assumptions to view results based on assumptions they are more comfortable with. A risk analysis is also normally included in the fourth component of a business case. This section is used to account for uncertainty and risks. This may be done by increasing costs by a certain percent and reducing savings by a certain percent, in order to reflect a more conservative estimate of the benefits of a given investment. FIG. 1P presents a cash flow statement that has been adjusted for risk, where costs were increased by 1% and savings were reduced by 3%.

The fifth component of a business case is the Conclusions and Recommendations section. The conclusions section may be used to interpret the results (e.g., financial summaries) that were generated, and connect these results to the objective of the business case. This section may also be used to highlight any unexpected or surprising results. The recommendations section, which is usually the final part of a business case, is the place where a course of action is suggested even if the results and conclusions speak for themselves.

II. Cost Justification Systems and Methods of the Present Invention

The present invention provides systems and methods for performing a cost justification analysis of a purchase (i.e. of a vendor product) and presenting the results of this analysis to a user. For example, the present invention provides systems, methods, and cost justification software tools for generating financial summaries (cash flow statements and financial summary values), and business cases for cost justification. In some embodiment, the systems and methods of the present invention provide methods for processing user information (e.g., buyer information, knowledge base information, rollout schedule information, and expense rule information). In preferred embodiments, the systems and methods of the present invention integrate buyer information, knowledge base information, rollout schedule information, and expense rule information. In some embodiments, the systems and methods of the present invention allow a cost justification analysis to be performed on a contemplated purchase, and further allow the actual benefits of ownership to be tracked once the purchase has been made. In certain embodiments, the system and methods of the present invention are in an automated format (e.g., software application).

The systems and methods of the present invention automatically calculate and track activity and savings cost reductions at the detailed level, and, in some embodiments, allows users to create financial summaries and business cases through expense rule information, user information, rollout schedule information, and knowledge base information. The present invention provides the first system that allows a user to generate a detailed business case by entering a small amount of data using a simple electronic user interface (e.g., an input Wizard). In certain embodiments, the system and methods of the present invention track financial measurements over certain time periods. In preferred embodiments, the system and methods of the present invention track financial measurements on a quarterly level or based on some other accounting period.

The systems and methods of the present invention have been designed so that minimal action is required by the user to re-calculate the result (e.g., full business case) when a change is required. For example, a common change in the implementation of a business decision is a modification to rollout schedule information. The projected activity savings need to be recalculated to reflect the change in the rollout schedule. Also, there may be expenses that are dependent upon the rollout schedule that must be recalculated. With the systems and methods of the present invention, when the rollout schedule information is modified, both savings and costs are recalculated automatically. This represents an enormous savings in time, since the user does not need to manually calculate, edit, and cut and paste the business case together.

The systems and methods of the present invention find use with any type of cost justification analyses. For example, one type of purchase to which the cost justification systems and methods are advantageously applied to is expensive equipment that represents a substantial financial investment for a business or individual. Examples of such purchases, includes, but is not limited to, Information Technology products (IT) (e.g., for automating data warehousing or application service providers [ASPs]), healthcare products, aerospace products, chemical products, industrial machinery products, and the like.

A. Buyer Information

Performing a cost justification analysis typically utilizes certain information from a user (e.g., potential buyer). Such information in called buyer information and includes, but is not limited to, project information, personnel information, assets information, and financial assumptions. Buyer information may be entirely provided by the user (e.g., buyer) and entered into the user interface of the present invention. However, the cost justification application may already contain all or a portion of the buyer information. For example, the cost justification application may already contain information regarding the type of vendor product being analyzed or the type of industry the buyer is in.

One type of buyer information is called project information. Project information includes, but is not limited to, the name of the project, start date of the project, the length of the project, who the author of the final report is, who the report is being prepared for, what type of industry the buyer is in, the type of product or service being contemplated (e.g., information technology product for automating data warehouse monitoring). Project information may be employed by the cost justification application of the present invention to select the appropriate knowledge base information to apply to the financial analysis, and may also help the cost justification application of the present invention select the appropriate roles and/or assets to analyze.

Another type of buyer information is called personnel information. Personnel information includes, but is not limited to, information regarding the total number of users who would utilize the purchased good or service or employees affected by the purchased good or service (may be number of user by category), data regarding the average salary for each type of worker (or hourly rate of each type of worker along with number of hours worked per year), data regarding the roles of each type of worker (e.g., field technician, contract administrator, call center worker, database administrator, or system administrator), the percent of time a certain type of worker typically spends on a certain type of role, the projected percent growth in the workload for each type of worker, information regarding the type of activities usually associated with each type of worker (e.g., field technician—locating parts and return visits). Personnel information may be used, for example, to determine part of the cash outflow of a business or individual as it relates to personnel, thus establishing personnel costs under a “business as usual” scenario.

An additional type of buyer information is called asset information. Asset information, includes, but is not limited to, information regarding assets owned by the business or person that are likely to be affected by the contemplated vendor product purchase, the amount of the asset owned, and the expected growth rate of such assets in the future. One example of such an asset is DASD (Direct Access Storage Device, better known as disk space) which may be heavily impacted by the purchase of data monitoring automation applications, as this type of software helps identify unused disk space (thus reducing the need to purchase more disk space).

Another type of buyer information is called financial assumptions. Financial assumptions include, but are not limited to, the discount rate and adjustments for risk (e.g., increase costs by and reduce savings by). Financial assumptions are useful in the methods and systems of the present invention to help determine financial summaries that require an adjustment for the time value of money (e.g., applying the discount rate), such as internal rate of return or discounted cash flow. Risk adjustments are also useful in the systems and methods of the present invention in order to provide “what if” scenarios that may take a more conservative approach to predicting the amount savings or the cost of goods and services in the future.

B. Knowledge Base Information

Performing a cost justification analysis typically requires certain information about projected savings or increased productivity resulting from a potential investment (e.g., a potential purchase of a vendor product). The systems and methods of the present invention employ knowledge base information in order to accurately predict projected savings and/or increased revenues resulting from a given investment. Knowledge base information may be provided by a user by entering knowledge base information into the user interface of the present invention (e.g., as guided or instructed by the software of the present invention). Knowledge base information may also be provided by the vendor which they have developed by monitoring buyers of their products (e.g., what types of activities to monitor and associated benefits). Alternatively, the knowledge base information may be already present in the cost justification application of the present invention and automatically applied to the financial analysis. Finally, knowledge base information may be generated by the systems and methods of the present invention by continuous monitoring of buyers who have made purchases, which may then be used to supplement or change the knowledge base information employed in the methods and systems of the present invention (See below, continuous monitoring section to generate survey data information).

Knowledge base information may also be a set of information representative of criteria that have been empirically determined to provide a useful financial analysis of a given product or service (e.g., what factors need to be measured to provide a useful financial analysis). Knowledge base information, therefore, may be employed to determine what factors (roles, assets) should be monitored for a financial analysis depending on the type of investment being analyzed and/or the type of industry the user is in. Knowledge base information is also the type of information that predicts the benefit (e.g., reduced costs or increased revenues) that are expected when a given investment is made based on empirically determined data. Examples of this type of knowledge base information include, but are not limited to, the percent of work time that is saved by implementing a vendor's proposed solution. The value may change over time as the personnel at the company become more efficient at using the solution. Thus, the knowledge base may provide criteria including a time factor. Such information becomes very relevant in determining savings if different rollout schedules are contemplated.

Knowledge base information may include case studies which consider different size organizations (e.g., sole proprietorship or large multi-national corporations), evaluation of different products (e.g., software product), purchases in different industries such as legal, financial, government, technology, and other suitable industries. These case studies typically include a complete financial analysis developed with a spreadsheet (e.g., Microsoft Excel), and are employed to develop a meaningful understanding of the financial value of a given purchase to the business operating in a particular industry. Particular factors that may be measured to generate knowledge base information include, but are not limited to, the costs for upgrading current technology infrastructure in connection with an IT purchase (investment), the cost of training and supporting users in connection with the utilization of the proposed investment, and benefits relating to time, operation and/or payroll savings in connection with the proposed investment. Knowledge base information may also include survey data. In some embodiments of the present invention, survey data is from similar companies who have implemented the same or a similar solution, while in other embodiments, the survey data comprises data obtained from the purchasing company employing the solution, such that the knowledge base is updated over time to account for empirically determined results of the employment of the solution.

C. Rollout Schedule Information

Timing of events associated with an investment/purchase may significantly affect the results generated as part of a cost justification analysis. The systems and methods of the present invention account for important timing events by incorporating rollout schedule information into the financial analysis. Rollout schedule information includes, but is not limited to, when the contemplated purchase (e.g., software application) is initiated in the company and when each role or activity is affected by the implementation. Rollout schedule information may be used to account for a deployment of an investment across a business that happens incrementally (e.g., the employees of the company may not all have access to the solution as the same time). Rollout schedule information may be entered into the processor of the present invention, or it may already be present in the processor. Rollout schedule information may be particularized such that it relates to the availability of the solution to a certain type of worker. Rollout schedule information may also detail the availability of a solution to a certain role, and further detail what percent of employees represented by the role have access to the investment in a given time period. Rollout schedule information may be different for different roles within the same financial analysis. In this manner, cost reductions and revenue increases may be calculated specifically over time for each type of role and/or activity. The system and methods of the present invention allow this type of particularized rollout schedule information to be entered, thus allowing an integration of knowledge base information and rollout schedule information to facilitate a detailed cost justification analysis.

Allowing a user (e.g., prospective buyer) to enter particularized rollout information in the methods of the present invention has advantages that allow the results generated to be more accurate, flexible, and acceptable to decision makers. For example, a cost justification analysis may track the impact of a software application on the activities of two types of roles. It is expected (e.g., through knowledge base information) that an investment in the software application will make the workers twice as effective. As such, the benefits associated with the software application may be tracked, for example, by a reduction in the number of employees over time and increased productivity. However, a prospective buyer of the software package, for business reasons, does not want (or is unable) to rollout the software application to the first role until the beginning of the second year of the project, but will rollout the software application to the second role immediately. Consequently, the savings associated with the first role would not start to accrue until the beginning of the second year, while the savings associated with the first role would begin to accrue immediately. A financial analysis that rolled out the software application to both roles in the first year would, therefore, overestimate any savings resulting from the investment in the software application. Likewise, a financial analysis that rolled out the software application to both roles beginning in the second year would underestimate savings associated with implementing the software package. Importantly, the methods of the present invention allow the business to easily determine cost savings and other effects (e.g., employee retention) of the solution in multiple different roll-out scenarios to best determine how, or if, to implement the solution.

D. Expense Rule Information

Expense rule information is information that may be included as part of a financial analysis to account for additional expenses that may be incurred as a result of a purchase of a vendor product. An example of expense rule information (expense rules) would be the cost of the item being purchased and the time period in which the expense is accounted for. However, many types of purchases where cost justification analysis is employed involve additional expenses besides the original investment. For example, information technology products (software applications) often require additional expenses such as training for personnel or additional hardware (e.g., servers) in order to employ the purchased software effectively. Expense rules allow a user to include these costs in the financial analysis (e.g., including a formula that represents how many servers need to be added based on the number of employees in a certain role). These additional expenses, however, represent not only simple costs, but are also a function of when certain events happen (e.g., when the solution is implemented for a given role). Therefore, there are essentially two types of expense rule information: those based upon rollout schedules and those that are not. Additionally, asset rules may track costs associated with both assets and services. Therefore, there are four categories of expense rule information: Assets—rollout or non-rollout and Services—rollout and non-rollout.

Non-rollout expense rules are used when there is an expense that is not dependent on a rollout schedule. The result is that the expense costs are simply added to total expenses in a certain year or accounting time period. Some expenses, however, are only incurred when personnel are rolled out. These types of expense rules are dependent upon the Rollout Schedules (i.e., they are essentially “if-then” statements). These types of expense rules integrate the expense rule information with the rollout schedule information. This frees the user of the methods of the present invention from having to guess what the effects would be or from having to go through rigorous re-calculations by hand, since the rollout expenses are automatically calculated and allocated by the systems and methods of the present invention. Expense rule information may be entered into the user interface of the present invention, or be already present (at least in part) in the cost justification application.

An example of rollout-type expense rule that may be created for an asset (e.g., a server) is the following: “For every 15 persons of the type ‘DBA’, add 1 server(s) at a cost of $10,000 per unit”. Once this rule has been added, for every 15 DBAs that are rolled out as determined by the methods of the present invention based on previously entered rollout schedule information, 1 server at the user's specified cost ($10,000) is added to the costs associated with the investment in the appropriate accounting period. Once the rollout of the 16th DBA occurs, another server will be allocated. Once the rollout of the 31st DBA occurs, a third server will be added. The accounting period in which this cost is allocated to is dependent upon when the rollout occurs. The automated processing of the methods of the present invention are described in detail below.

In some preferred embodiments of the present invention, after a solution has been implemented (i.e. a vendor product purchased and employed), a continuous tracking system is employed to monitor the results of the solution. In such embodiments, various survey data or other collected data is compiled to determine the actual effects from the implementation of the solution. Survey data includes, but is not limited to, data on the amount of savings obtained for one or more roles and activities, data on when savings are obtained, data on the amount and timing of costs, data on expenses and accuracy of the original expense rules, and the like. This data may then be added to the knowledge base of the present invention to improve future calculations using the cost justification software and methods of the present invention. For example, the improved knowledge base may be used by the company implementing the solution to make better decisions in further implementation of the system, in cancelling the solution, or in changing solutions. The improved knowledge base includes improvements on the identity of the roles and activities that are most relevant to select in future analyses and improvements in the details of the expense rules. The improved knowledge base may also be used by other companies employing the solution or similar solutions. In some embodiments of the present invention, the continuous tracking system generates periodic business cases that are provided to management of the company so that they may make informed decisions.

III. Exemplary Embodiments

The following description provides an example of the implementation of the methods of the present invention in the context of information technology management solutions. This example is not intended to limit the scope of the present invention. For example, many different versions of the software may be implemented, including many different ways to input information. In preferred embodiments, the present invention employs a cost justification application for processing user information to generate results (e.g., financial summaries and business case(s)). In some embodiments, the cost justification application is a software application (e.g., Solution Scorecard). The Solution Scorecard Business Case communicates, in Generally Accepted Accounting Principals (GAAP) terminology, the financial impact of implementing a proposed solution, thus bridging the gap between solution providers, IT managers, and Chief Financial Officers. The cost justification software uses two scenarios: 1) vendors solution and 2) Business as Usual (BAU). Under BAU current activity costs are projected and asset cost tracking is taken into account with the expected growth rate based on application backlogs. The vendor product scenario takes into account the same growth rate as the BAU scenario, but additionally vendor product solution reflects cost reductions and/or revenue increases associated with the vendor product. For example, implementing a data warehouse management solution as the vendor product, it is expected that the costs associated with data base administrators (DBAs), System Administrators, and DASD (disk space) would be significantly reduced.

In particularly preferred embodiments, the cost justification software comprises knowledge base information and a rollout schedule information, wherein both components are adjustable by the user. In a further embodiment, the cost justification software comprises knowledge base information, rollout schedule information and expense rules (expense rule information). In other embodiments, the cost justification software integrates knowledge base information, expense rule information and rollout schedule information. The knowledge base information contains projected and actual activity and asset savings. The expense rules can be based upon the rollout schedule or a straight-line expense. The rollout schedule is a quarterly schedule that indicates when the proposed solution is deployed.

By changing the rollout schedule, savings and expenses are automatically recalculated based upon the knowledge base and expense rules. This allows the user to manipulate the details of the financial model. An additional benefit is that the knowledge base and expenses rules may be presented (e.g., printed) as part of a business case.

In this exemplary embodiment, the cost justification software employs a “Wizard” (i.e., a user interface provided by the software of the present invention) that asks for information regarding an IT customer's Business As Usual (BAU) expenditures and personnel. The information entered into the Wizard is compared to a vendor product solution once all necessary fields are filled. The information entered in the Wizard is BAU information and can be changed after leaving the Wizard. Once data entry into the Wizard is completed, the cost justification software presents a Viewer (i.e. financial summaries are displayed). A user may then begin doing “What if” analysis by manipulating the details behind the vendor product solution including the rollout schedule information, the knowledge base information, expense rule information and all of the Project Data that would encompass the vendor product solution. In a Results section a user can navigate and review various spreadsheets, including, but not limited to: Business as Usual (BAU); Vendor Product Solution, Savings, Economic Benefits, and Cash Flow. The various aspects of the cost justification software, and the underlying formulas used to calculate the results (e.g., financial summaries) are described in more detail below. The components of the cost justification software discussed below are primarily directed to the financial analysis of Information Technology related purchases. However, the cost justification software is useful for financial analysis for cost justification of any type of purchase.

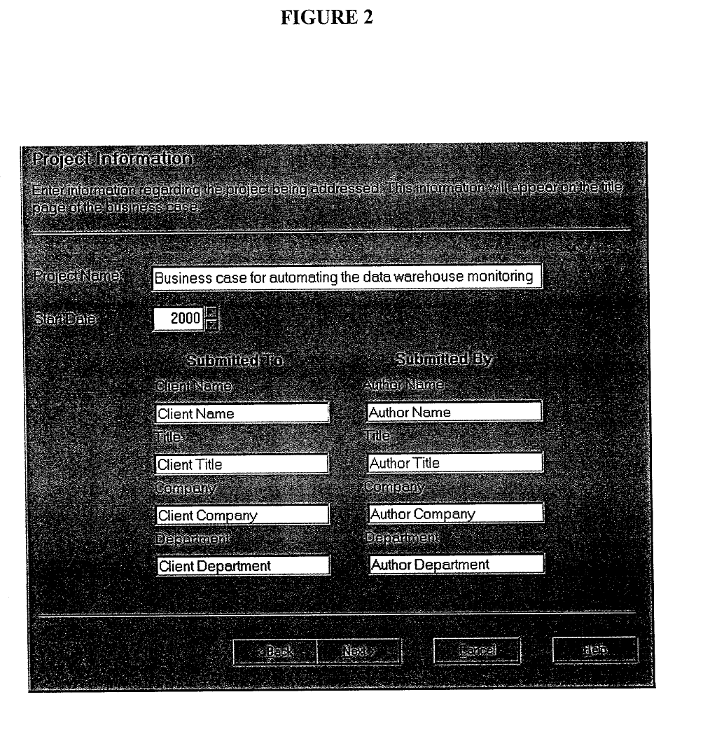

As mentioned above, the cost justification software of the present invention may be used to generate results (e.g., financial summaries and business cases) for the purchase of Information Technology (IT). Detailed below is a description of the cost justification software of the present invention configured for datawarehouse monitoring type IT applications with the appropriate buyer information fields useful for datawarehouse monitoring cost justification analysis. This description is in reference to FIGS. 2-12, which present examples of user interface screens displayed to a user when the cost justification software is configured for a datawarehouse monitoring type purchase. These embodiments of the present invention represent, for example, a system used by a vendor to demonstrate to a potential buyer that the solution offered by the vendor is a wise purchase. This embodiment of the cost justification software of the present invention, for example, may be used by a sales force representing the vendor.

FIG. 2 depicts a user interface screen displayed to a user to collect buyer information pertaining to a proposed IT investment, including: the title of the project, the year the project is to begin, who prepared the report (i.e., the “author”), and what company the report is intended for (i.e., the “client”). Information entered here is inserted in the relevant areas of a printed document once it is generated (e.g., the Project Name is the name of the business case that is printed on the front cover, and in the footer, of the generated business case). Additionally, the Start Date entered is the starting point in all graphs, charts, and the rollout schedule for the entire business case (and financial summaries), and appears in all relevant portions of any printed documents as well.

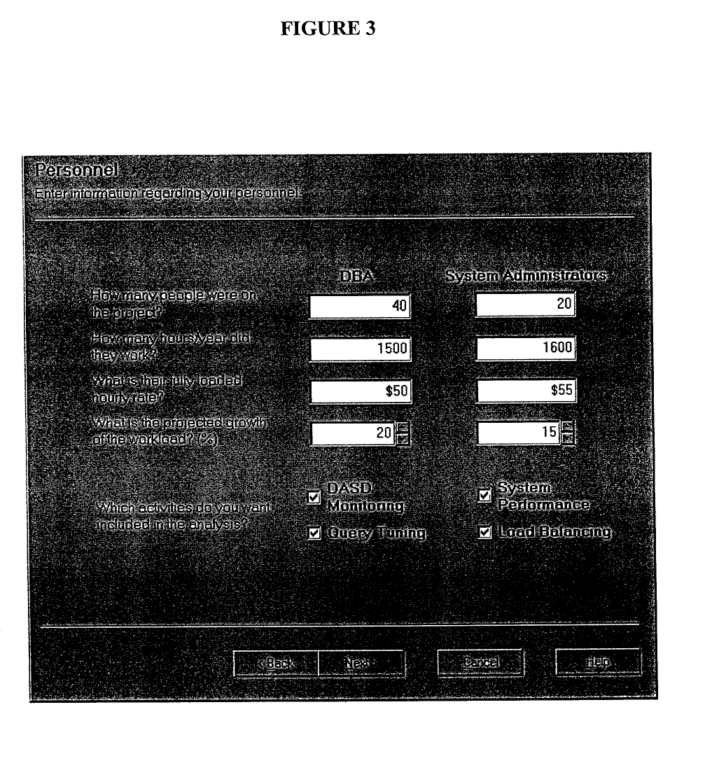

FIG. 3 depicts a user interface screen displayed to a user to collect buyer information regarding personnel (e.g., data warehousing and monitoring personnel). In particular, two types of roles (IT personnel relevant to a data warehouse monitoring solution) are presented, Database Administrators (DBA) and System administrators, with various questions relevant to each type of personnel. A Database Administrator is a person responsible for the physical design and management of the database and for the evaluation, selection and implementation of the DBMS (database management software). In most organizations, the database administrator and the data administrator are the same person, however, when the two responsibilities are managed separately, the database administrator's function is more technical. With regard to DBA administrator activities, DASD monitoring and query tuning are DBA activities that are impacted by a data warehouse monitoring solution (obtained from knowledge base information or by requesting that the user select a limited number of roles that account for a substantial portion of the expected savings). DASD monitoring by data warehouse monitoring applications identifies dormant data that can then be purged and better utilized. DASD monitoring results in a significant reduction in disk space costs due to more efficient utilization. DASD Monitoring is a DBA activity that is impacted by implementing a data warehouse monitoring solution. Query tuning is the process of examining long-running queries by Database Administrators. Query tuning is a DBA activity that is impacted by implementing a data warehouse monitoring solution.

System Administrators are responsible for several areas including monitoring system performance, system throughput, system availability, load balancing, and configuration management. They also manage service level agreements, resolve system wide problems that affect the data warehouse and assist in optimizing CPU utilization. With regard to the System Administrators activities, load balancing and system performance are impacted by a data warehouse monitoring solution. Load balancing is the fine tuning of a computer system, network or disk subsystem in order to more evenly distribute data and/or processing across available resources. For example, in clustering, load balancing might distribute the incoming transactions evenly to all servers, or it might redirect them to the next available server. System performance type activity ensures that servers and local area networks are performing efficiently. Load balancing and system performance type activity are System Administrator activities that are impacted by implementing a data warehouse monitoring solution.

Buyer information regarding these workers may be entered by a user into the Wizard depicted in FIG. 3. Information that may be entered includes: information concerning the number of Data Base Administrators (DBA) and System Administrators, their hours worked, fully loaded hourly rate (this is not just a salary but the total costs related to an employee type) and the expected growth of the workload for the next year (projected growth of the workload that DBAs and System Administrators will be increased in the next year). This data will be reflected as BAU in the cost justification software's Viewer and will be compared to a data warehouse monitoring solution outcome. The cost justification software's Wizard screen, depicted in FIG. 3, also gives a user the opportunity to select which activities associated with each type of personnel to include in the analysis. The activities associated with DBAs presented to the user are DASD monitoring and query tuning. The activities associated with System Administrators presented to the user are system performance and load balancing. Any of these four activities may be included or excluded by the user in the embodiment of the cost justification software presented in this figure. In other embodiments of the present invention, the Wizard may have data entry fields where the user can input the identity of the activities to be considered in the analysis.

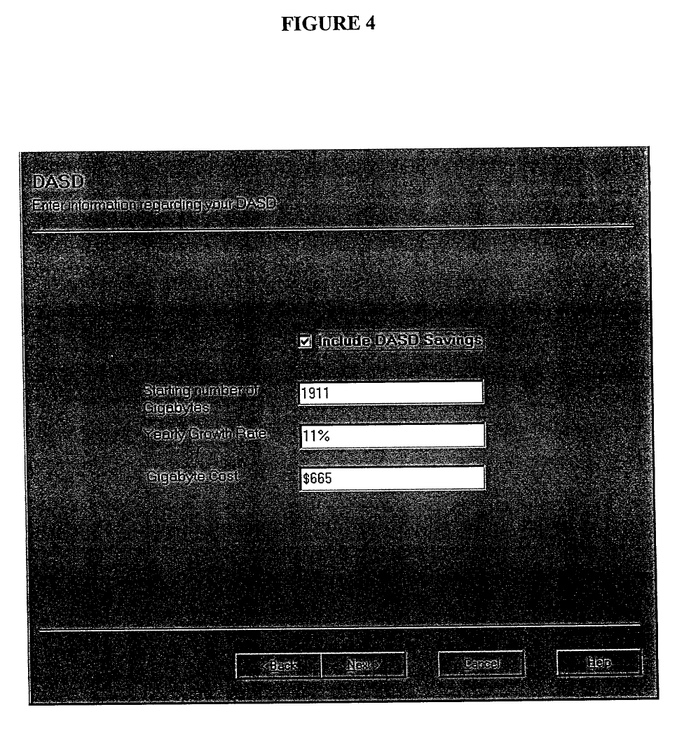

FIG. 4 depicts a screen displayed to a user to collect buyer information regarding DASD (Direct Access Storage Device, better known as disk space). The client's disk space in gigabytes is the starting point for calculating the DASD savings of a data warehouse monitoring solution. Through the Wizard depicted in FIG. 4, a user enters into the cost justification software the starting number of gigabytes (current gigabytes in the client's data warehouse/mart), the yearly growth rate in DASD needs in gigabytes (the expected backlog and increased demand for DASD (disk space) needs for the coming year), and the gigabyte cost (the expected cost per gigabyte that will be incurred for increased data warehousing needs and future DASD purchases) the buyer expects to pay for future purchases. FIG. 4 provides values entered by a user of 1911 for starting gigabytes, 11% for the expected yearly growth rate, and $665.00 for the expected gigabyte cost. DASD is impacted by a data warehouse monitoring solution in that data warehouse monitoring identifies dormant data allowing for better utilization of disk space.

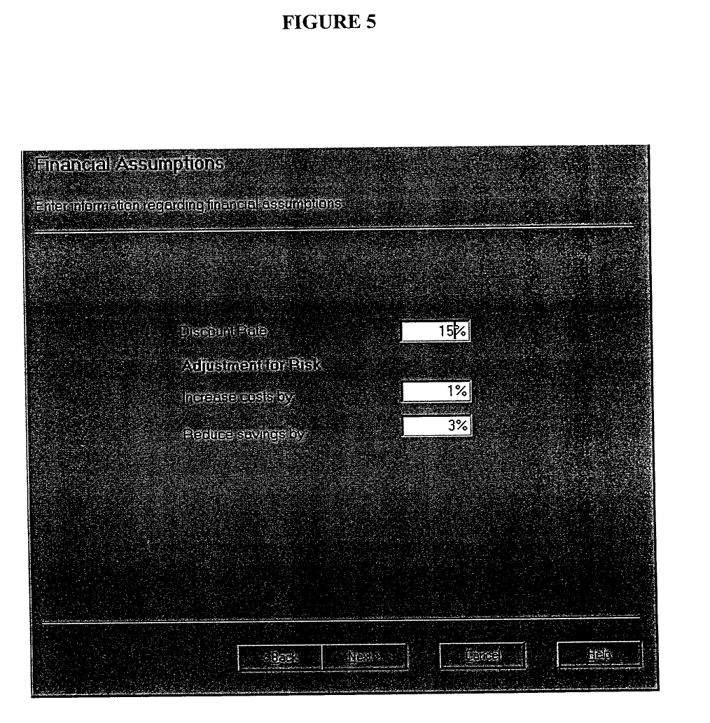

FIG. 5 depicts a user interface screen displayed to a user to collect buyer information regarding financial assumptions. In particular, through the Wizard depicted in FIG. 5, a user enters into the cost justification software the discount rate, and two adjustments for risk (‘Increase costs by’ and ‘Reduce Savings by’). The cost justification software uses the discount rate for Net Present Value (NPV) calculations. FIG. 5 depicts a 15% discount rate entered by a user.

The cost justification software uses Adjustment for Risk (‘Increase costs by’ and ‘Reduce Savings by’) to account for sensitivity in financial projections. Adjustment for Risk accounts for risk in calculating the projected savings resulting from the data warehouse monitoring solution. The cost justification software, however, does not require that adjustments for risk be entered. The ‘Increase costs by’ field allows a user to increase the costs of a proposed investment based on the idea that the initial projection underestimated costs. FIG. 5 depicts a 1% increased costs figure entered by a user. The ‘Reduce savings by’ field allows a user to reduce the potential savings of a proposed investment based on the idea that projected savings of an investment are overestimated. FIG. 5 depicts a 3% reduced savings figure entered by a user.

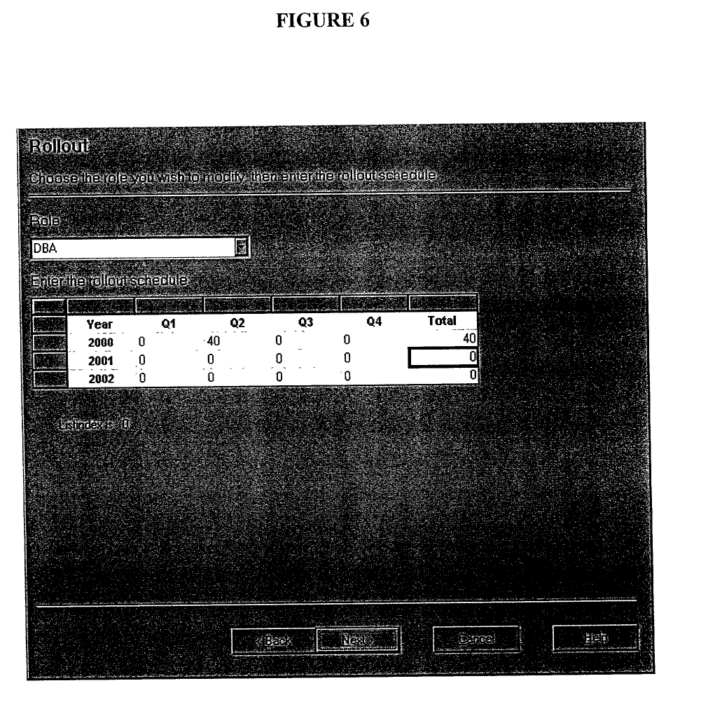

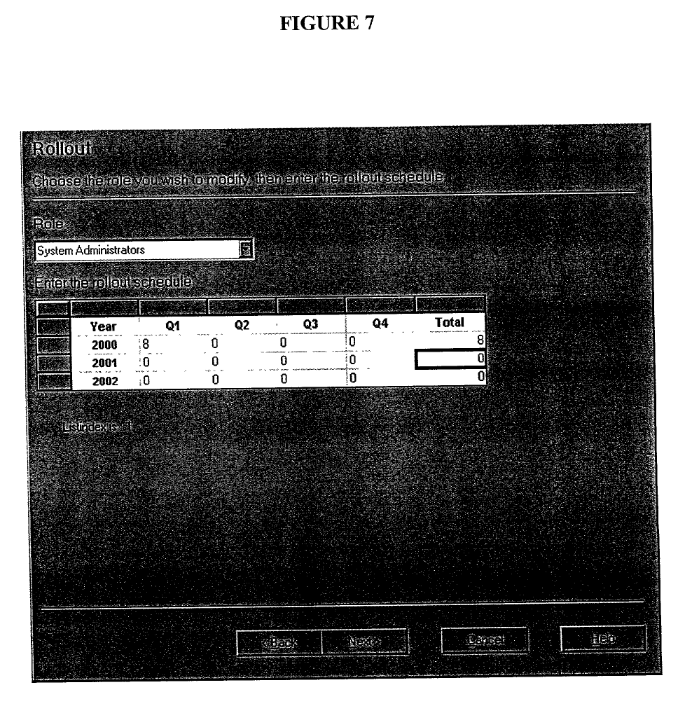

FIGS. 6 and 7 depict user interface screens displayed to a user to enter rollout schedule information for System Administrators and DBAs that will be deployed under the proposed data warehouse monitoring scenario. The information entered is quarterly rollouts for the roles (e.g., DBAs and System Administrators). FIG. 6 depicts a DBA rollout schedule entered by a user with 40 DBAs scheduled in the second quarter of the year 2000. FIG. 7 depicts a System Administrator rollout schedule entered by the user with 8 System Administrators scheduled in the first quarter of the year 2000. Inputting how many of each type of employee, and when they will be deployed, will impact financial projections. The cost justification software aggregates quarterly rollout schedules and computes personnel costs based on DBA's and System Administrator's fully loaded hourly rate, their hours worked per year, and the reduction of their workload and costs due to a data warehouse monitoring solution. The rollout schedule also interacts with asset and service rollout rules (See FIGS. 10 A+B infra). Depending on the number of each role that is rolled out each year of the project, and the rules that are created for each role, asset and service costs will be impacted.

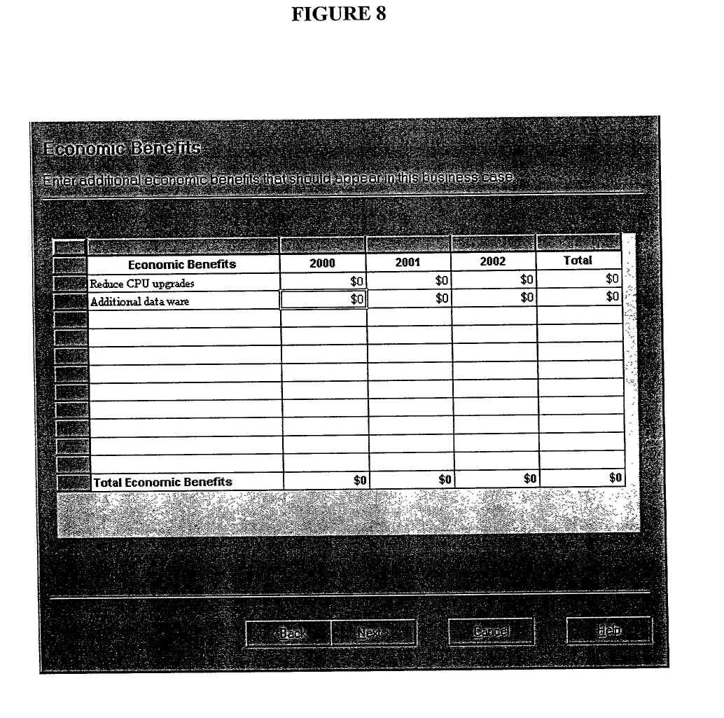

FIG. 8 depicts a user interface screen displayed to a user to enter additional economic benefits provided by implementing a data warehouse monitoring solution. Economic benefits are the tangible but unquantified benefits of a data warehouse monitoring solution. The Wizard depicted in FIG. 8 allows a user to account for benefits that are not accounted for elsewhere in the cost justification software. Examples of economic benefits include; a reduction in the need for CPU upgrades and creating additional data warehouses. A data warehouse monitoring solution may reduce the need for CPU upgrades by eliminating unused data from the client's data warehouse which will increase the efficiency of current hardware investments by delaying additional CPU upgrades. From a 3-year financial perspective it is generally acceptable to consider this cost avoidance a tangible but unquantified benefit. A data warehouse monitoring solution may also create/allow additional data warehouses for the client by increasing the efficiency of current data warehouse investments, allowing the client to produce more with less. This will impact a client's bottom line since the client will be able to support more data warehousing applications, therefore solving more business problems. Some organizations have done Return on Investment (ROI) studies for senior management regarding data warehousing. Therefore, some buyers will feel comfortable putting a dollar value on additional support capability incurred by the reduction in DBA and System Administrator workloads created by the implementation of a data warehouse monitoring solution. The reduced CPU upgrades and additional data warehouse economic benefits listed by a user in FIG. 8, however, were not assigned a dollar value.

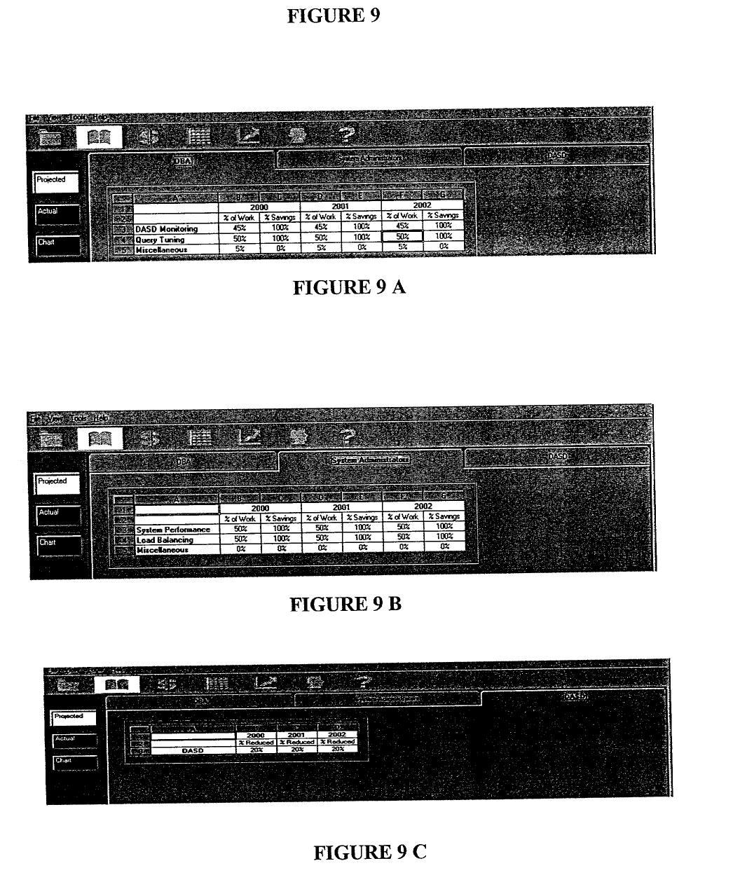

FIGS. 9A-C depict three user interface screens displayed to a user to view and/or change the cost justification software's projected activity and asset savings (e.g., the knowledge base information of the cost justification software). Projected reductions (percent savings) in personnel costs of each role based on the implementation of a data warehouse monitoring solution are presented in FIGS. 9A and 9B, along with the percent of a specific role's work time (percent of work) allocated to each function. For example, DASD Monitoring is an activity performed by a DBA. The cost justification software of the present invention calculates what percent of a DBA's yearly time is allocated to that activity in a BAU scenario, and what percent of that work-time will be reduced by a data warehouse monitoring solution (100% is depicted in FIG. 9A). When a user alters the percent of work or the percent of savings, this is reflected in the cost justification software's Viewer (under the Solution and Savings spreadsheets). For example, if a DBAs % Of Work for DASD monitoring is 45% and the % Of Savings is 100%, DBAs will show a 45% reduction under Personnel Expenses on the vendor's solution spreadsheet. The 45% savings will appear on the Savings spreadsheet. The sum of those two numbers is the total BAU Personnel Expenses for each role (DBA and System Administrator).

The knowledge base of the cost justification software of the present invention also maintains actual results of an implemented solution (not shown in the figures) and allows quarterly tracking in the “Actual” form of the knowledge base. DBA Actual tracks the actual work reduced by implementing a data warehouse monitoring solution. Activities tracked in the embodiment of the cost justification software presented in the figures for DBAs are DASD monitoring and query tuning. Activities that may be tracked for System Administrators are system performance and load balancing. The actual figures may be inputted by the user based on what has actually occurred during the implementation of a data warehouse monitoring solution. They are used to contrast and/or improve projections from the projected section of the Knowledge Base.

FIGS. 10A and 10B depict user interface screens displayed to a user to view and/or change the cost justification software's expense rules (specifically, in this case, for an Asset Rollout). Expense rules allow a user to manipulate line items by year on the data warehouse monitoring operating expense sheet. There are two types of rules; those based upon rollout schedules and those that are not. Non-rollout are used when there is an expense that is not dependent on a rollout schedule. The result is that the expense costs are added to a specific line item and year. Some expenses, however, are only incurred when personnel are rolled out. Rollout rules allow one to add an expense to a line item that is dependent upon the rollout schedules (i.e., they are essentially “if-then” statements).

The Asset Rollout user interface form allows the user to view, add, edit, and delete expense rules pertaining to items that are dependent on a rollout schedule. Asset Rollout Rules allow the user to customize the business case (or financial summaries) for specific rollout scenarios that require assets based upon an increase in personnel. For Asset Rollouts there are a seven types of assets (line items) that can be rolled out in the cost justification software presented in this example, including: (1) Applications (programs that automate technical or business processes pertaining to running the business), (2) System Software (any computer programs pertaining to the operating systems of client or server platforms), (3) Client Workstations (hardware for individual users), (4) Client Networks (enhancements needed to support individual workstations), (5) Client Peripherals (additional devices such as memory, disk-space, or processor upgrades needed for client workstations to implement the proposed solution), (6) Server (an architecture in which the client (e.g., personal computer or workstation) is the requesting machine and the server is the supplying machine, both of which are connected via a local area network shared by multiple users), (7) Server Networks (enhancements needed to support the server). FIGS. 10A and 10B, detailed further below, depict an Asset Rollout form for adding an additional server based on the number of DBAs.

The Asset Non-Rollout form (not depicted in the Figures) allows the user to add, edit, and delete expense rules pertaining to items that do not have a rollout schedule. Asset Non-rollout rules allow the user to customize the business case to add specific assets, in specific accounting periods that are not dependent on personnel. These are the same assets as Asset Rollouts, the only difference being they are not dependent on the Rollout Schedules but instead on the Year Applied that is selected in the Add Rules Asset Non-Rollout form. An example of an Asset Non-Rollout under applications is the cost of the data warehouse monitoring applications purchased by the buyer from the IT vendor appearing in the first year of the project.

The Service Rollout form (not depicted in the Figures) allows the user to view, add, edit, and delete expense rules for services that will be on a rollout schedule. The only difference between asset and service rollout rules is what is being rolled out. For Service Rollouts, there are three services that can be rolled out in this example, including: installation, administration, and training.

The Service Non-Rollout form (not depicted in the Figures) allows the user to view, add, edit, and delete expense rules for services that are not dependent upon a rollout schedule. These are the same services as Service Rollouts, the only difference being they are not dependent on the rollout schedule but instead on the year applied that is selected in the Add Rules Service Non-Rollout form.

FIG. 10B depicts the creation/editing of a particular Asset Rollout expense rule, which will add this rule to the resulting financial summaries and business cases that are generated by cost justification software of the present invention. In particular, the rule created states “For every 15 persons of the type ‘DBA’, add 1 server(s) at a cost of $10,000 per unit (for a cost of 10,000). This rule has a yearly upgrade cost of $2,500”. This rule is created by filling in the fields detailed in FIG. 10B as follows. Under Personnel, role DBA is entered and the number entered is 15. Under Asset, the name entered is Server. Under Quantity, a quantity of 1 is entered with a unit cost of $10,000. Under recurring cost, the upgrade box is checked and a cost of $2,500 is entered. Once this rule has been added, for every 15 DBAs that are rolled out, 1 server at the user's specified cost ($10,000) is added to the solution calculation and Additional Expenses Spreadsheets. Once the rollout of the 16th DBA occurs, another server is allocated. Once the rollout of the 31st DBA occurs, a third server is added. If the rollout of the 16th DBA occurs in the second year, the cost will be added to the second year. If the rollout of 30 DBAs occurs in the first year, 2 servers will be rolled out in the first year. If the rollout of 15 DBAs occurs in the first year, 15 in the second year, and 15 in the third year, the client would incur the cost of one server in each of the three years. Maintenance costs may also be allocated, but only to applications and system Software. Maintenance contains the percentage of total asset cost that is counted as maintenance in subsequent years. A Maintenance Cost is applied to the first year the application or system software is applied, as well as all subsequent years of the project that are remaining. For instance, if one has a rule that rolls out one application in the first year at a cost of $1000, with a maintenance cost of 100%, then the financial summaries/business cases will reflect $1000 under applications in the first year, and $1000 in software maintenance for all three years of the project.

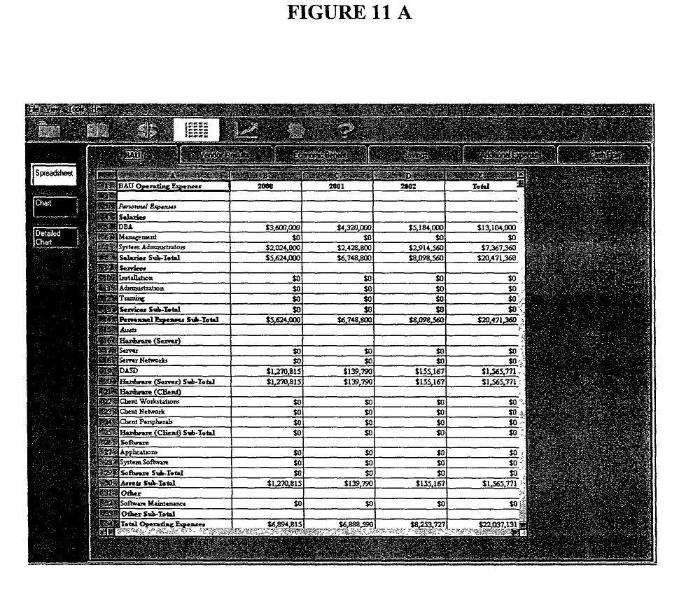

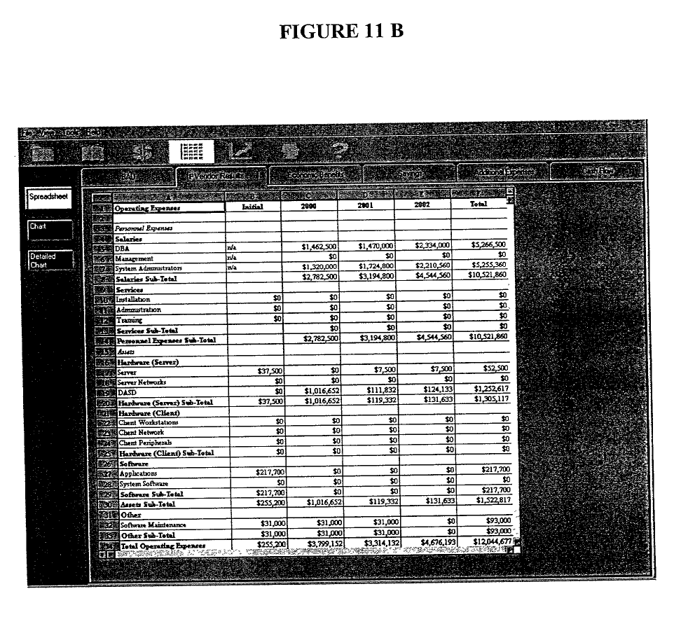

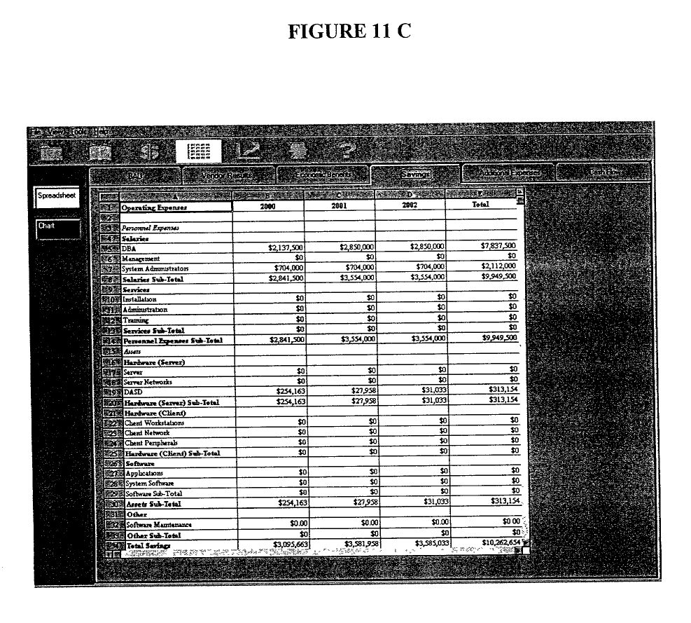

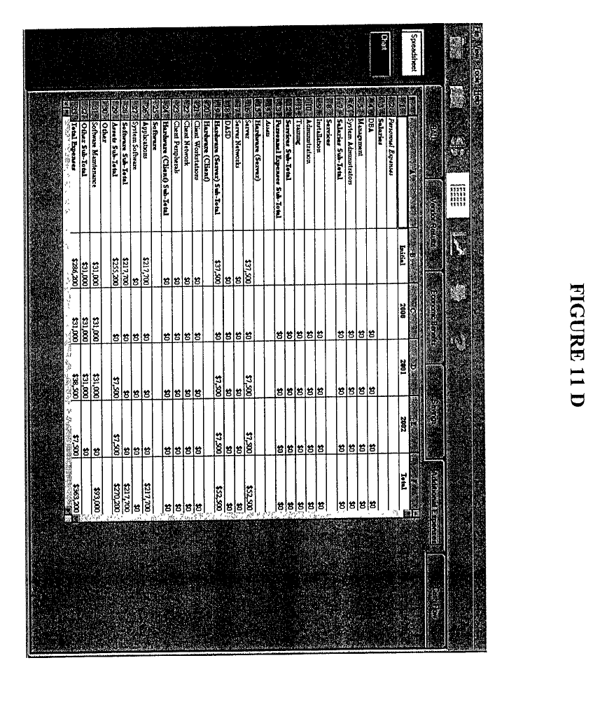

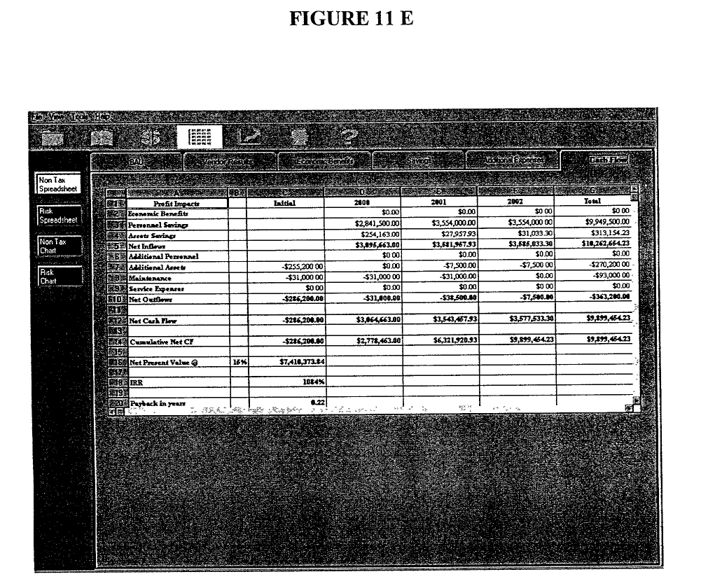

FIGS. 11A-E collectively depict the cost justification software's ‘Viewer’ which are the various Results forms (e.g., financial summaries or financial summary screens) generated by software's financial analysis calculations. The Results portion of software is the location that presents the financial figures (summaries) compiled by the application based on the user's data entry. There are several Results forms, each of which contain specific information regarding the project being analyzed. The names of these forms are: BAU Results, Vendor Solution Results, Economic Benefits Results, Savings Results, Additional Expenses Results, and Cash Flow Results, each of which is explained below.

FIG. 11A depicts the Business as Usual (BAU) Results form in a spreadsheet format (the cost justification software may also depict this form in a chart or detailed chart format). The BAU spreadsheet (and graphs) reflect current costs with no changes to a business as usual approach. In particular, FIG. 11A reflects the BAU Results from the information entered as depicted in FIGS. 2-8, the knowledge base information as depicted in FIG. 9, and the expense rule added as depicted in FIGS. 10 A+B. An Example of one figure generated under BAU, presented in FIG. 11A, is a calculated Total Operating Expense of $22,037,131. This information is used to contrast models measuring the impact of a new product or service. The BAU Results section also contains a chart and a detailed chart option for alternate viewing options. The detailed chart itemizes all activities that are measured by a data warehouse monitoring solution.

FIG. 11B depicts the Vendor Results (data warehouse monitoring results) in a spreadsheet format. The Vendor Results spreadsheet (and graphs) reflect the costs incurred by purchasing and implementing a vendor solution. An example of one figure generated under the Vendor Results, presented in FIG. 11B, is a calculated Total Operating Expense of $12,044,677. These costs are generated using the knowledge base which is the actual TCO costs of previous Vendor customers who have implemented the solution. The Detailed Chart itemizes the Three Year Costs of implementing a solution. The normal chart shows the three year costs without the details.

The Economic Benefits Results (not depicted in a Figure) displays a spreadsheet with other tangible but unquantified economic benefits that are incurred by implementing the data warehouse monitoring solution.

FIG. 11C depicts the Savings Results in a spreadsheet format. The Savings Results spreadsheet (and chart) reflects the projected savings by implementing the proposed solution (e.g., the difference between the BAU results and Solution results for each category). An example of a savings figure, presented in FIG. 11C, is the Total Savings of $10,262,654 for implementing the vendor product solution.

FIG. 11D depicts the Additional Expenses Results in a spreadsheet format. The Additional Expenses Results (and chart) reflect any additional expenses necessary to implement the proposed solution. In other words, this sheet reflects only those expenses that result based on any Expense Rules previously entered by the user (or already present in the cost justification application). An example of an expense rule (rollout type), detailed in FIG. 11D, is the addition of 1 server for every 15 DBAs at a cost of $10,000 with a yearly upgrade cost of $2,500.

FIG. 11E depicts the Cash Flow Results in a Non-Tax spreadsheet format (cash flow is also presented in a Non-Tax chart, Risk Spreadsheet, and Risk Chart). Both of the Cash Flow Spreadsheets types display all items included in the financial model and their financial impact on the proposed solution. In other words, the Cash Flow Statement presents the ‘complete picture’ by taking into account the savings by implementing the data warehouse monitoring application, additional expenses caused by implementing data warehouse monitoring, etc. The non-taxes cash-flow spreadsheet (FIG. 10E) reflects costs and benefits without the impact of taxes, and presents various financial summary values like Net Cash Flow, Net Present Value, IRR, and Payback.

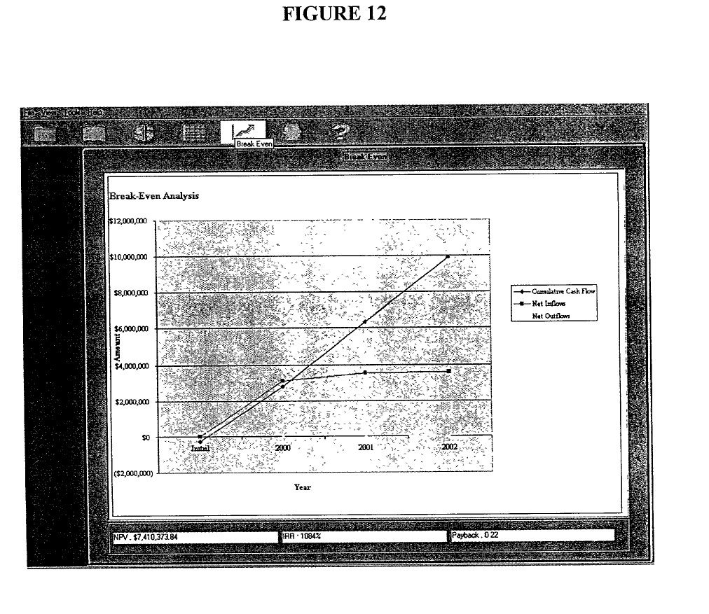

FIG. 12 depicts a Break Even Analysis form, which is a graphic representation of the Cumulative Cash Flow, the Net Inflows and the Net Outflows. The Cumulative Cash represents a running total of cash Inflows and Outflows. For example, if the Net Cash Flow for years 1, 2, and 3 are $500, $1000, and $2000 respectively, the Cumulative Cash Flow for years 1, 2 and 3 would be $500, $1,500, and $3,500. This form also presents payback, which is the amount of time that will pass before the investment has earned back the costs incurred by implementing the data warehouse monitoring solution. In FIG. 12, the payback for the vendor product solution (described in FIGS. 2-11) is 0.22 years.

The calculations (e.g., processing of buyer information, rollout schedule information, etc) used in generating the quantitative aspects of the business case may be performed using any suitable method. One exemplary method is described in detail below for certain business case elements of the present invention. In this example, each entry is displayed in three different formats in a spread-sheet display. The first format shows the numerical entries that appear in a business case, either from entry by a user, selection from a knowledge base, or calculation using the software of the present invention. For example, if 100 employees represent a given role one year into the implementation of the solution, a cell under the heading for “year 1” under “Role 1” under “# of People” will show the number “100.” The second format shows assigned cell names for each of the above entries. The cell name is an identity tag assigned to the entry in the cell for use in calculations. For example, an identity tag for the cell referred to above may be “DP_BAU_Prjctd_Role1_Yr1” where the tag represents the number “100” under the conditions stated above and may be used in formulas by referring to the identity tag. The use of an identity tag allows the number corresponding to the identity tag to change without permanently changing the formulas that use the identity tag. The identity tag above is named such that it represents a particular solution (DP), corresponds to a “business-as-usual” condition (BAU), for a certain project (Prjctd), for a certain role (Role 1), for a certain time period (year 1). The third format shows any formulas used to generate the number in the first format. For example, the formula corresponding to the above entries may have the formula “=ROUND(DBBud_PrvYrNmbrRole4+DBBud_PrvYrNmbrRole4*DBBud_Role4Grwth RtPrvYr,0)” where the term “ROUND” refers to a mathematical instruction to round the calculated number to a present standard (e.g., to the nearest integer) and where the number of employees in year (100) represents the number of employees in the previous year (represented by the identity tag “DBBud_PrvYrNmbrRole4”) plus the number of employees in the previous years times a growth rate for the first year (represented by the identity tag “DBBud_Role4GrwthRtPrvYr,0”).

The following abbreviations are used in this example: “=” (the formula or variable following the sign is to be used to represent or calculate the value in the cell, respectively); “ROUND” (Round the calculated figures to a particular decimal place); “+” (add); “−” (subtract); “*” (multiply); “/” (divide): “SUM(AX:AY)” (add all of the values contained in column A from cell number X to cell number Y); “y” (the item corresponding to the cell meets a given requirement); “n” (the item corresponding to the cell does not meet a given requirement); “IF(X=“y”, . . . )” (if the cell for the identity tag ‘X’ has been assigned a “y” than the formula following the comma is to be executed, otherwise it is not to be executed); “Xˆ Y” (the value X is raised to the power Y); “<” (less than); “>” (greater than); and “< >” (greater than or less than).

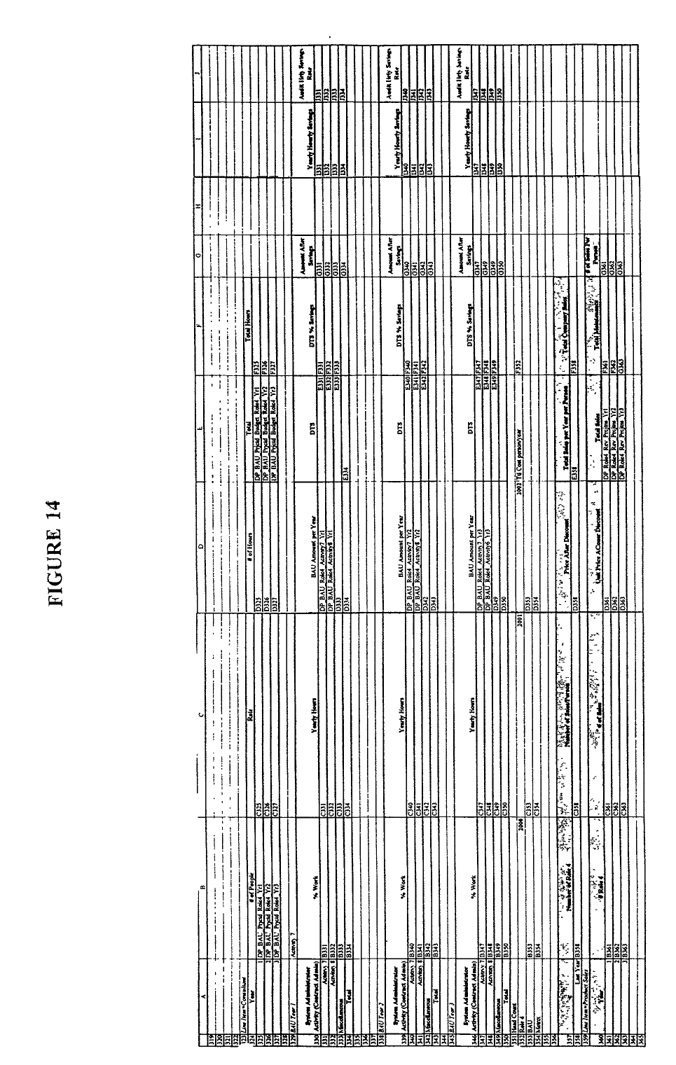

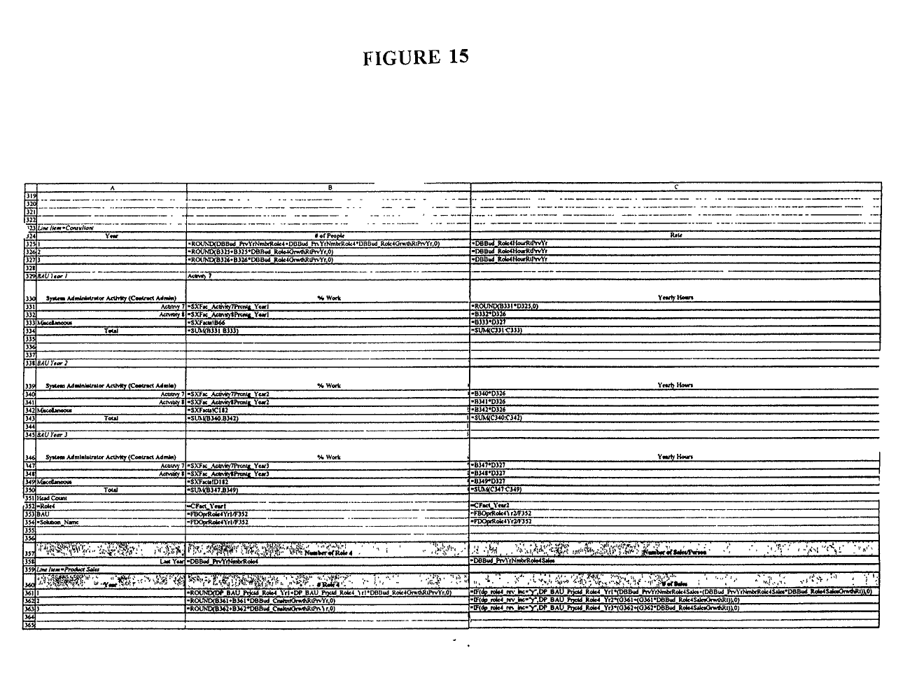

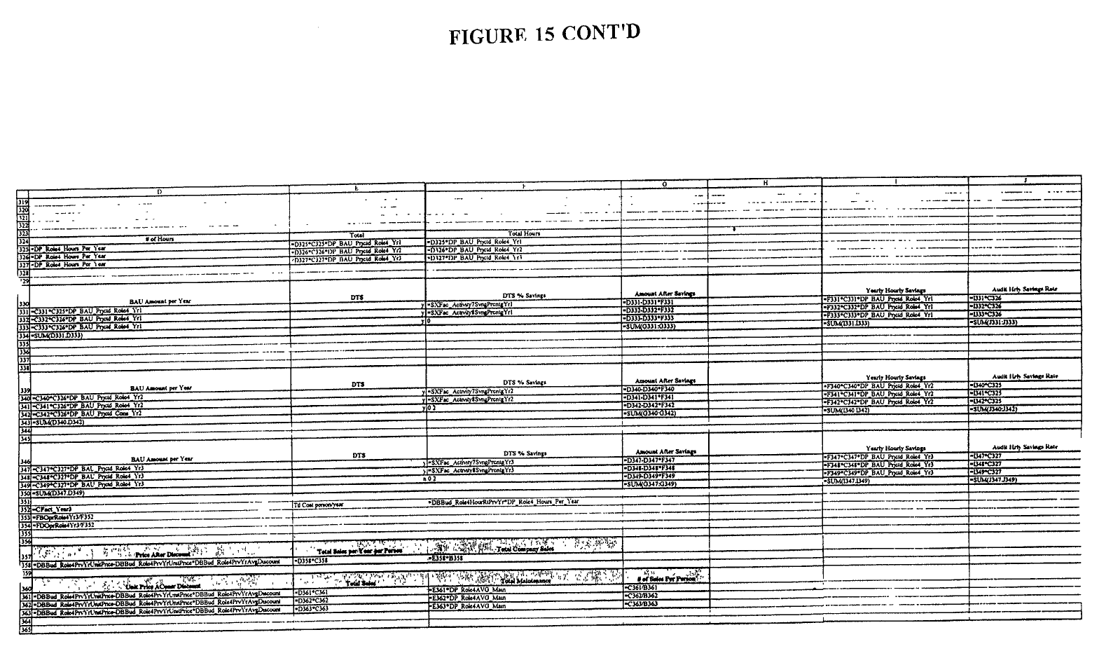

FIGS. 13, 14, and 15 show all three formats for assigning and calculating values for various activities for a particular role, in one embodiment of the present invention. The first format is shown in FIG. 13A. The first set of entries show the number of personnel, their hourly charge, the number of hours worked, and the total cost and hours worked for each of three years for system administrators. The second set of entries show the amount of time each system administrator spends on each particular activity and the associated hours and BAU values per year for each activity. The second set also shows whether or not the solution is applicable to these entries (y=yes) and the % savings expected when the solution is applied. The value for each activity is shown after the savings and the yearly savings per person and total yearly savings are shown. The third and fourth sets of data show the same values for years 2 and 3 of the solution. The fifth set of entries show the number of system administrators for each time period under BAU and applying the solution (in this case, the solution allows all of the system administrators to be eliminated), as well as the total cost per person per year. The final entries show values for changes in income due to changes in the number of system administrators. In this case, for each year, the number of administrators is provided, along with the number of sales attributable to the presence of each administrator, the price of each sale (after discounting for time) and the total sales per person and per year for all system administrators. FIG. 14 shows the identity tags corresponding to each entry in the first format. FIG. 15 shows the formulas used to generate the value in each cell. Where the formula uses an identity tag not present in FIG. 14, the value is obtained from a separate data set (e.g., a data set that contains values obtained from a user or from a knowledge base or data calculated in any of the following data sets or similar sets).

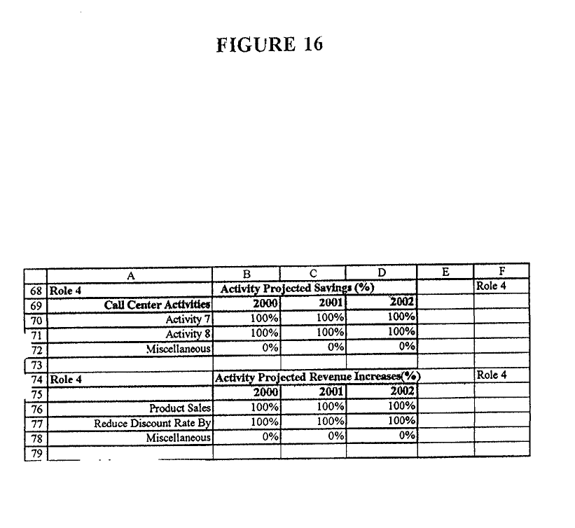

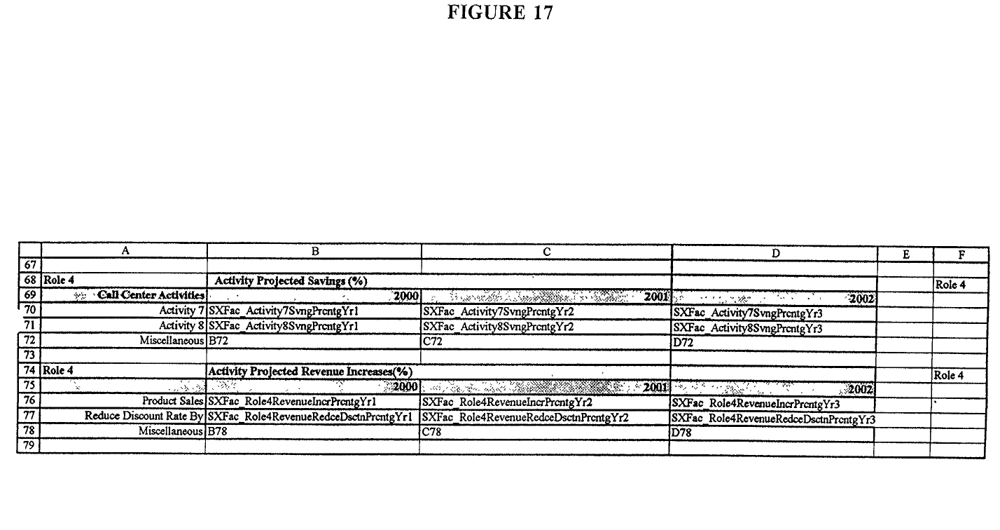

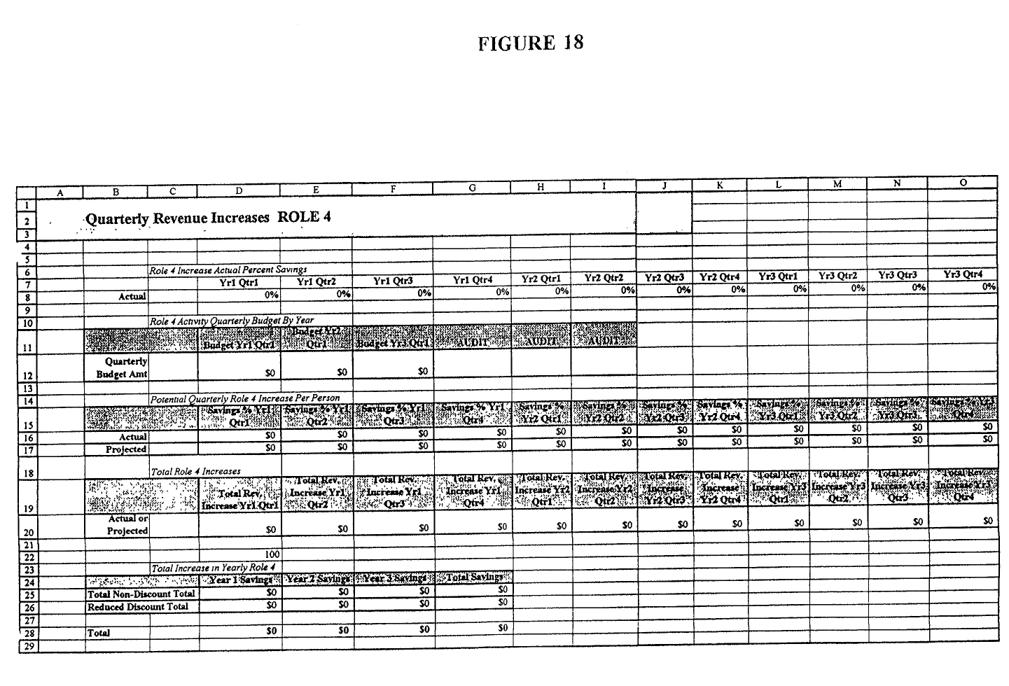

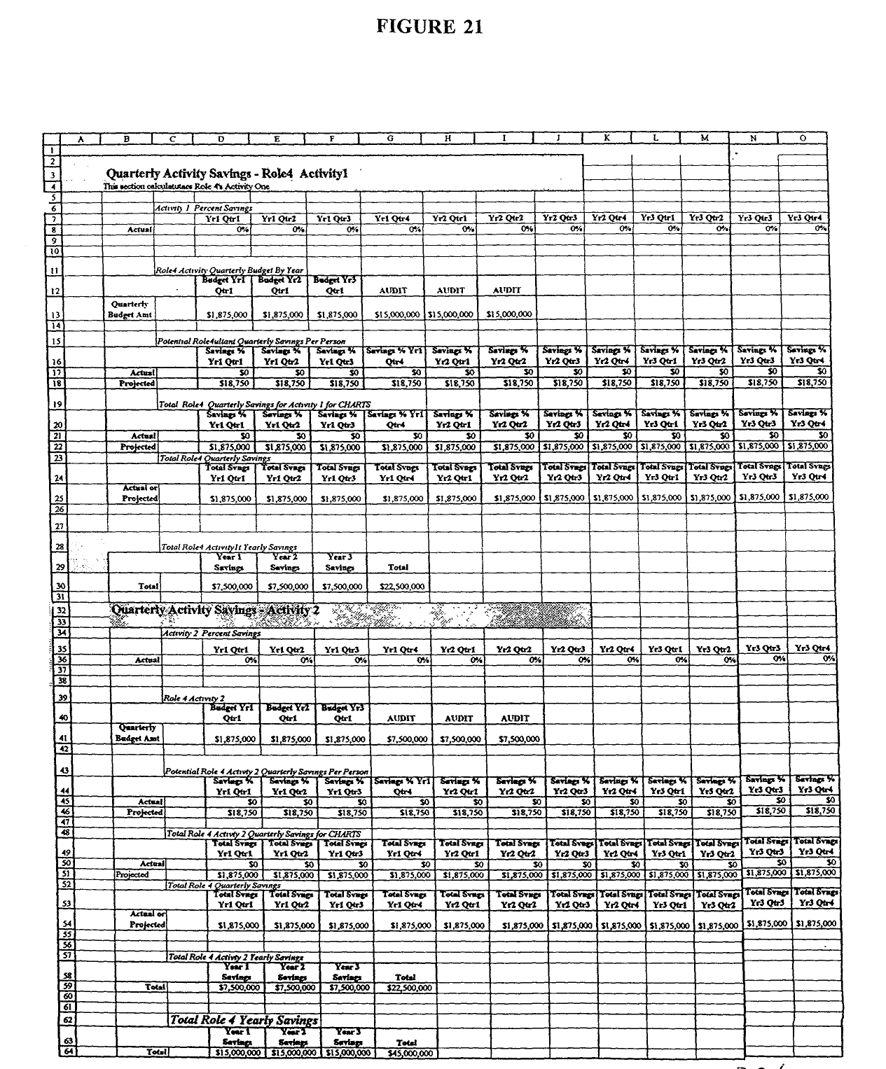

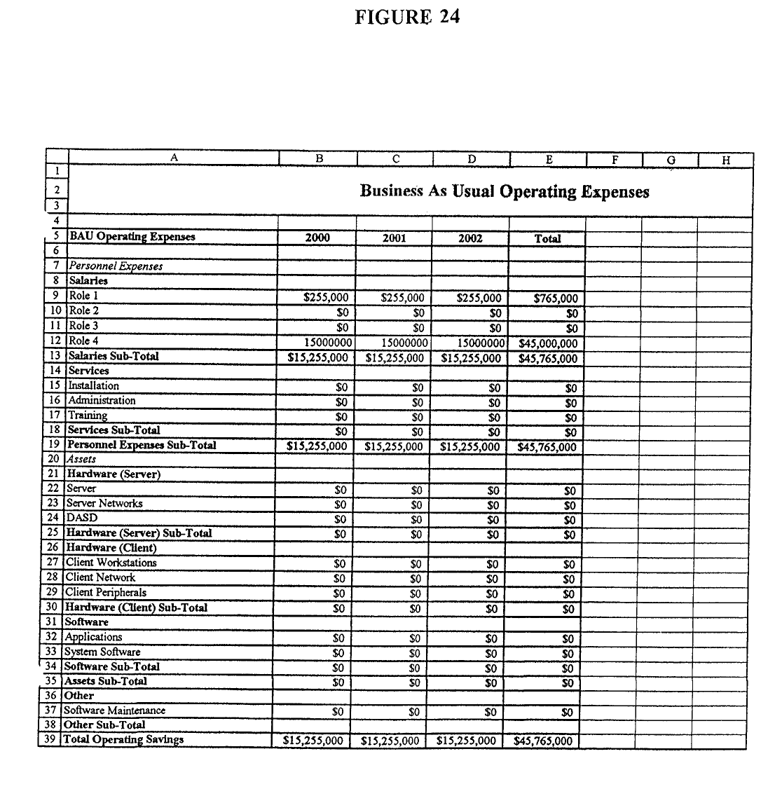

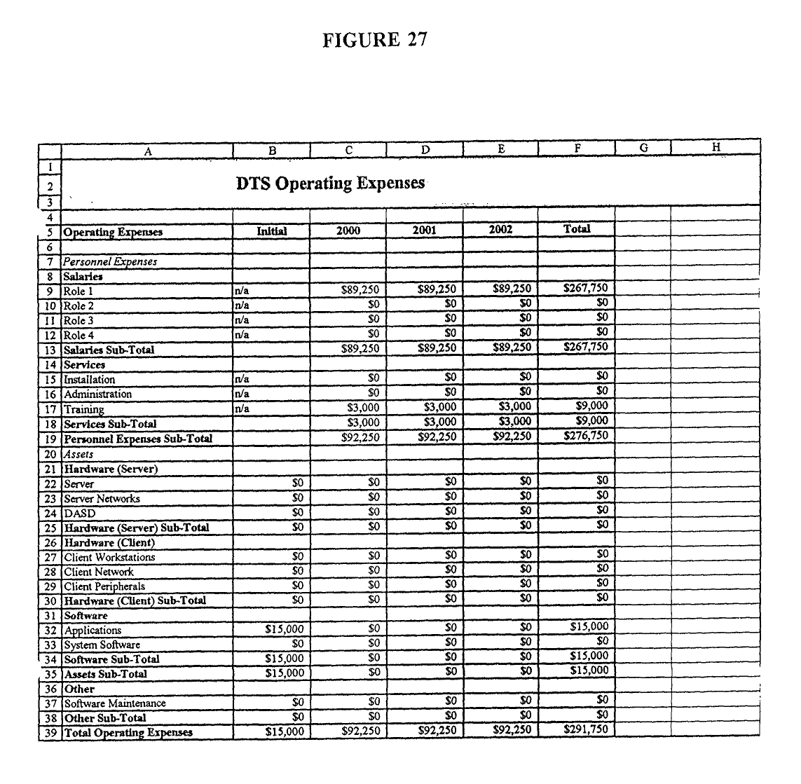

FIGS. 16 and 17 show the values, identity tags, and formulas for savings associated with employing the solution to alter Call Center activities (e.g., activities that alter the efficiency of people responsible for responding to phone requests from customers, such as service calls). FIGS. 18, 19, and 20 show the values, identity tags, and formulas for revenue increases related to the system administrators of FIG. 13. In this case, revenues are tracked by quarter years, with totals for each year, and total revenues calculated. Entries are available to include an analysis of actual information for any of the time periods for the purpose of tracking and monitoring the effects of the solution as they happen. FIGS. 21, 22, and 23 show the values, identity tags, and formulas for savings with the solution for each activity. Savings are tracked by quarter years, with totals for each year, and total savings calculated. Entries are available to include an analysis of actual information for any of the time periods for the purpose of tracking and monitoring the effects of the solution as they happen. In this example, no actual data is included (i.e., all the values are projected). FIGS. 24, 25, and 26 show values, identity tags, and formulas for an example of a summary report for operating expenses under business-as-usual conditions, while FIGS. 27, 28, and 29 show values, identity tags, and formulas for the same factors employing the solution.

FIGS. 30-33 show an additional exemplary embodiment of the present invention where the cost justification application is customized for a particular application (e.g., for a particular vendor or particular vendor product). In this regard, the cost justification application may be customized for a particular user before user information is entered into the user interface (See above). In this exemplary embodiment, ABC company is offering a server based computing solution (vendor product) to XYZ company. ABC company is proposing a quarter of a million dollar investment for XYZ company to migrate its Microsoft Office Application to a server based environment. As such, the cost justification application is employed by ABC company to generate a business case to examine positive business impacts and incurred expenses that the vendor product creates. In this exemplary embodiment, XYZ company originally has ten Client Administrators who maintain Microsoft Office, and ten Help Desk personnel answering support calls.

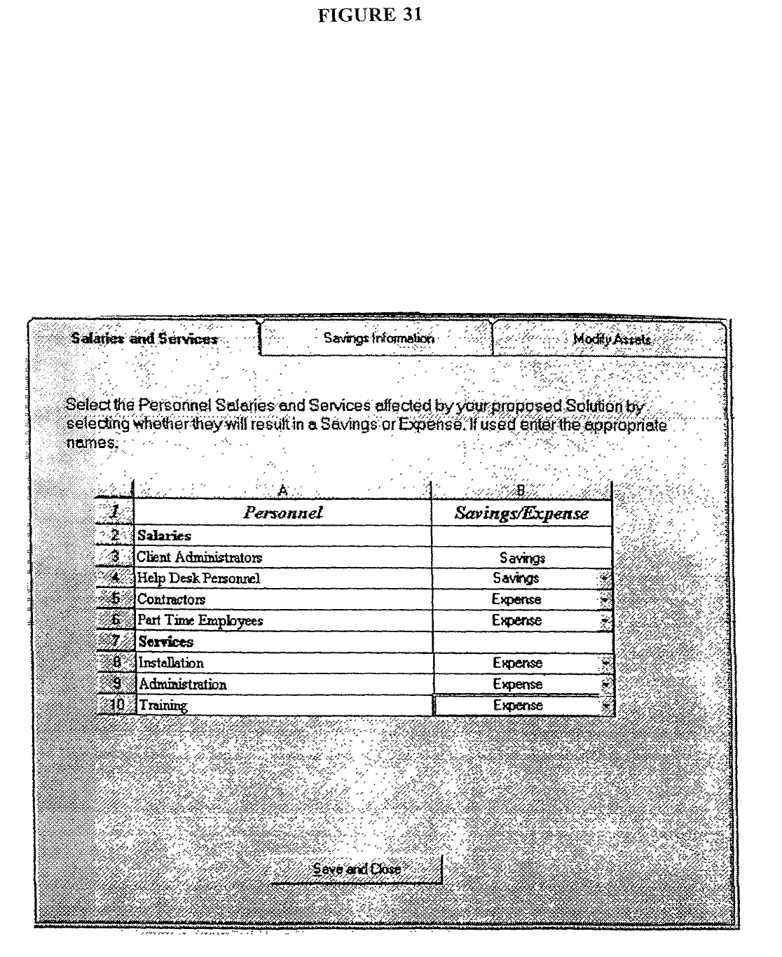

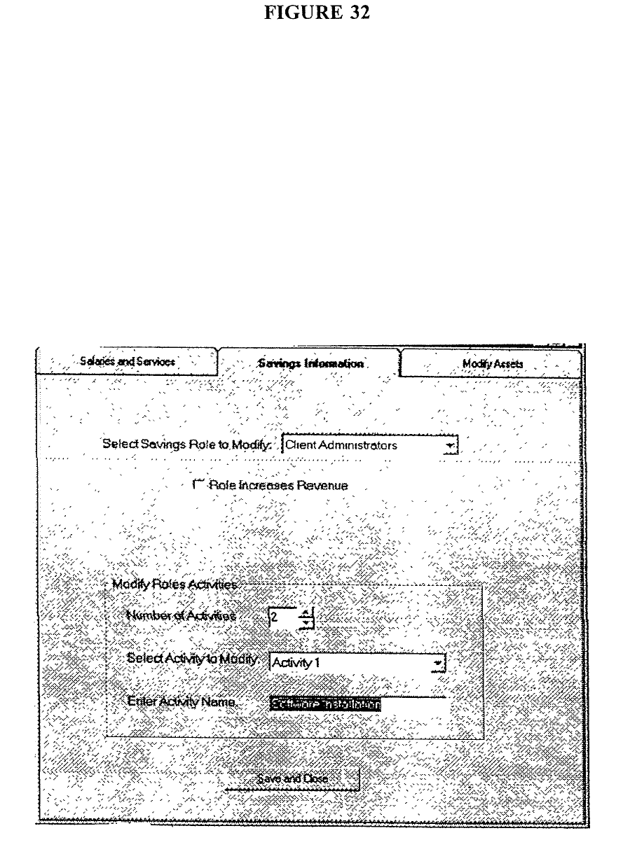

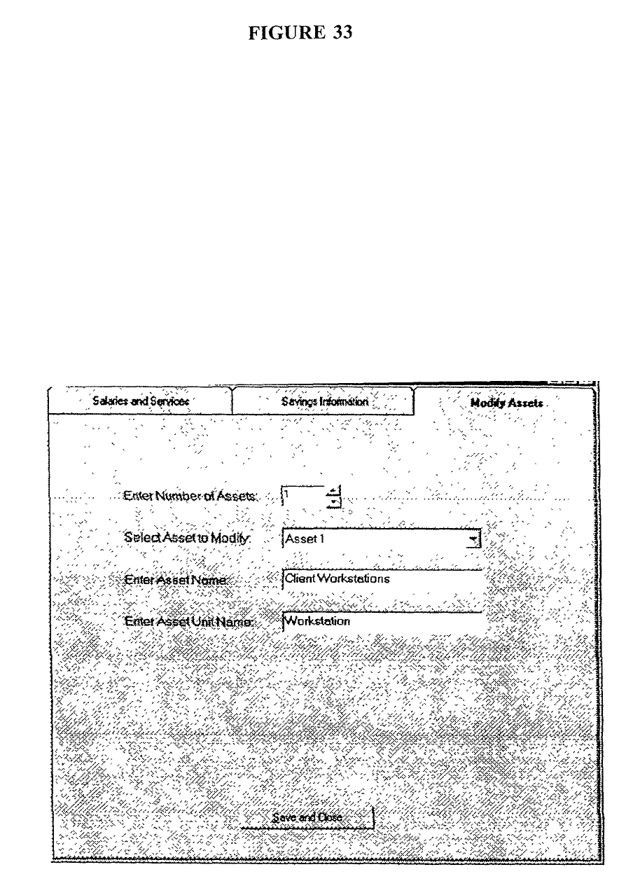

As depicted in FIG. 30, ABC company names their template ‘Server Based Computing’, assigns a project name of ‘ROI Analysis of Terminal Services’, and the proposed solution name is called ‘Windows Terminal Services’. As depicted in FIG. 31, the cost justification application may be customized by selecting or entering the personnel salaries and services affected by the proposed solution (vendor product), and designating whether they will result in a savings or expenses. As depicted in FIG. 32, savings information associated with the roles being evaluated (e.g., client administrators), along with the activities associated with each role (e.g., software installation and asset management), may be entered in to the user interface. Furthermore, the personnel roles may also be associated with revenue increases (which may be designated by checking the ‘Role Increase Revenue’ box in FIG. 32). Finally, as depicted in FIG. 33, the modify assets form allows a user to enter information regarding assets that will show a savings based on the impact of the vendor solution. The example depicted in FIG. 33 allows a user to select up to three assets that will be show a savings (e.g., ABC projects that their solution will save customers on Client Workstations). Once this step is complete, a customized template for a particularized scenario is ready to be employed (e.g., by entering user information). In some embodiments of the present invention, the cost justification software guides the user in selecting the above criteria (e.g., selecting the number of and identity of the roles and activities to be analyzed). In preferred embodiments, the guidance is based on knowledge base information contained in the cost justification software of the present invention.

IV. Implementation of the Methods of the Present Invention

Those skilled in the art will recognize that the methods of the present invention may be implemented in a wide variety of ways. The following description provides illustrative implementation systems that are not intended to limit the scope of the present invention. It will be appreciated that these methods may be incorporated into many existing systems, although certain alterations to the systems may be necessary.

The systems and methods of the present invention address the major issues for both the buyers and the sellers of complex and expensive solutions. For example, the present invention provides systems and methods that represent a complete ROI customer lifecycle, making solution sellers more efficient at every step of the marketing and sales process by providing higher quality lead data and value justifications for their solutions. End users benefit from value justification comparisons at the point of purchase and the capacity to measure solution costs and benefits continually.

In some preferred embodiments of the present invention, the systems and methods are provided over an electronic network such as the World Wide Web. In some preferred embodiments, the systems are provided on the Internet as an easily accessible and easy-to-use Web ROI tool. In some embodiments of the present invention, the Web ROI is a web-based component that enables prospective purchasers to pre-qualify themselves by generating a simple cost-justification business case based upon their unique information. In some embodiments, the business case is stored on a e-commerce web site for future reference and modification by the end-user. The server hosting the Web site and storing such information may be provided by a vendor selling solution products, by an intermediate service provider (i.e., someone other than the vendor or a buyer), or any other suitable party. It is contemplated that marketing departments will use Web ROI as an integral part of e-marketing campaigns as the business case captures quality lead qualifying data. For example, sales teams can view, download, and distribute the business cases generated by their prospects.

In other embodiments of the present invention, the systems and methods of the present invention are provided as a desktop application. For example, in some embodiments, the desktop application creates a detailed business case credibly based upon the vendor's knowledge base of historic deployments and their prospect's parameters. Sales professionals can use the desktop application to qualify prospects, propose and identify true buyers and shorten the sales cycle by aligning their sales process with the customer's buying process. Buyers gain a tool to measure and compare the value of different proposed IT solutions.

In preferred embodiments, the desktop application or Web application is hosted by an intermediate party. In some such embodiments, the intermediate party sells access to the software as a value-added service. Buyers may use this service to manage the deployment of a vendor's solution, track activities and costs over time and then link the results back to the business case. Empirical data may be acquired from a survey generator to develop knowledge bases. This feature not only provides superior strategic differentiation for vendors, but can be used to generate additional revenue streams for the intermediate party by providing a variety of additional and related services to vendors, buyers, and other parties (e.g., collection, compilation, and distribution of customer lists to other parties interested in selling products to, or otherwise communicating with vendors or buyers).

A separate feature of the software, or a separate software application, may be used to manage survey information. For example, this feature may be used to statistically validate survey responses and provides immediate graphical results that vendors use in conjunction with the software application to provide a credible justification of the impact of their solution. The survey management system can contain all the functionality to manage a web survey campaign, validate results, and prompt end-users to comply. In such embodiments, the survey process is automated and operates with little to no human supervision.

The desktop application and Web component provide means to create buyer and vendor networks. For example, the ability of the systems and methods of the present invention to view and update a multitude of different business cases within one single tool increases the value to suppliers and buyers who are dealing with multiple IT projects. Thus, the systems and methods of the present invention may be used to create an open market for business cases. When supplied by an intermediate service provider, the intermediate service provider establishes goodwill and recognition with vendors and buyers. The Web component, using the methods and systems of the present invention, provides a compelling product for vendors that is far superior to the systems available in the art. In addition to the ability to efficiently demonstrate their products, vendors have the ability to acquire information from the intermediary service provider regarding the identity and needs of buyers (e.g., the multitude of buyers accessing the Web site to test the vendor's solution or the solution of other vendors). For example, the intermediary service can provide access to opt-in email lists or other contact information. Vendors may opt in by paying for the service or through other methods such as agreement to provide marketing for the intermediary service, agreement to generate and/or provide survey information for use in generating improved knowledge bases, or agreement to exchange buyer identification information (e.g., in trade for providing information on one buyer, the vendor is given information on two other buyers). With a developed opt-in list, the intermediate service provider can provide the service of automatically distributing qualified leads to customer's desktops.

In some embodiments of the present invention, the intermediate service providers provides infomediary services (e.g., for a transaction fee). For example, the intermediate service may be provided as an Internet application that allows buyers to submit requests for solutions based upon a business case. In some embodiments, suppliers, in addition to paying a subscription fee, will have the opportunity to submit a business case/proposal response to the buyer's request. The intermediate service collects a percent of these transactions. Unlike other business to business (B-to-B) exchange services, the intermediate service of the present invention is focused on value, not price (i.e., using the methods of the present invention, transactions are facilitated by value justification). Where surveys are incorporated into the service, vendors pay to use the survey generator to enhance customer service by quantifying the value that their customer's derive from their solution. Buyers pay for access to the systems of the present invention that are enhanced through incorporation of empirical knowledge base information. This type of knowledge base integration is not available in current electronic value justification systems.

The infomediary services provided by the intermediate service of the present invention are particularly beneficial to the highly fragmented software and services markets, which are characterized by an increasing number of suppliers and buyers. Fragmented markets provide the competitive dynamics that favor the development of infomediaries. Infomediaries create the most value in markets where buyers and sellers have difficulty finding each other. For example, a Global 2000 company seeking a database performance tool would have up to 150 choices. Today, the typical Fortune 500 company has over 300 buyers and makes over 1,000 IT purchases, as compared to 10 years ago when the typical Fortune 500 company has 20 buyers and made 50 purchases a year. Thus, the infomediary services provided by the present invention are particularly suited to large Fortune 500 companies. However, the present invention is not limited to these large companies. Any seller of any solution can benefit from a business case in their marketing and sales activities, and any purchaser of any solution can benefit from value justification comparisons. The novel methods provided by the present invention, where marketing is based on value (e.g., the use of continuous value tracking), offer new opportunities to efficiently link buyers and sellers.

In some embodiments of the present invention, vendors and/or buyers are provided with free or reduced-cost products to encourage them to use the systems and methods of the present invention. For example, in some embodiments of the present invention, marketing departments are encouraged to subscribe to Web component with a free copy of software application for use by their sales force. Likewise, in some embodiments, sales people are sold cost justification software and offered a free, limited time subscription to the Web component. In other embodiments, the cost justification application (or reduced function versions of the cost justification application) are given away or provided a reduced cost in order to demonstrate the capabilities of the software. Such techniques compound sales, and encourage the use of both the software application and the Web component as a package. In yet other embodiments, large corporate sponsors are given a limited number of software applications so they can build business cases for the multitude of software packages they are offered on a daily basis. In exchange, they agree to require the business case format of the present invention from all their vendors and thereby demonstrate the software of the present invention. They can also be encouraged to purchase the software application for each of their employees involved in software purchases.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be within the scope of the following claims.

We claim:

1. A method of cost justification analysis for a user comprising;
a) providing;
i) a user interface capable of receiving user information, wherein said user information comprises buyer information,
ii) a cost justification application operably linked to said user interface, wherein said cost justification application comprises knowledge base information, and
iii) a computer system having stored therein said cost justification application, wherein said computer system comprises computer memory and a computer processor,
b) receiving said user information by way of said user interface, and
c) processing said user information with said cost justification application to generate results.

2. The method of claim 1, wherein said user information further comprises rollout schedule information.

3. The method of claim 1, wherein said knowledge base information comprises expected improvement information.

4. The method of claim 3, wherein said expected improvement information comprises expected cost reductions and expected revenue increases.

5. The method of claim 3, wherein said expected improvement information is capable of being modified.

6. The method of claim 1, further comprising step d) displaying said results to a user.

7. The method of claim 1, wherein said results comprise a financial summary.

8. The method of claim 7, wherein said financial summary comprises a business case.

9. The method of claim 1, wherein said cost justification application further comprises expense rule information.

10. A method of cost justification analysis for a user comprising;
a) providing;
i) a user interface capable of receiving buyer information and rollout schedule information,
ii) a cost justification application operably linked to said user interface, wherein said cost justification application comprises knowledge base information, and
iii) a computer system having stored therein said cost justification application, wherein said computer system comprises computer memory and a computer processor,
b) receiving said buyer information and said rollout schedule information by way of said user interface,
c) processing said buyer information with said cost justification application to generate business as usual results, and
d) processing said buyer information, as a function of both said rollout schedule information and said knowledge base information, with said cost justification application to generate vendor results.

11. The method of claim 10, further comprising step e) processing said business as usual results, and said vendor product results, with said cost justification application to generate results comprising a financial summary.

12. The method of claim 11, wherein said financial summary comprises a business case.

13. The method of claim 10, wherein steps c) and d) occur simultaneously.

14. The method of claim 10, wherein step d) occurs before step c).

15. The method of claim 10, wherein said knowledge base information comprises expected improvement information and user criteria.

16. The method of claim 10, wherein said cost justification application further comprises expense rule information.

17. A cost justification system comprising:
a) a user interface capable of receiving user information, wherein said user information comprises buyer information,
b) a cost justification application operably linked to said user interface, wherein said cost justification application comprises knowledge base information, and wherein said cost justification application is capable of processing said user information to generate a result comprising a financial summary, and
c) a computer system having stored therein said cost justification application, wherein said computer system comprises computer memory and a computer processor.

18. The system of claim 17, wherein said user information further comprises rollout schedule information.

19. The system of claim 17, wherein said cost justification application further comprises expense rule information.

20. The system of claim 17, wherein said financial summary comprises a business case.
